(19) United States
(12) Patent Application Publication
(10) Pub. No.: US 2025/0193891 A1
(43) Pub. Date: Jun. 12, 2025

(54) RESOURCE MANAGEMENT FOR UE-INITIATED REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/969,070

(22) Filed: Dec. 4, 2024

Related U.S. Application Data
(60) Provisional application No. 63/608,756, filed on Dec. 11, 2023.
(60) Provisional application No. 63/609,247, filed on Dec. 12, 2023.
(60) Provisional application No. 63/611,583, filed on Dec. 18, 2023.

(51) Int. Cl. H04W 72/21; H04L 5/00; H04W 76/38

(52) U.S. Cl. CPC H04W 72/21; H04L 5/0055; H04W 76/38

(57) ABSTRACT

Methods and apparatuses for resource management for user equipment (UE)-initiated reporting. A method performed by a UE includes receiving first information related to a physical uplink control channel (PUCCH) for transmission of an indicator to indicate transmission of a beam report, receiving second information related to a physical uplink shared channel (PUSCH) for transmission of the beam report, and determining a PUCCH resource based on the first information. The method further includes determining, based on the indicator or the determined PUCCH resource and the second information, a PUSCH resource, transmitting the indicator via the PUCCH resource, and transmitting the beam report via the PUSCH resource.

### CROSS-REFERENCE TO RELATED AND CLAIM OF PRIORITY

The present application claims priority under 35 U.S.C. § 119 (e) to U.S. Provisional Patent Application No. 63/608,756 filed on Dec. 11, 2023; U.S. Provisional Patent Application No. 63/609,247 filed on Dec. 12, 2023; and U.S. Provisional Patent Application No. 63/611,583 filed on Dec. 18, 2023, which are hereby incorporated by reference in their entirety.

### TECHNICAL FIELD

The present disclosure relates generally to wireless communication systems and, more specifically, the present disclosure relates to methods and apparatuses for resource management for user equipment (UE)-initiated reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to resource management for UE-initiated reporting.

In one embodiment, a UE is provided. The UE includes a transceiver configured to receive first information related to a physical uplink control channel (PUCCH) for transmission of an indicator to indicate transmission of a beam report and receive second information related to a physical uplink shared channel (PUSCH) for transmission of the beam report. The UE further includes a processor operably coupled with the transceiver. The processor is configured to determine, based on the first information, a PUCCH resource and determine, based on (i) the indicator or (ii) the determined PUCCH resource and the second information, a PUSCH resource. The transceiver is further configured to transmit, via the PUCCH resource, the indicator; and transmit, via the PUSCH resource, the beam report.

In another embodiment, a base station (BS) is provided. The BS includes a processor and a transceiver operably coupled with the processor. The transceiver is configured to transmit first information related to a PUCCH for an indicator to indicate transmission of a beam report, transmit second information related to a PUSCH for the beam report, receive, via a PUCCH resource, the indicator, and receive, via a PUSCH resource, the beam report. The PUCCH resource is based on the first information. The PUSCH resource is based on (i) the indicator or (ii) the determined PUCCH resource and the second information.

In yet another embodiment, a method performed by a UE is provided. The method includes receiving first information related to a PUCCH for transmission of an indicator to indicate transmission of a beam report, receiving second information related to a PUSCH for transmission of the beam report, and determining a PUCCH resource based on the first information. The method further includes determining, based on the indicator or the determined PUCCH resource and the second information, a PUSCH resource, transmitting the indicator via the PUCCH resource, and transmitting the beam report via the PUSCH resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure; and

FIG. 7 illustrates an example method performed by a UE in a wireless communication system according to embodiments of the present disclosure.

### DETAILED DESCRIPTION

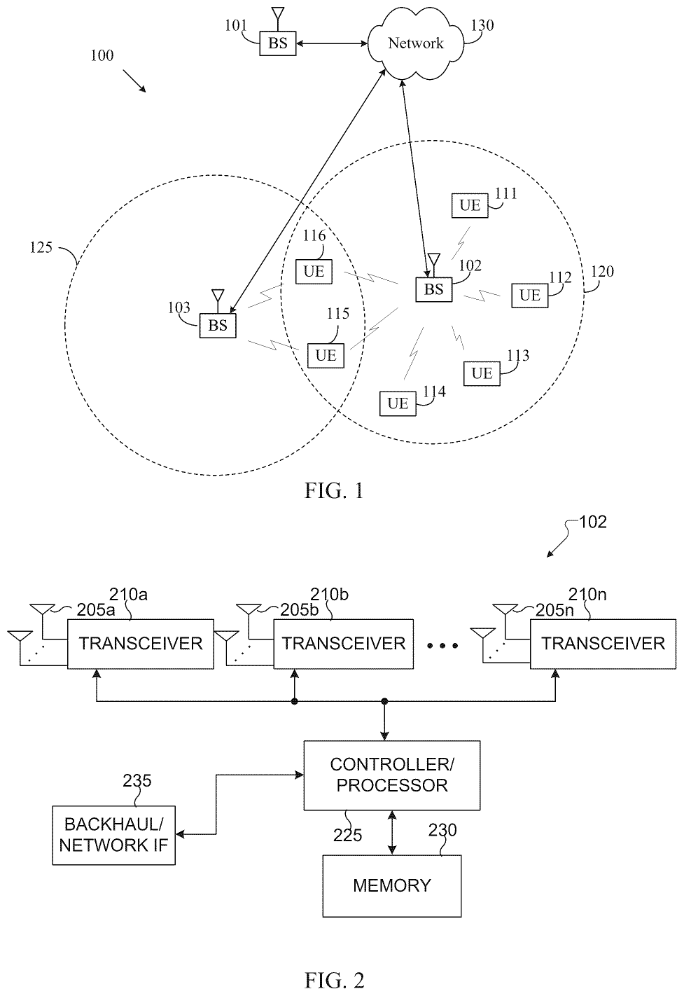

FIGS. 1-7, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for resource management for UE-initiated reporting. In certain embodiments, one or more of the BSs 101-103 include circuitry, programing, or a combination thereof to support resource management for UE-initiated reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting resource management for UE-initiated reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

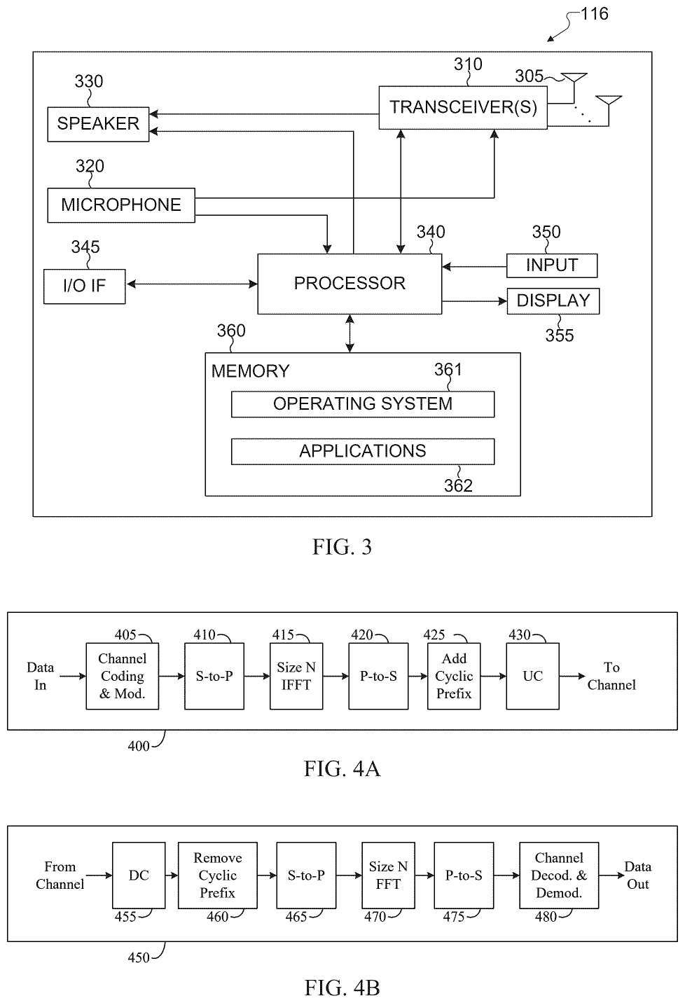

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify resource management for UE-initiated reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support utilize resource management for UE-initiated reporting as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

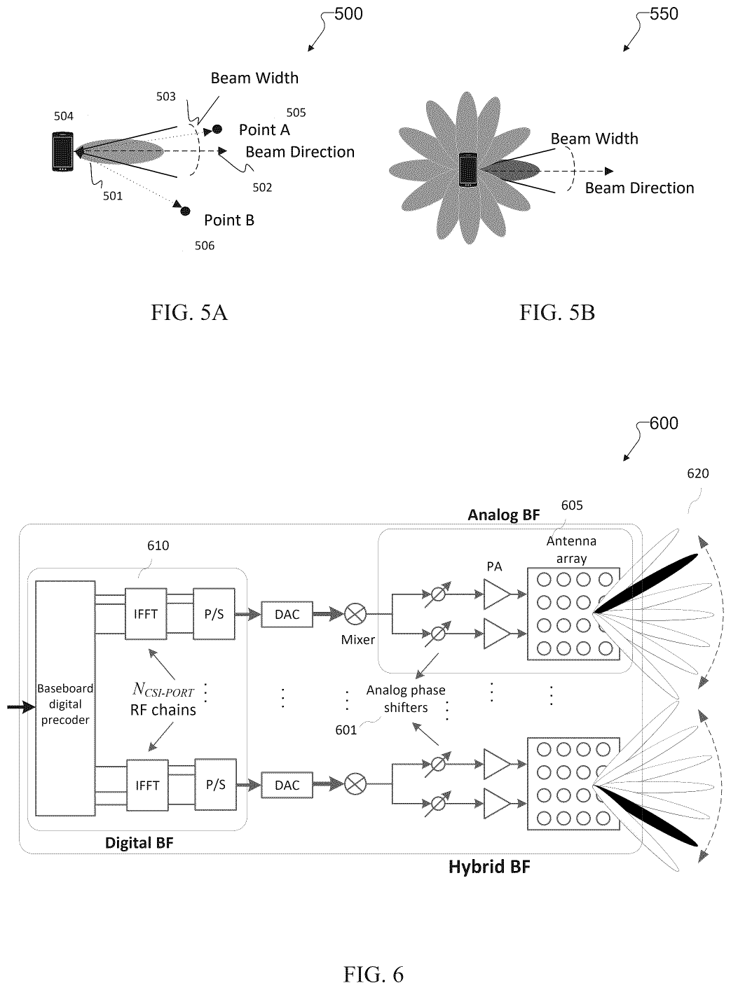

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of;
A transmission configuration indication (TCI) state, that establishes a quasi-colocation (QCL) relationship between a source reference signal (e.g. SSB and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE (e.g., the UE 116) knows the DL channel condition better. Embodiments of the present disclosure recognize that, in this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate). This disclosure provides example embodiments on the mentioned UE-initiated beam management framework herein including CSI/beam reporting, beam switching and beam activation/sub-selection. Furthermore, this disclosure also provides various design options for determining modulation and coding schemes (MCSs) for the L1 signaling mediums (including physical uplink control channel (PUCCH) and physical uplink shared channel (PUSCH)) that carries the UE-initiated report(s).

The present disclosure provides various detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents detailed methods of how to determine modulation and coding schemes (MCSs) for the L1 signaling mediums (including PUCCH and PUSCH) that carries the UE-initiated report(s).

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g. CRI, synchronization signal block resource indicator (SSBRI)) and Jᵢ is a beam metric (e.g. layer 1 reference signal received power (L1-RSRP), layer 1 signal-to-interference-plus-noise ratio (L1-SINR)).
In one example, the content includes CSI-related quantity/quantities. For example, at least one of rank indicator (RI), precoding matrix indicator (PMI), channel quality indicator (CQI), CQI report interval (CRI), layer index (LI) is included.
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-) correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna (e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (examples herein) and at least one other quantity/quantities (examples herein).
In one example, the content includes CSI-related quantity/quantities (examples herein) and at least one other quantity/quantities (examples herein).
In one example, the content includes TDCP-related quantity/quantities (examples herein) and at least one other quantity/quantities (examples herein).
In one example, the content includes beam-related quantity/quantities (examples herein) and CSI-related quantity/quantities (examples herein).
In one example, the content includes beam-related quantity/quantities (examples herein) and TDCP-related quantity/quantities (examples herein).
In one example, the content includes TDCP-related quantity/quantities (examples herein) and CSI-related quantity/quantities (examples herein).

In one example, the report is targeting a physical layer (L1) communication (e.g. L1 DL/UL, or L1 sidelink (SL)), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| | | Trigger/pre-notification | |
| Event type | Type | message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/beam/ | (A) | Yes (e.g. non-CSI-related event) | No |
| TDCP | (B) | No | Yes |
| | (C) | Yes (e.g. non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), | No |
| | content-specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification message/trigger, i.e., the report-type is (A), the trigger/pre-notification message simply provides a ‘hint/alarm/cue’ to the target entity according to at least one of the following examples.
For example, the hint is about the communication link/channel. For example, it can imply a need for a new or updated report (e.g. beam or CSI or TDCP). In this case, it is up to NW whether to configure a report for the content (separately).
For another example, the hint is about an RS transmission. For example, it can imply a need for an aperiodic or semi-persistent RS (e.g. CSI-RS, SRS) transmission. The RS transmission can be from the target entity, or from the UE.
For another example, the hint is about a selection/switch. For example, it can imply a need for switching from current A to another A, where A is one of current panel(s), TRP(s)/RRH(s), resource sets, antenna groups, antenna port groups.
For another example, the hint is about beam/CSI parameters. For example, the parameter can be codebook type (e.g. from Type I to Type II or vice versa), or rank restriction (e.g. from high rank to low rank or vice versa).
For another example, the hint is about RS parameters. For example, the parameter can be related to a AP RS trigger, or RS periodicity, or number of SRS ports (panel switch, 1 panel to 2 panel or vice versa) or number of RS resources.
For another example, the hint is about transmission scheme, which can be one of PMI-based, diversity (cyclic delay diversity (CDD), cycling, SFBC), reciprocity (NCB, or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint is about transmission parameters, e.g. MCS, or number of CWs.
For another example, when there is no pre-notification message/trigger associated with a content, i.e., the report-type is (B), the content can be transmitted using UL resource(s) configured (e.g. configured-grant PUSCH), or reserved for the UE-initiated report, or via a RACH procedure.

In one embodiment, a UE could send to the network (e.g., the network 130) one or more indicators/triggers each comprising/including/containing or corresponding to one or more of:
An identity (ID) of the TCI state
An index/ID of a higher layer RRC configured list/set/pool of TCI states that comprises/indicates/provides the TCI state
An index of the TCI state in a list/set/pool of TCI states higher layer RRC configured to the UE
An index of the TCI state in a set of TCI states activated by a (unified) TCI state(s) activation/deactivation MAC CE
An index/ID of a set of TCI states—e.g., among sets of TCI states activated/provided by a (unified) TCI state(s) activation/deactivation MAC CE—that comprises/indicates/provides the TCI state
An index of the TCI state among TCI states mapped to a TCI codepoint activated/provided by a (unified) TCI state(s) activation/deactivation MAC CE
A TCI codepoint activated/provided by a (unified) TCI state(s) activation/deactivation MAC CE that comprises/indicates/provides the TCI state
An index/ID of a TCI codepoint—e.g., among TCI codepoints activated/provided by a (unified) TCI state(s) activation/deactivation MAC CE—that comprises/indicates/provides the TCI state
An index of the TCI state among TCI states indicated by a TCI codepoint of a TCI field in a beam indication DCI (e.g., DCI format 1_1/1_2 with or without DL assignment)
An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received
An index/ID of or information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received
RS index(es)/ID(s) such as SSB index(es)/ID(s) and/or CSI-RS resource index(es)/ID(s) provided/indicated in the TCI state along with the corresponding QCL-type(s)
Resource indicator(s) such as SSBRI(s) and/or CRI(s) reported in one or more CSI/beam reports
Beam metric(s) such as L1-RSRP(s) and/or L1-SINR(s) reported in one or more CSI/beam reports
Index(es)/ordering(s) of resource indicator(s) such as SSBRI(s) and/or CRI(s) among resource indicators such as SSBRIs and/or CRIs reported in one or more CSI/beam reports
Index(es)/ordering(s) of resource indicator(s) such as SSBRI(s) and/or CRI(s) among resource indicators such as SSBRIs and/or CRIs reported for TCI state(s)/beam(s) activation/deactivation/sub-selection as specified herein in the present disclosure in one or more CSI/beam reports
Index(es)/ordering(s) of resource indicator(s) such as SSBRI(s) and/or CRI(s) among candidate resource indicators such as SSBRIs and/or CRIs—as specified herein in the present disclosure—reported in one or more CSI/beam reports
Index(es)/ordering(s) of beam metric(s) such as L1-RSRP(s) and/or L1-SINR(s) among beam metrics such as L1-RSRPs and/or L1-SINRs reported in one or more beam/CSI reports
Index(es)/ordering(s) of beam metric(s) such as L1-RSRP(s) and/or L1-SINR(s) among beam metrics such as L1-RSRPs and/or L1-SINRs corresponding to resource indicators such as SSBRIs and/or CRIs reported for TCI state(s)/beam(s) activation/deactivation/sub-selection as specified herein in the present disclosure in one or more CSI/beam reports
Index(es)/ordering(s) of beam metric(s) such as L1-RSRP(s) and/or L1-SINR(s) among beam metrics such as L1-RSRPs and/or L1-SINRs corresponding to candidate resource indicators such as SSBRIs and/or CRIs—as specified herein in the present disclosure—reported in one or more CSI/beam reports
Group(s)/pair(s) of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of resource indicators among groups/pairs of candidate resource indicators such as SSBRIs and/or CRIs—as specified herein in the present disclosure—reported in one or more CSI/beam reports
Group(s)/pair(s) of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of candidate resource indicators such as SSBRIs and/or CRIs—as specified herein in the present disclosure—reported in one or more CSI/beam reports
A bitmap with each bit position of the bitmap corresponding to a candidate TCI state/TCI state ID/TCI state index/RS index or ID/resource indicator/etc. according to those specified herein in the present disclosure; for this case, when/if a bit position of the bitmap is set to ‘1’ (or ‘0’), the TCI state/TCI state ID/TCI state index/RS index or ID/resource indicator/etc. corresponding to the bit position could be for the UE-initiated beam(s)/TCI state(s) switching/update/change as specified herein in the present disclosure.

Throughout the present disclosure, an index could correspond to the “first”, the “second”, and etc. Furthermore, throughout the present disclosure, “trigger” can also be referred to as “initiate” or “indicate”; i.e., they can be used/applied to various design examples throughout the present disclosure interchangeably. For instance, the UE could send to the network an indicator to trigger a TCI state change/update/switch for one or more channels or signals. Furthermore, throughout the present disclosure, a MCS can be replaced by a transport block size (TBS) and/or a MCS table can be replaced by a TBS table, and the corresponding operations/procedures equally apply.

The indicator(s) described herein in the present disclosure could correspond to the trigger/pre-notification message in a (report-)type (A) based report or a (report-)type (C) based report, or part of the (corresponding) content in a (report-)type (B) based report or a (report-)type (C) based report. Furthermore, the signaling medium/container for reporting the indicator(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, physical random access channel (PRACH), MAC CE, uplink control information (UCI) and etc. The UE may expect to receive from the network an acknowledgement (ACK) (or negative ACK (NACK)) for the indicator(s) specified herein in the present disclosure within a first time window/offset (e.g., in terms of the number of slots/symbols/etc.) starting from the transmission of the indicator(s) (e.g., starting from the corresponding slot/symbol/etc.). The value of the first time window/offset could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network via uplink channels such as PUCCH/PUSCH.
When/if the UE does not receive from the network an ACK for the indicator(s) within the first time window/offset starting from the transmission of the indicator(s) or receives a NACK for the indicator(s) within the first time window/offset starting from the transmission of the indicator(s), the UE could (re-)send the indicator(s).
When/if the UE receives from the network an ACK for the indicator(s) within the first time window/offset starting from the transmission of the indicator(s), the UE may perform the behaviors/operations and/or expect the corresponding network's operations according to the indicator(s) X duration/offset/time (e.g., X symbols/slots/etc.) starting from the reception of the ACK message for the indicator(s). The value of X could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network via uplink channels such as PUCCH/PUSCH.

The UE could be indicated/configured/provided by the network, e.g., via higher layer RRC signaling/parameter and/or MAC CE command and/or dynamic DCI based L1 signaling, the ACK (or NACK) for the indicator(s) specified herein in the present disclosure. For instance, The UE could be indicated/configured/provided by the network, e.g., via higher layer RRC signaling/parameter and/or MAC CE command and/or dynamic DCI based L1 signaling, a one-bit indicator to indicate ACK or NACK for the indicator(s) specified herein in the present disclosure for the UE-initiated beam operation; when/if the one-bit indicator is set to ‘1’ (or ‘0’), the one-bit indicator could indicate an ACK for the indicator(s) sent by the UE for the UE-initiated beam operation; and when/if the one-bit indicator is not present/configured or is set to ‘0’ (or ‘1’), the one-bit indicator could indicate a NACK for the indicator(s) sent by the UE (e.g., the UE 116) for the UE-initiated beam operation. Furthermore, when/if provided/indicated in a DCI, the ACK (or NACK)—e.g., the one-bit indicator as described herein—for the indicator(s) sent by the UE for the UE-initiated beam operation such as UE-initiated TCI state(s)/beam(s) switching/update/change could be indicated/provided via one or more new/dedicated DCI fields—e.g., denoted by ‘ACK/NACK for UE-initiated beam switching’ field(s) in the DCI. Alternatively, when/if provided/indicated in a DCI, the ACK (or NACK)—e.g., the one-bit indicator as described herein—for the indicator(s) sent by the UE for the UE-initiated beam operation including UE-initiated TCI state(s)/beam(s) switching/update/change could be indicated/provided via/by repurposing one or more bits of one or more existing DCI fields in the DCI. For instance, the ‘New Data Indicator’ (NDI) field in a DCI could be repurposed/used to indicate the ACK (or NACK) for the indicator(s) sent by the UE for the UE-initiated beam operation; when/if the NDI field is toggled or is set to ‘1’ (or ‘0’), the NDI could indicate an ACK for the indicator(s) sent by the UE for the UE-initiated beam operation including UE-initiated TCI state(s)/beam(s) switching/update/change; otherwise, the NDI could indicate a NACK for the indicator(s) sent by the UE for the UE-initiated beam operation including UE-initiated TCI state(s)/beam(s) switching/update/change.

A UE could determine modulation and/or coding scheme(s) for the signaling medium(s)-including PUCCH and PUSCH—that carries the indicator(s)/report(s) as specified herein in the present disclosure for the UE-initiated reporting according to one or more of:
Type(s) of the indicator(s)/report(s): for example, the indicator(s)/report(s) could correspond to the trigger/pre-notification message in a (report-)type (A) based report or a (report-)type (C) based report according to those specified herein in the present disclosure; for another example, the indicator(s)/report(s) could contain, include or comprise one or more configurations/activations/indications of TCI state(s) and/or resource indicators such as SSBRIs/CRIs along with their associated beam metrics such as L1-RSRPs/L1-SINRs and/or etc. as specified herein in the present disclosure in part of the content(s) in a (report-)type (B) based report or a (report-)type (C) based report; for another example, the indicator(s)/report(s) for the UE-initiated reporting as specified herein in the present disclosure could correspond to a scheduling request (SR);
Signaling medium(s) of the indicator(s)/report(s): including, e.g., PUCCH, PUSCH, PRACH, PUSCH/MAC CE and etc.
Format(s) of the signaling medium(s) that carries the indicator(s)/report(s): various PUCCH formats including PUCCH format 0/1/2/3/4, various PUSCH configurations including type-1 and/or type-2 configured grant (CG) PUSCH and/or dynamic grant (DG) PUSCH
Payload size(s) of the indicator(s)/report(s): e.g., in terms of number of UCI bits used for sending the indicator(s)/report(s) as specified herein in the present disclosure; for example, the number of UCI bits used for the UE-initiated reporting could be 1 or 2 bits for the trigger/pre-notification message in a (report-)type (A) based report or a (report-)type (C) based report or a scheduling request (SR); for another example, the number of UCI bits used for the UE-initiated reporting could be up to 11 bits or more than 11 bits for the CSI/beam report(s) as specified herein in the present disclosure in part of the content(s) in a (report-)type (B) based report or a (report-)type (C) based report.
Purpose(s) of the indicator(s)/report(s): e.g., when/if the indicator(s)/report(s) corresponds to the trigger/pre-notification message in a (report-)type (A) based report or a (report-)type (C) based report according to those specified herein in the present disclosure, the indicator(s)/report(s) could be used to trigger, initiate, indicate or request UL resource(s) for (i) CSI/beam reporting, wherein a beam report could include/contain/comprise one or more resource indicators including SSBRIs/CRIs and their associated beam metrics including L1-RSRPs/L1-SINRs, (ii) beam switching, wherein a beam switching report could include/contain/comprise one or more configurations/activations/indications of TCI states and/or etc.; furthermore, the indicator(s)/report(s) could be addressed to certain radio network temporary identifiers (RNTIs) such as cell RNTI (C-RNTI), etc.
Network's indication(s)/configuration(s), e.g., via higher layer RRC signaling(s)/parameter(s) and/or MAC CE command(s) and/or dynamic DCI based L1 signaling(s), including e.g. uplink resource allocation(s)/assignment(s) for sending the indicator(s)/report(s) as specified herein in the present disclosure

TABLE 6
an example of association(s)/mapping(s) between MCS(s), type(s) of indicator(s)/report(s) for the UE-
initiated reporting, and payload size of the indicator(s)/report(s) for the UE-initiated reporting

| Type(s) of the | | | | | |
|---|---|---|---|---|---|
| indicator(s)/report(s) | Payload (e.g., UCI size) of | | | | |
| for the UE-initiated | the indicator(s)/report(s) for | | Modulation | | MCS index in |
| reporting | the UE-initiated reporting | | scheme | Coding scheme | a MCS table |
| Trigger/pre-notification | 1 | bit | BPSK | Reed-Muller code | 1 |
| message | | | | with a target code-rate | |
| Trigger/pre-notification | 2 | bits | QPSK | Reed-Muller code | 2 |
| message | | | | with a target code-rate | |
| UE-initiated beam/CSI | 3-11 | bits | QPSK | Reed-Muller code | 3 |
| report(s) | | | | with a target code-rate | |
| Trigger/pre-notification | 3-11 | bits | QPSK | Reed-Muller code | 4 |
| message and UE-initiated | | | | with a target code-rate | |
| beam/CSI report(s) | | | | | |
| UE-initiated beam/CSI | >11 | bits | 64 QAM | Polar code with a | 5 |
| report(s) | | | | target code-rate | |
| Trigger/pre-notification | >11 | bits | 64 QAM | Polar code with a | 6 |
| message and UE-initiated | | | | target code-rate | |
| beam/CSI report(s) | | | | | |

In one embodiment, the association/mapping between one or more of (1) type(s) of the indicator(s)/report(s), (2) signaling medium(s) of the indicator(s)/report(s), (3) format(s) of the signaling medium(s) that carries the indicator(s)/report(s), (4) payload size(s) of the indicator(s)/report(s), (5) purpose(s) of the indicator(s)/report(s) and (6) network's indication(s)/configuration(s), e.g., via higher layer RRC signaling(s)/parameter(s) and/or MAC CE command(s) and/or dynamic DCI based L1 signaling(s) as specified herein in the present disclosure for the UE-initiated reporting and various modulation and coding schemes (MCSs) used for the signaling medium(s) to that sends/carries the indicator(s)/report(s) for the UE-initiated reporting could be fixed (e.g., provided in look-up tables) in system specifications.
For example, the UE could determine a MCS or a MCS index associating to a modulation order and a target code-rate in a MCS table specified for physical downlink shared channel (PDSCH)/PUSCH reception(s)/transmission(s) for the signaling medium(s) that sends/carries the indicator(s)/report(s) as specified herein in the present disclosure according to at least (1) type(s) of the indicator(s)/report(s) and (4) payload size(s) of the indicator(s)/report(s) as specified herein in the present disclosure for the UE-initiated reporting. In one example, the UE could determine, e.g., binary phase-shift keying (BPSK) (or QPSK) as the modulation scheme and/or Reed-Muller code (e.g., with a target code-rate/etc.) as the coding scheme according to the association/mapping rule(s) specified in system specifications for the indicator(s)/report(s), when/if the type(s) of the indicator(s)/report(s) corresponds to the trigger/pre-notification message in a (report-)type (A) based report or a (report-)type (C) based report according to those specified herein in the present disclosure and the payload size of the indicator(s)/report(s)—in terms of number of UCI bits—is less than a threshold (e.g., 2 bits). For this case, after the UE has determined the MCS for the indicator(s)/report(s), the UE could send to the network the indicator(s)/report(s) via the allocated/configured uplink resources including PUCCH and/or PUSCH using various formats/configurations including, e.g., format(s) 0, 1, 2, 3 and/or 4 for PUCCH and/or type-1/2 CG and/or DG for PUSCH transmission(s). In another example, the UE could determine, e.g., 64QAM as the modulation scheme and/or Polar code (e.g., with a target code-rate/etc.) as the coding scheme according to the association/mapping rule(s) specified in system specifications for the indicator(s)/report(s), when/if the type(s) of the indicator(s)/report(s) corresponds to both the trigger/pre-notification message in a (report-)type (A) based report or a (report-)type (C) based report and a beam/CSI report (including at least one or more resource indicators and their associated beam metrics) according to those specified herein in the present disclosure and the payload size of the indicator(s)/report(s)—in terms of number of UCI bits—is greater than a threshold (e.g., 11 bits). For this case, after the UE has determined the MCS for the indicator(s)/report(s), the UE could send the indicator(s)/report(s) via the allocated/configured uplink resources including PUCCH and/or PUSCH using various formats/configurations including, e.g., format(s) 0, 1, 2, 3 and/or 4 for PUCCH and/or type-1/2 CG and/or DG for PUSCH transmission(s). That is, for this design example, the determination of the MCS(s) for sending the indicator(s)/report(s) as specified herein in the present disclosure for the UE-initiated reporting is irrespective/regardless of the used/applied signaling medium(s)—e.g., PUCCH and/or PUSCH—and/or the corresponding signaling medium format(s)/configuration(s)—e.g., PUCCH format(s) 0/1/2/3/4 or CG/DG PUSCH(s). The UE could also send to the network information related to the determined MCS or MCS index, e.g., in part of the indicator(s)/report(s)—e.g., in part of the trigger/pre-notification message—for the UE-initiated reporting as specified herein in the present disclosure. One conceptual example of the association/mapping between the MCS(s) and (1) type(s) of the indicator(s)/report(s) and (4) payload size(s) of the indicator(s)/report(s) as specified herein in the present disclosure for the UE-initiated reporting is provided in Table 6.
For another example, the UE could determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure according to at least (1) type(s) of the indicator(s)/report(s), (2) signaling medium(s) of the indicator(s)/report(s), and (3) format(s) of the signaling medium(s) that carries the indicator(s)/report(s). In one example, the UE could determine, e.g., BPSK (or QPSK) as the modulation scheme and/or Reed-Muller code (with a target code-rate/etc.) as the coding scheme according to the association/mapping rule(s) specified in system specifications for the indicator(s)/report(s), when/if the type(s) of the indicator(s)/report(s) corresponds to the trigger/pre-notification message in a (report-)type (A) based report or a (report-)type (C) based report according to those specified herein in the present disclosure and the UE uses/applies PUCCH format 0 as the signaling medium to send the indicator(s)/report(s). For this case, the UE could determine the payload size of the indicator(s)/report(s) from the type(s) of the indicator(s)/report(s)—e.g., 1 or 2 bit(s) for the indicator(s)/report(s) corresponding to the trigger/pre-notification message as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s). In another example, the UE could determine, e.g., a MCS index in a MCS table specified for PDSCH/PUSCH reception(s)/transmission(s) comprising a modulation order and a target code-rate, according to the association/mapping rule(s) specified in system specification(s) for the indicator(s)/report(s), when the type(s) of indicator(s)/report(s) corresponds to both the trigger/pre-notification message in a (report-)type (A) based report or a (report-)type (C) based report and a CSI/beam report comprising at least one or more resource indicators/beam metrics according to those specified herein in the present disclosure and the UE uses/applies CG (type-1 or type-2) PUSCH(s) as the signaling medium to send the indicator(s)/report(s). The UE could also send to the network information related to the determined MCS or MCS index, e.g., in part of the indicator(s)/report(s)—e.g., in part of the trigger/pre-notification message—for the UE-initiated reporting as specified herein in the present disclosure. One conceptual example of the association/mapping between the MCS(s) and (1) type(s) of the indicator(s)/report(s), (2) signaling medium(s) of the indicator(s)/report(s), and (3) format(s) of the signaling medium(s) that carries the indicator(s)/report(s) as specified herein in the present disclosure for the UE-initiated reporting is provided in Table 7.
For another example, the UE could determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure according to at least (1) type(s) of the indicator(s)/report(s)
   In one example, when/if the type(s) of the indicator(s)/report(s) corresponds to the trigger/pre-notification message in a (report-)type (A) based report or a (report-)type (C) based report according to those specified herein in the present disclosure, the UE could first determine the payload size of the indicator(s)/report(s) from the type(s) of the indicator(s)/report(s)—e.g., 1 or 2 bit(s) for the indicator(s)/report(s) corresponding to the trigger/pre-notification message as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s); the UE could then determine the signaling medium(s)—e.g., PUCCH and/or PUSCH—and/or format(s) of the signaling medium(s) that carries the indicator(s)/report(s)—e.g., PUCCH format(s) 0/1/2/3/4 and/or type-1/2 CG and/or DG PUSCH(s) corresponding to the indicator(s)/report(s)—e.g., PUCCH format 0 for the indicator(s)/report(s) corresponding to the trigger/pre-notification message as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s). Based on or according to the determined payload size of the indicator(s)/report(s) and/or the determined signaling medium(s) and the corresponding/associated format(s) for the determined signaling medium(s), the UE could determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure. The UE could also send to the network information related to the determined MCS or MCS index, e.g., in part of the indicator(s)/report(s)—e.g., in part of the trigger/pre-notification message—for the UE-initiated reporting as specified herein in the present disclosure.
   In another example, when/if the type(s) of the indicator(s)/report(s) corresponds to beam/CSI report(s) including/containing/comprising one or more configurations/activations/indications of TCI state(s) and/or resource indicators such as SSBRIs/CRIs along with their associated beam metrics such as LI-RSRPs/L1-SINRs and/or etc. as specified herein in the present disclosure in part of the content(s) in a (report-)type (B) based report or a (report-)type (C) based report according to those specified herein in the present disclosure, the UE could first determine the payload size of the indicator(s)/report(s) from the type(s) of the indicator(s)/report(s)—e.g., a number of N bits for the indicator(s)/report(s) corresponding to the CSI/beam report(s) as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network (e.g., the network 130) via uplink report(s); the UE could then determine the signaling medium(s)—e.g., PUCCH and/or PUSCH—and/or format(s) of the signaling medium(s) that carries the indicator(s)/report(s)—e.g., PUCCH format(s) 0/1/2/3/4 and/or type-1/2 CG and/or DG PUSCH(s) corresponding to the indicator(s)/report(s)—e.g., PUSCH CG type-1/2 for the indicator(s)/report(s) corresponding to the CSI/beam report(s) as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s). Based on or according to the determined payload size of the indicator(s)/report(s) and/or the determined signaling medium(s) and the corresponding/associated format(s) for the determined signaling medium(s), the UE could determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure. The UE could also send to the network information related to the determined MCS or MCS index, e.g., in part of the indicator(s)/report(s)—e.g., in part of a trigger/pre-notification message associated to the indicator(s)/report(s) for this design example—for the UE-initiated reporting as specified herein in the present disclosure.
   In another example, when/if the type(s) of the indicator(s)/report(s) corresponds to both the trigger/pre-notification message in a (report-)type (A) based report or a (report-)type (C) based report according to those specified herein in the present disclosure and the beam/CSI report(s) including/containing/comprising one or more configurations/activations/indications of TCI state(s) and/or resource indicators such as SSBRIs/CRIs along with their associated beam metrics such as L1-RSRPs/L1-SINRs and/or etc. as specified herein in the present disclosure in part of the content(s) in a (report-)type (B) based report or a (report-)type (C) based report according to those specified herein in the present disclosure, the UE could first determine the payload size of the indicator(s)/report(s) from the type(s) of the indicator(s)/report(s)—e.g., a number of M bits for the indicator(s)/report(s) corresponding to both the trigger/pre-notification message and the CSI/beam report(s) as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s); the UE could then determine the signaling medium(s)—e.g., PUCCH and/or PUSCH—and/or format(s) of the signaling medium(s) that carries the indicator(s)/report(s)—e.g., PUCCH format(s) 0/1/2/3/4 and/or type-1/2 CG and/or DG PUSCH(s) corresponding to the indicator(s)/report(s)—e.g., PUSCH CG type-1/2 for the indicator(s)/report(s) corresponding to both the trigger/pre-notification message and the CSI/beam report(s) as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s). Based on or according to the determined payload size of the indicator(s)/report(s) and/or the determined signaling medium(s) and the corresponding/associated format(s) for the determined signaling medium(s), the UE could determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure. The UE could also send to the network information related to the determined MCS or MCS index, e.g., in part of the indicator(s)/report(s)—e.g., in part of the trigger/pre-notification message associated to the indicator(s)/report(s) for this design example—for the UE-initiated reporting as specified herein in the present disclosure.

TABLE 7
an example of association(s)/mapping(s) between MCS(s), type(s)
of indicator(s)/report(s), signaling medium(s) and the corresponding
signaling medium format(s) for the UE-initiated reporting

| | | MCS index (associating |
|---|---|---|
| | | to a modulation order |
| Type(s) of the indicator(s)/report(s) | Signaling medium(s) | and a target code-rate) |
| for the UE-initiated reporting | and format(s) | in a MCS table |
| Trigger/pre-notification message | PUCCH format 0 | 1 |
| Trigger/pre-notification message | PUCCH format 1 | 2 |
| UE-initiated beam/CSI report(s) | PUCCH format 2/3/4 | 3 |
| Trigger/pre-notification message and | CG PUSCH | 4 |
| UE-initiated beam/CSI report(s) | | |
| UE-initiated beam/CSI report(s) | CG PUSCH | 5 |
| Trigger/pre-notification message and | CG PUSCH | 6 |
| UE-initiated beam/CSI report(s) | | |

In one embodiment, a UE could be provided/configured indicated by the network, e.g., via higher layer RRC signaling(s) and/or MAC CE command(s) and/or dynamic DCI based L1 signaling(s), the association/mapping between one or more of (1) type(s) of the indicator(s)/report(s), (2) signaling medium(s) of the indicator(s)/report(s), (3) format(s) of the signaling medium(s) that carries the indicator(s)/report(s), (4) payload size(s) of the indicator(s)/report(s), (5) purpose(s) of the indicator(s)/report(s) and (6) network's indication(s)/configuration(s), e.g., via higher layer RRC signaling(s)/parameter(s) and/or MAC CE command(s) and/or dynamic DCI based L1 signaling(s) as specified herein in the present disclosure for the UE-initiated reporting and various modulation and coding schemes (MCSs) used for the signaling medium(s) that sends/carries the indicator(s)/report(s) for the UE-initiated reporting.
For example, the UE (e.g., the UE 116) could be indicated/provided/configured by the network, e.g., via higher layer RRC signaling(s)/parameter(s) and/or MAC CE command(s) and/or dynamic DCI based L1 signaling(s), to determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure according to at least (1) type(s) of the indicator(s)/report(s) and (4) payload size(s) of the indicator(s)/report(s) as specified herein in the present disclosure for the UE-initiated reporting. In one example, the UE could determine, e.g., BPSK (or QPSK) as the modulation scheme and/or Reed-Muller code (e.g., with a target code-rate/etc.) as the coding scheme according to the indicated/provided/configured association/mapping rule(s) for the indicator(s)/report(s), when/if the type(s) of the indicator(s)/report(s) corresponds to the trigger/pre-notification message in a (report-)type (A) based report or a (report-)type (C) based report according to those specified herein in the present disclosure and the payload size of the indicator(s)/report(s)—in terms of number of UCI bits—is less than a threshold (e.g., 2 bits). For this case, after the UE has determined the MCS for the indicator(s)/report(s), the UE could send to the network the indicator(s)/report(s) via the allocated/configured uplink resources including PUCCH and/or PUSCH using various formats/configurations including, e.g., format(s) 0, 1, 2, 3 and/or 4 for PUCCH and/or type-1/2 CG and/or DG for PUSCH transmission(s). In another example, the UE could determine, e.g., 64QAM as the modulation scheme and/or Polar code (e.g., with a target code-rate/etc.) as the coding scheme according to the provided/indicated/configured association/mapping rule(s) for the indicator(s)/report(s), when/if the type(s) of the indicator(s)/report(s) corresponds to both the trigger/pre-notification message in a (report-)type (A) based report or a (report-)type (C) based report and a beam/CSI report (including at least one or more resource indicators and their associated beam metrics) according to those specified herein in the present disclosure and the payload size of the indicator(s)/report(s)—in terms of number of UCI bits—is greater than a threshold (e.g., 11 bits). For this case, after the UE has determined the MCS for the indicator(s)/report(s), the UE could send the indicator(s)/report(s) via the allocated/configured uplink resources including PUCCH and/or PUSCH using various formats/configurations including, e.g., format(s) 0, 1, 2, 3 and/or 4 for PUCCH and/or type-1/2 CG and/or DG for PUSCH transmission(s). That is, for this design example, the determination of the MCS(s) for sending the indicator(s)/report(s) as specified herein in the present disclosure for the UE-initiated reporting is irrespective/regardless of the used/applied signaling medium(s)—e.g., PUCCH and/or PUSCH—and/or the corresponding signaling medium format(s)/configuration(s)—e.g., PUCCH format(s) 0/1/2/3/4 or CG/DG PUSCH(s). The UE could also send to the network information related to the determined MCS or MCS index, e.g., in part of the indicator(s)/report(s)—e.g., in part of the trigger/pre-notification message—for the UE-initiated reporting as specified herein in the present disclosure.
For another example, the UE could be indicated/provided/configured by the network, e.g., via higher layer RRC signaling(s)/parameter(s) and/or MAC CE command(s) and/or dynamic DCI based L1 signaling(s), to determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure according to at least (1) type(s) of the indicator(s)/report(s), (2) signaling medium(s) of the indicator(s)/report(s), and (3) format(s) of the signaling medium(s) that carries the indicator(s)/report(s). In one example, the UE could determine, e.g., BPSK (or QPSK) as the modulation scheme and/or Reed-Muller code (with a target code-rate/etc.) as the coding scheme according to the provided/configured/indicated association/mapping rule(s) for the indicator(s)/report(s), when/if the type(s) of the indicator(s)/report(s) corresponds to the trigger/pre-notification message in a (report-)type (A) based report or a (report-)type (C) based report according to those specified herein in the present disclosure and the UE uses/applies PUCCH format 0 as the signaling medium to send the indicator(s)/report(s). For this case, the UE could determine the payload size of the indicator(s)/report(s) from the type(s) of the indicator(s)/report(s)—e.g., 1 or 2 bit(s) for the indicator(s)/report(s) corresponding to the trigger/pre-notification message as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s). In another example, the UE could determine, e.g., a MCS index in a MCS table specified for PDSCH/PUSCH reception(s)/transmission(s) comprising a modulation order and a target code-rate, according to the provided/indicated/configured association/mapping rule(s) for the indicator(s)/report(s), when the type(s) of indicator(s)/report(s) corresponds to both the trigger/pre-notification message in a (report-)type (A) based report or a (report-)type (C) based report and a CSI/beam report comprising at least one or more resource indicators/beam metrics according to those specified herein in the present disclosure and the UE uses/applies CG (type-1 or type-2) PUSCH(s) as the signaling medium to send the indicator(s)/report(s). The UE could also send to the network information related to the determined MCS or MCS index, e.g., in part of the indicator(s)/report(s)—e.g., in part of the trigger/pre-notification message—for the UE-initiated reporting as specified herein in the present disclosure.
For another example, the UE could be indicated/provided/configured by the network, e.g., via higher layer RRC signaling(s)/parameter(s) and/or MAC CE command(s) and/or dynamic DCI based L1 signaling(s), to determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure according to at least (1) type(s) of the indicator(s)/report(s)
   In one example, when/if the type(s) of the indicator(s)/report(s) corresponds to the trigger/pre-notification message in a (report-)type (A) based report or a (report-)type (C) based report according to those specified herein in the present disclosure, the UE could first determine the payload size of the indicator(s)/report(s) from the type(s) of the indicator(s)/report(s)—e.g., 1 or 2 bit(s) for the indicator(s)/report(s) corresponding to the trigger/pre-notification message as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s); the UE could then determine the signaling medium(s)—e.g., PUCCH and/or PUSCH—and/or format(s) of the signaling medium(s) that carries the indicator(s)/report(s)—e.g., PUCCH format(s) 0/1/2/3/4 and/or type-1/2 CG and/or DG PUSCH(s) corresponding to the indicator(s)/report(s)—e.g., PUCCH format 0 for the indicator(s)/report(s) corresponding to the trigger/pre-notification message as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s). Based on or according to the determined payload size of the indicator(s)/report(s) and/or the determined signaling medium(s) and the corresponding/associated format(s) for the determined signaling medium(s), the UE could determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure. The UE could also send to the network information related to the determined MCS or MCS index, e.g., in part of the indicator(s)/report(s)—e.g., in part of the trigger/pre-notification message—for the UE-initiated reporting as specified herein in the present disclosure.
   In another example, when/if the type(s) of the indicator(s)/report(s) corresponds to beam/CSI report(s) including/containing/comprising one or more configurations/activations/indications of TCI state(s) and/or resource indicators such as SSBRIs/CRIs along with their associated beam metrics such as L1-RSRPs/L1-SINRs and/or etc. as specified herein in the present disclosure in part of the content(s) in a (report-)type (B) based report or a (report-)type (C) based report according to those specified herein in the present disclosure, the UE could first determine the payload size of the indicator(s)/report(s) from the type(s) of the indicator(s)/report(s)—e.g., a number of N bits for the indicator(s)/report(s) corresponding to the CSI/beam report(s) as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s); the UE could then determine the signaling medium(s)—e.g., PUCCH and/or PUSCH—and/or format(s) of the signaling medium(s) that carries the indicator(s)/report(s)—e.g., PUCCH format(s) 0/1/2/3/4 and/or type-1/2 CG and/or DG PUSCH(s) corresponding to the indicator(s)/report(s)—e.g., PUSCH CG type-1/2 for the indicator(s)/report(s) corresponding to the CSI/beam report(s) as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s). Based on or according to the determined payload size of the indicator(s)/report(s) and/or the determined signaling medium(s) and the corresponding/associated format(s) for the determined signaling medium(s), the UE could determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure. The UE could also send to the network information related to the determined MCS or MCS index, e.g., in part of the indicator(s)/report(s)—e.g., in part of a trigger/pre-notification message associated to the indicator(s)/report(s) for this design example—for the UE-initiated reporting as specified herein in the present disclosure.
   In another example, when/if the type(s) of the indicator(s)/report(s) corresponds to both the trigger/pre-notification message in a (report-)type (A) based report or a (report-)type (C) based report according to those specified herein in the present disclosure and the beam/CSI report(s) including/containing/comprising one or more configurations/activations/indications of TCI state(s) and/or resource indicators such as SSBRIs/CRIs along with their associated beam metrics such as L1-RSRPs/L1-SINRs and/or etc. as specified herein in the present disclosure in part of the content(s) in a (report-)type (B) based report or a (report-)type (C) based report according to those specified herein in the present disclosure, the UE could first determine the payload size of the indicator(s)/report(s) from the type(s) of the indicator(s)/report(s)—e.g., a number of M bits for the indicator(s)/report(s) corresponding to both the trigger/pre-notification message and the CSI/beam report(s) as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s); the UE could then determine the signaling medium(s)—e.g., PUCCH and/or PUSCH—and/or format(s) of the signaling medium(s) that carries the indicator(s)/report(s)—e.g., PUCCH format(s) 0/1/2/3/4 and/or type-1/2 CG and/or DG PUSCH(s) corresponding to the indicator(s)/report(s)—e.g., PUSCH CG type-1/2 for the indicator(s)/report(s) corresponding to both the trigger/pre-notification message and the CSI/beam report(s) as specified herein in the present disclosure, according to, e.g., (i) network's configuration(s)/indication(s), e.g., via higher layer RRC signaling(s) and/or MAC CE command(s) and/or dynamic DCI based L1 signaling(s), (ii) fixed rule(s) in system specification(s), and/or (iii) UE's autonomous determination, which could be further sent to the network via uplink report(s). Based on or according to the determined payload size of the indicator(s)/report(s) and/or the determined signaling medium(s) and the corresponding/associated format(s) for the determined signaling medium(s), the UE could determine a MCS or a MCS index associating to a modulation order and a target code-rate in a MCS table specified for PDSCH/PUSCH reception(s)/transmission(s) for the signaling medium(s) that sends/carries the indicator(s)/report(s) as specified herein in the present disclosure. The UE could also send to the network information related to the determined MCS or MCS index, e.g., in part of the indicator(s)/report(s)—e.g., in part of the trigger/pre-notification message associated to the indicator(s)/report(s) for this design example—for the UE-initiated reporting as specified herein in the present disclosure.

A MCS table specified herein in the present disclosure could comprise one or more rows with each row comprising at least a modulation order and a target code-rate for the corresponding channel coding scheme (e.g., Reed-Muller, polar and/or LDPC code(s)). A MCS table could correspond to one of those used for determining the MCSs for PDSCH reception(s)/PUSCH transmission(s) in the system specifications (e.g., the MCS Index tables 5.1.3.1.-1, 5.1.3.1.-2, 5.1.3.1.-3, 6.1.4.1-1 and 6.1.4.1-2 in the 3GPP TS 38.214 [REF4]. Alternatively, the UE could be indicated/provided/configured by the network, e.g., via higher layer RRC signaling(s)/parameter(s) and/or MAC CE command(s) and/or dynamic DCI based L1 signaling(s), one or more such MCS table(s) for the UE-initiated reporting according to those specified herein in the present disclosure.

In one embodiment, the UE could send to the network the trigger/pre-notification message in a (report-) type (A) based report or a (report-)type (C) based report as specified herein in the present disclosure to also indicate the MCS(s) used for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message.
In one example, the UE could be provided/indicated/configured by the network, e.g., via higher layer RRC signaling(s)/parameter(s) and/or MAC CE command(s) and/or dynamic DCI based L1 signaling(s), one or more candidate MCSs and/or one or more MCS tables each comprising one or more rows with each row corresponding to a candidate MCS, wherein a candidate MCS could comprise at least a modulation order/scheme and a target code-rate for a corresponding channel coding scheme. For this case/design example, the trigger/pre-notification message as specified herein in the present disclosure could be of 1-bit (e.g., sent via PUCCH format 0/1 with the UCI size of 1 bit and BPSK). When/if the trigger/pre-notification message is set to ‘0’ (or ‘1’), the first candidate MCS among the one or more provided/configured/indicated candidate MCSs and/or the candidate MCS corresponding to the first row of a (provided/configured/indicated) MCS table as specified herein in the present disclosure could be used/applied for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message. When/if the trigger/pre-notification message is set to ‘1’ (or ‘0’), the second candidate MCS among the one or more provided/configured/indicated candidate MCSs and/or the candidate MCS corresponding to the second row of a (provided/configured/indicated) MCS table as specified herein in the present disclosure could be used/applied for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message.
In another example, the UE could be provided/indicated/configured by the network, e.g., via higher layer RRC signaling(s)/parameter(s) and/or MAC CE command(s) and/or dynamic DCI based L1 signaling(s), up to two (e.g., a first and/or a second) candidate MCSs and/or one or more MCS tables each comprising up to two (a first and/or a second) rows with each row corresponding to a candidate MCS, wherein a candidate MCS could comprise at least a modulation order/scheme and a target code-rate for a corresponding channel coding scheme. For this case/design example, the trigger/pre-notification message as specified herein in the present disclosure could be of 1-bit (e.g., sent via PUCCH format 0/1 with the UCI size of 1 bit and BPSK). When/if the trigger/pre-notification message is set to ‘0’ (or ‘1’), the first candidate MCS among the provided/configured/indicated candidate MCSs and/or the candidate MCS corresponding to the first row of a (provided/configured/indicated) MCS table as specified herein in the present disclosure could be used/applied for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message. When/if the trigger/pre-notification message is set to ‘1’ (or ‘0’), the second candidate MCS among the provided/configured/indicated candidate MCSs and/or the candidate MCS corresponding to the second row of a (provided/configured/indicated) MCS table as specified herein in the present disclosure could be used/applied for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message.
In another example, the UE could be provided/indicated/configured by the network, e.g., via higher layer RRC signaling(s)/parameter(s) and/or MAC CE command(s) and/or dynamic DCI based L1 signaling(s), one or more candidate MCSs and/or one or more MCS tables each comprising one or more rows with each row corresponding to a candidate MCS, wherein a candidate MCS could comprise at least a modulation order/scheme and a target code-rate for a corresponding channel coding scheme. For this case/design example, the trigger/pre-notification message as specified herein in the present disclosure could be of multi-bit (e.g., 2-bit sent via PUCCH format 0/1 with the UCI size of 2 bits and QPSK, or 4-bit sent via PUCCH format 2/3 with the UCI size of 4 bits, QPSK and Reed-Muller code of a target code-rate). For this case/design example, each of the state of the multi-bit trigger/pre-notification message (e.g., 4 states for a 2-bit trigger/pre-notification message and 16 states for a 4-bit trigger/pre-notification message) could correspond/associated to a candidate MCS among the one or more provided/indicated/configured candidate MCSs and a candidate MCS corresponding to a row of a (provided/configured/indicated) MCS table as specified herein in the present disclosure. The correspondence/association could be based on, (1) fixed rule(s) in system specification(s), e.g., the states of the multi-bit trigger/pre-notification message and the one or more provided/configured/indicated candidate MCSs/rows that correspond to the candidate MCSs in a (provided/configured/indicated) MCS table could be one-to-one mapped in an ascending/descending order of the candidate MCS index(es) and/or index(es) of the states of the multi-bit indicator, (2) network's configuration(s)/indication(s), e.g., via higher layer RRC signaling(s)/parameter(s) and/or MAC CE command(s) and/or dynamic DCI based LI signaling(s), and/or (3) UE's autonomous selection/determination which could be further sent to the network, e.g., via/in part of the uplink report(s). For this case/design example, when/if the trigger/pre-notification message is set to a state (e.g., ‘00’ for a 2-bit indicator), the candidate MCS among the provided/configured/indicated candidate MCSs that is associated to the state (e.g., the first candidate MCS) and/or the candidate MCS corresponding to the row of a (provided/configured/indicated) MCS table that is associated to the state (e.g., the first row) as specified herein in the present disclosure could be used/applied for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message.
In another example, the UE could be provided/indicated/configured by the network, e.g., via higher layer RRC signaling(s)/parameter(s) and/or MAC CE command(s) and/or dynamic DCI based L1 signaling(s), up to K candidate MCSs and/or one or more MCS tables each comprising up to K rows with each row corresponding to a candidate MCS, wherein a candidate MCS could comprise at least a modulation order/scheme and a target code-rate for a corresponding channel coding scheme. For this case/design example, the trigger/pre-notification message as specified herein in the present disclosure could be of k=[log₂(K)]-bit (e.g., (k=2)-bit sent via PUCCH format 0/1 with the UCI size of 2 bits and QPSK, or (k=4)-bit sent via PUCCH format 2/3 with the UCI size of 4 bits, QPSK and Reed-Muller code of a target code-rate). For this case/design example, each of the state of the k-bit trigger/pre-notification message (e.g., 4 states for a 2-bit trigger/pre-notification message and 16 states for a 4-bit trigger/pre-notification message) could correspond/associated to a candidate MCS among the provided/indicated/configured (e.g., K) candidate MCSs and a candidate MCS corresponding to a row of a (provided/configured/indicated) MCS table as specified herein in the present disclosure. The correspondence/association could be based on, (1) fixed rule(s) in system specification(s), e.g., the states of the k-bit trigger/pre-notification message and the provided/configured/indicated (e.g., K) candidate MCSs/(e.g., K) rows that correspond to the candidate MCSs in a (provided/configured/indicated) MCS table could be one-to-one mapped in an ascending/descending order of the candidate MCS index(es) and/or index(es) of the states of the k-bit indicator, (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination which could be further sent to the network, e.g., via/in part of the uplink report(s). For this case/design example, when/if the trigger/pre-notification message is set to a state (e.g., ‘00’ for a 2-bit indicator), the candidate MCS among the provided/configured/indicated candidate MCSs that is associated to the state (e.g., the first candidate MCS) and/or the candidate MCS corresponding to the row of a (provided/configured/indicated) MCS table that is associated to the state (e.g., the first row) as specified herein in the present disclosure could be used/applied for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message.

As specified herein in the present disclosure, a UE could determine the signaling medium(s), format(s) of the signaling medium(s) and/or MCS for the signaling medium(s) that carries/sends the trigger/pre-notification message as specified herein in the present disclosure according to one of:
In one example, the UE could transmit the trigger/pre-notification message as specified herein in the present disclosure via PUCCH format 0/1 with BPSK and of 1-bit UCI size, or optionally, the UE could transmit the trigger/pre-notification message via PUCCH format 0/1 with QPSK and of 2-bit UCI size, or alternatively, the UE could transmit the trigger/pre-notification message via PUCCH format 2/3 with QPSK, Reed-Muller code of a target code-rate and of 2-bit UCI size)
In another example, the UE could determine the signaling medium(s), format(s) of the signaling medium(s) and/or MCS for the signaling medium(s) that carries/sends the trigger/pre-notification message as specified herein in the present disclosure according to the association/mapping rule(s) specified herein in the present disclosure (e.g., those provided in Table 6 and Table 7 in the present disclosure).
In another example, the UE could determine the signaling medium(s), format(s) of the signaling medium(s) and/or MCS for the signaling medium(s) that carries/sends the trigger/pre-notification message as specified herein in the present disclosure according to the number of provided/configured/indicated candidate MCSs and/or number of (provided/configured/indicated) MCS tables and/or number of rows of candidate MCSs in each of the (provided/configured/indicated) MCS table.

In one embodiment, the UE could be provided/indicated/configured by the network, e.g., via higher layer RRC signaling(s)/parameter(s) and/or MAC CE command(s) and/or dynamic DCI based L1 signaling(s), one or more configurations for CG PUSCH(s), wherein a configuration for a CG PUSCH provides at least MCS information for the CG PUSCH. For this case, the UE could send to the network (e.g., the network 130) a trigger/pre-notification message in a (report-)type (A) based report or a (report-)type (C) based report as specified herein in the present disclosure to also indicate the configuration(s) for the CG PUSCH(s), and therefore, the corresponding CG PUSCH(s) and their corresponding/associated MCS(s), to use for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message. Optionally, the UE (e.g., the UE 116) could send to the network a trigger/pre-notification message in a (report-)type (A) based report or a (report-)type (C) based report as specified herein in the present disclosure, wherein the trigger/pre-notification message could also provide/indicate/include/comprise/contain the configuration(s) for the CG PUSCH(s), and therefore, the corresponding CG PUSCH(s) and their corresponding/associated MCS(s), to use for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message.

In one embodiment, the UE could send to the network a trigger/pre-notification message in a (report-) type (A) based report or a (report-)type (C) based report as specified herein in the present disclosure, wherein the trigger/pre-notification message could also provide/indicate/include/comprise/contain information related to the MCS(s) used for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message. As specified herein in the present disclosure, the information related to the MCS(s) could include modulation order(s), target code-rate(s) for a given channel coding scheme, channel coding scheme(s), index(s) of candidate MCS(s) among one or more indicated/provided configured candidate MCSs, MCS index(es) each corresponding to a row in a (provided/indicated/configured) MCS table comprising at least a modulation order and a target code-rate for a corresponding channel coding scheme.

The UE could send to the network the trigger/pre-notification message in a (report-)type (A) based report or a (report-)type (C) based report as specified herein in the present disclosure to also indicate the MCS(s) used for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message when/if one or more of the following conditions are held/satisfied/achieved.
The number of provided/configured/indicated candidate MCSs and/or number of (provided/configured/indicated) MCS tables and/or number of rows of candidate MCSs in each of the (provided/configured/indicated) MCS table for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message is less than (or greater than) a threshold, which could be determined according to: (i) fixed value(s) in system specification(s), and/or (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in part of the beam/CSI report and/or UE's capability signaling(s).
The PUCCH format(s) to be used is a short (or long) PUCCH format, e.g., PUCCH format 0, 2 (or 1, 3, 4).
The number of UCI bits is less than (or greater than) a threshold, which could be determined according to: (i) fixed value(s) in system specification(s), and/or (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination, which could be further sent to the network, e.g., in part of the beam/CSI report and/or UE's capability signaling(s).

Otherwise, i.e., when/if one or more of the conditions herein are not held/achieved/satisfied, the UE could send to the network a trigger/pre-notification message in a (report-)type (A) based report or a (report-) type (C) based report as specified herein in the present disclosure that also provides/indicates/includes/comprises/contains the information related to the MCS(s) used for the signaling medium(s) that carries/sends the UE-initiated beam/CSI report(s) in part of the content(s) in a (report-)type (B) based report or a (report-)type (C) based report as specified herein in the present disclosure associated/corresponding to the trigger/pre-notification message.

In one embodiment, the UE could send to the network, e.g., in a single reporting instance, the UE-initiated beam/CSI report(s)—e.g., including one or more resource indicators, beam metrics, configurations/activations/indications of TCI states and/or etc.—in part of the content(s) in a (report-)type (B) based report or a (report-)type (C) based report as specified herein in the present disclosure in two parts (a first part or part 1 and a second part or part 2). Part 1 and part 2 of the UE-initiated beam/CSI report(s) as specified herein in the present disclosure could be separately encoded and reported in a single reporting instance. The first part (or part 1) of the UE-initiated beam/CSI report could be of fixed payload size, which could provide or indicate information related to the second part (or part 2) of the UE-initiated beam/CSI report. Furthermore, part 1 of the UE-initiated beam/CSI report could be used to identify/indicate the size of the payload in part 2 of the UE-initiated beam/CSI report. Part 1 of the UE-initiated beam/CSI report shall be transmitted in its entirety before the transmission of part 2 of the UE-initiated beam/CSI report. In one example, part 2 of the UE-initiated beam/CSI report can be absent. When absent, the UE-initiated beam/CSI report is via part 1 only (i.e. one part UCI), and when present, the UE-initiated beam/CSI report is via both part 1 and part 2 (i.e. two-part UCI). In one example, part 2 of the UE-initiated beam/CSI report is present, but its payload could vary depending on the information in part 1. In the present disclosure, part 1 of the UE-initiated beam/CSI report could provide/indicate information related to the MCS(s) used for the signaling medium(s) that carries/sends (part 1 and/or part 2 of) the UE-initiated beam/CSI report(s) in part of the content(s) in a (report-)type (B) based report or a (report-)type (C) based report as specified herein in the present disclosure associated/corresponding to the trigger/pre-notification message.
In one example, the UE could be provided/indicated/configured by the network, e.g., via higher layer RRC signaling(s)/parameter(s) and/or MAC CE command(s) and/or dynamic DCI based L1 signaling(s), one or more candidate MCSs and/or one or more MCS tables each comprising one or more rows with each row corresponding to a candidate MCS, wherein a candidate MCS could comprise at least a modulation order/scheme and a target code-rate for a corresponding channel coding scheme. For this case/design example, part 1 of the UE-initiated beam/CSI report(s) as specified herein in the present disclosure could provide/contain/include a one-bit indicator. When/if the one-bit indicator is set to ‘0’ (or ‘1’), the first candidate MCS among the one or more provided/configured/indicated candidate MCSs and/or the candidate MCS corresponding to the first row of a (provided/configured/indicated) MCS table as specified herein in the present disclosure could be used/applied for the signaling medium(s) that carries/sends (part 1 and/or part 2) of the UE-initiated beam/CSI report(s) in part of the content(s) in a (report-)type (B) based report or a (report-)type (C) based report as specified herein in the present disclosure. When/if the one-bit indicator is set to ‘1’ (or ‘0’), the second candidate MCS among the one or more provided/configured/indicated candidate MCSs and/or the candidate MCS corresponding to the second row of a (provided/configured/indicated) MCS table as specified herein in the present disclosure could be used/applied for the signaling medium(s) that carries/sends (part 1 and/or part 2 of) the UE-initiated beam/CSI report(s) in part of the content(s) in a (report-)type (B) based report or a (report-)type (C) based report as specified herein in the present disclosure.
In another example, the UE could be provided/indicated/configured by the network, e.g., via higher layer RRC signaling(s)/parameter(s) and/or MAC CE command(s) and/or dynamic DCI based L1 signaling(s), up to two (e.g., a first and/or a second) candidate MCSs and/or one or more MCS tables each comprising up to two (a first and/or a second) rows with each row corresponding to a candidate MCS, wherein a candidate MCS could comprise at least a modulation order/scheme and a target code-rate for a corresponding channel coding scheme. For this case/design example, part 1 of the UE-initiated beam/CSI report(s) as specified herein in the present disclosure could provide/contain/include a one-bit indicator. When/if the one-bit indicator is set to ‘0’ (or ‘1’), the first candidate MCS among the provided/configured/indicated candidate MCSs and/or the candidate MCS corresponding to the first row of a (provided/configured/indicated) MCS table as specified herein in the present disclosure could be used/applied for the signaling medium(s) that carries/sends (part 1 and/or part 2 of) the UE-initiated beam/CSI report(s) in part of the content(s) in a (report-)type (B) based report or a (report-)type (C) based report as specified herein in the present disclosure. When/if the one-bit indicator is set to ‘1’ (or ‘0’), the second candidate MCS among the provided/configured/indicated candidate MCSs and/or the candidate MCS corresponding to the second row of a (provided/configured/indicated) MCS table as specified herein in the present disclosure could be used/applied for the signaling medium(s) that carries/sends (part 1 and/or part 2 of) the UE-initiated beam/CSI report(s) in part of the content(s) in a (report-)type (B) based report or a (report-)type (C) based report as specified herein in the present disclosure.
In another example, the UE could be provided/indicated/configured by the network, e.g., via higher layer RRC signaling(s)/parameter(s) and/or MAC CE command(s) and/or dynamic DCI based L1 signaling(s), one or more candidate MCSs and/or one or more MCS tables each comprising one or more rows with each row corresponding to a candidate MCS, wherein a candidate MCS could comprise at least a modulation order/scheme and a target code-rate for a corresponding channel coding scheme. For this case/design example, part 1 of the UE-initiated beam/CSI report(s) as specified herein in the present disclosure could provide/contain/include a multi-bit indicator. For this case/design example, each of the state of the multi-bit indicator (e.g., 4 states for a 2-bit indicator and 16 states for a 4-bit indicator) could correspond/associated to a candidate MCS among the one or more provided/indicated/configured candidate MCSs and a candidate MCS corresponding to a row of a (provided/configured/indicated) MCS table as specified herein in the present disclosure. The correspondence/association could be based on, (1) fixed rule(s) in system specification(s), e.g., the states of the multi-bit indicator and the one or more provided/configured/indicated candidate MCSs/rows that correspond to the candidate MCSs in a (provided/configured/indicated) MCS table could be one-to-one mapped in an ascending/descending order of the candidate MCS index(es) and/or index(es) of the states of the multi-bit indicator, (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination which could be further sent to the network, e.g., via/in part of the uplink report(s). For this case/design example, when/if the multi-bit indicator is set to a state (e.g., ‘00’ for a 2-bit indicator), the candidate MCS among the provided/configured/indicated candidate MCSs that is associated to the state (e.g., the first candidate MCS) and/or the candidate MCS corresponding to the row of a (provided/configured/indicated) MCS table that is associated to the state (e.g., the first row) as specified herein in the present disclosure could be used/applied for the signaling medium(s) that carries/sends (part 1 and/or part 2 of) the UE-initiated beam/CSI report(s) in part of the content(s) in a (report-)type (B) based report or a (report-)type (C) based report as specified herein in the present disclosure.
In another example, the UE could be provided/indicated/configured by the network, e.g., via higher layer RRC signaling(s)/parameter(s) and/or MAC CE command(s) and/or dynamic DCI based L1 signaling(s), up to K candidate MCSs and/or one or more MCS tables each comprising up to K rows with each row corresponding to a candidate MCS, wherein a candidate MCS could comprise at least a modulation order/scheme and a target code-rate for a corresponding channel coding scheme. For this case/design example, part 1 of the UE-initiated beam/CSI report(s) as specified herein in the present disclosure could provide/contain/include a k-bit indicator with k=[log₂(K)]-bit. For this case/design example, each of the state of the k-bit indicator (e.g., 4 states for a 2-bit indicator and 16 states for a 4-bit indicator) could correspond/associated to a candidate MCS among the provided/indicated/configured (e.g., K) candidate MCSs and a candidate MCS corresponding to a row of a (provided/configured/indicated) MCS table as specified herein in the present disclosure. The correspondence/association could be based on, (1) fixed rule(s) in system specification(s), e.g., the states of the k-bit indicator and the provided/configured/indicated (e.g., K) candidate MCSs/(e.g., K) rows that correspond to the candidate MCSs in a (provided/configured/indicated) MCS table could be one-to-one mapped in an ascending/descending order of the candidate MCS index(es) and/or index(es) of the states of the k-bit indicator, (2) network's configuration(s)/indication(s), e.g., via higher layer RRC signaling(s)/parameter(s) and/or MAC CE command(s) and/or dynamic DCI based L1 signaling(s), and/or (3) UE's autonomous selection/determination which could be further sent to the network, e.g., via/in part of the uplink report(s). For this case/design example, when/if the k-bit indicator is set to a state (e.g., ‘00’ for a 2-bit indicator), the candidate MCS among the provided/configured/indicated candidate MCSs that is associated to the state (e.g., the first candidate MCS) and/or the candidate MCS corresponding to the row of a (provided/configured/indicated) MCS table that is associated to the state (e.g., the first row) as specified herein in the present disclosure could be used/applied for the signaling medium(s) that carries/sends (part 1 and/or part 2 of) the UE-initiated beam/CSI report(s) in part of the content(s) in a (report-)type (B) based report or a (report-)type (C) based report as specified herein in the present disclosure.

Optionally, the UE could send to the network (e.g., the network 130) a trigger/pre-notification message in a (report-)type (A) based report or a (report-)type (C) based report as specified herein in the present disclosure to also indicate the MCS(s) used for the signaling medium(s) that carries/sends, e.g., part 1 of, the UE-initiated beam/CSI report(s) in part of the content(s) in a (report-)type (B) based report or a (report-)type (C) based report as specified herein in the present disclosure associated/corresponding to the trigger/pre-notification message according to those specified herein in the present disclosure, and/or the UE could send to the network a trigger/pre-notification message in a (report-)type (A) based report or a (report-)type (C) based report as specified herein in the present disclosure that also provides/indicates/includes/comprises/contains the information related to the MCS(s) used for the signaling medium(s) that carries/sends, e.g., part 1 of, the UE-initiated beam/CSI report(s) in part of the content(s) in a (report-)type (B) based report or a (report-)type (C) based report as specified herein in the present disclosure associated/corresponding to the trigger/pre-notification message.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate).

The present disclosure provides various detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents detailed methods of sending the UE-initiated report as a UCI over PUCCH and/or PUSCH.

In one example, when there is no content associated with a pre-notification message/trigger, i.e., the report-type is (A), the trigger/pre-notification message simply provides a ‘hint/alarm/cue’ to the target entity according to at least one of the following examples.
For example, the hint is about the communication link/channel. For example, it can imply a need for a new or updated report (e.g. beam or CSI or TDCP). In this case, it is up to NW whether to configure a report for the content (separately).
For another example, the hint is about an RS transmission. For example, it can imply a need for an aperiodic or semi-persistent RS (e.g. CSI-RS, SRS) transmission. The RS transmission can be from the target entity, or from the UE.
For another example, the hint is about a selection/switch. For example, it can imply a need for switching from current A to another A, where A is one of current panel(s), TRP(s)/RRH(s), resource sets, antenna groups, antenna port groups.
For another example, the hint is about beam/CSI parameters. For example, the parameter can be codebook type (e.g. from Type I to Type II or vice versa), or rank restriction (e.g. from high rank to low rank or vice versa).
For another example, the hint is about RS parameters. For example, the parameter can be related to a AP RS trigger, or RS periodicity, or number of SRS ports (panel switch, 1 panel to 2 panel or vice versa) or number of RS resources.
For another example, the hint is about transmission scheme, which can be one of PMI-based, diversity (CDD, cycling, SFBC), reciprocity (NCB, or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint is about transmission parameters, e.g. MCS, or number of CWs.
For another example, when there is no pre-notification message/trigger associated with a content, i.e., the report-type is (B), the content can be transmitted using UL resource(s) configured (e.g. configured-grant PUSCH), or reserved for the UE-initiated report, or via a RACH procedure.

In one embodiment, a UE could send to the network, in one or more UE-initiated report, one or more indicators/triggers (or contents as specified herein in the present disclosure corresponding to the trigger/pre-notification message) each comprising/including/containing or corresponding to one or more of:
An identity (ID) of the TCI state
An index/ID of a higher layer RRC configured list/set/pool of TCI states that comprises/indicates/provides the TCI state.
An index of the TCI state in a list/set/pool of TCI states higher layer RRC configured to the UE
An index of the TCI state in a set of TCI states activated by a (unified) TCI state(s) activation/deactivation MAC CE
An index/ID of a set of TCI states—e.g., among sets of TCI states activated/provided by a (unified) TCI state(s) activation/deactivation MAC CE—that comprises/indicates/provides the TCI state
An index of the TCI state among TCI states mapped to a TCI codepoint activated/provided by a (unified) TCI state(s) activation/deactivation MAC CE
A TCI codepoint activated/provided by a (unified) TCI state(s) activation/deactivation MAC CE that comprises/indicates/provides the TCI state
An index/ID of a TCI codepoint—e.g., among TCI codepoints activated/provided by a (unified) TCI state(s) activation/deactivation MAC CE—that comprises/indicates/provides the TCI state
An index of the TCI state among TCI states indicated by a TCI codepoint of a TCI field in a beam indication DCI (e.g., DCI format 1_1/1_2 with or without DL assignment)
An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received
An index/ID of or information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received
RS index(es)/ID(s) such as SSB index(es)/ID(s) and/or CSI-RS resource index(es)/ID(s) provided/indicated in the TCI state along with the corresponding QCL-type(s)
Resource indicator(s) such as SSBRI(s) and/or CRI(s) reported in one or more CSI/beam reports
Beam metric(s) such as L1-RSRP(s) and/or L1-SINR(s) reported in one or more CSI/beam reports
Index(es)/ordering(s) of resource indicator(s) such as SSBRI(s) and/or CRI(s) among resource indicators such as SSBRIs and/or CRIs reported in one or more CSI/beam reports
Index(es)/ordering(s) of resource indicator(s) such as SSBRI(s) and/or CRI(s) among resource indicators such as SSBRIs and/or CRIs reported for TCI state(s)/beam(s) activation/deactivation/sub-selection as specified herein in the present disclosure in one or more CSI/beam reports
Index(es)/ordering(s) of resource indicator(s) such as SSBRI(s) and/or CRI(s) among candidate resource indicators such as SSBRIs and/or CRIs—as specified herein in the present disclosure—reported in one or more CSI/beam reports
Index(es)/ordering(s) of beam metric(s) such as L1-RSRP(s) and/or L1-SINR(s) among beam metrics such as L1-RSRPs and/or L1-SINRs reported in one or more beam/CSI reports
Index(es)/ordering(s) of beam metric(s) such as L1-RSRP(s) and/or L1-SINR(s) among beam metrics such as L1-RSRPs and/or L1-SINRs corresponding to resource indicators such as SSBRIs and/or CRIs reported for TCI state(s)/beam(s) activation/deactivation/sub-selection as specified herein in the present disclosure in one or more CSI/beam reports
Index(es)/ordering(s) of beam metric(s) such as L1-RSRP(s) and/or L1-SINR(s) among beam metrics such as L1-RSRPs and/or L1-SINRs corresponding to candidate resource indicators such as SSBRIs and/or CRIs—as specified herein in the present disclosure—reported in one or more CSI/beam reports
Group(s)/pair(s) of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of resource indicators among groups/pairs of candidate resource indicators such as SSBRIs and/or CRIs—as specified herein in the present disclosure—reported in one or more CSI/beam reports
Group(s)/pair(s) of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of resource indicators such as SSBRIs CRIs reported for TCI state(s)/beam(s) activation/deactivation/sub-selection as specified herein in the present disclosure in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of candidate resource indicators such as SSBRIs and/or CRIs—as specified herein in the present disclosure-reported in one or more CSI/beam reports
A bitmap with each bit position of the bitmap corresponding to a candidate TCI state/TCI state ID/TCI state index/RS index or ID/resource indicator/etc. according to those specified herein in the present disclosure; for this case, when/if a bit position of the bitmap is set to ‘1’ (or ‘0’), the TCI state/TCI state ID/TCI state index/RS index or ID/resource indicator/etc. corresponding to the bit position could be for the UE-initiated beam(s)/TCI state(s) switching/update/change as specified herein in the present disclosure.

Throughout the present disclosure, an index could correspond to the “first”, the “second”, and etc. Furthermore, throughout the present disclosure, “trigger” can also be referred to as “initiate” or “indicate”; i.e., they can be used/applied to various design examples throughout the present disclosure interchangeably. For instance, the UE could send to the network an indicator to trigger a TCI state change/update/switch for one or more channels or signals. Furthermore, throughout the present disclosure, a MCS can be replaced by a transport block size (TBS) and/or a MCS table can be replaced by a TBS table, and the corresponding operations/procedures equally apply.

The indicator(s) described herein in the present disclosure could correspond to the trigger/pre-notification message in a (report-)type (A) based report or a (report-)type (C) based report, or part of the (corresponding) content in a (report-)type (B) based report or a (report-)type (C) based report. Furthermore, the signaling medium/container for reporting the indicator(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI and etc. The UE (e.g., the UE 116) may expect to receive from the network an ACK (or NACK) for the indicator(s) specified herein in the present disclosure within a first time window/offset (e.g., in terms of the number of slots/symbols/etc.) starting from the transmission of the indicator(s) (e.g., starting from the corresponding slot/symbol/etc.). The value of the first time window/offset could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network via uplink channels such as PUCCH/PUSCH.
When/if the UE does not receive from the network an ACK for the indicator(s) within the first time window/offset starting from the transmission of the indicator(s) or receives a NACK for the indicator(s) within the first time window/offset starting from the transmission of the indicator(s), the UE could (re-)send the indicator(s).
When/if the UE receives from the network an ACK for the indicator(s) within the first time window/offset starting from the transmission of the indicator(s), the UE may perform the behaviors/operations and/or expect the corresponding network's operations according to the indicator(s) X duration/offset/time (e.g., X symbols/slots/etc.) starting from the reception of the ACK message for the indicator(s). The value of X could be: (i) fixed in the system specification(s), (ii) configured/provided/indicated by the network, e.g., via higher layer RRC signaling/parameter and/or MAC CE command and/or dynamic DCI based L1 signaling, or (iii) autonomously determined by the UE and sent to the network (e.g., the network 130) via uplink channels such as PUCCH/PUSCH.

The UE could be indicated/configured/provided by the network, e.g., via higher layer RRC signaling/parameter and/or MAC CE command and/or dynamic DCI based L1 signaling, the ACK (or NACK) for the indicator(s) specified herein in the present disclosure. For instance, The UE could be indicated/configured/provided by the network, e.g., via higher layer RRC signaling/parameter and/or MAC CE command and/or dynamic DCI based L1 signaling, a one-bit indicator to indicate ACK or NACK for the indicator(s) specified herein in the present disclosure for the UE-initiated beam operation; when/if the one-bit indicator is set to ‘1’ (or ‘0’), the one-bit indicator could indicate an ACK for the indicator(s) sent by the UE for the UE-initiated beam operation; and when/if the one-bit indicator is not present/configured or is set to ‘0’ (or ‘1’), the one-bit indicator could indicate a NACK for the indicator(s) sent by the UE for the UE-initiated beam operation. Furthermore, when/if provided/indicated in a DCI, the ACK (or NACK)—e.g., the one-bit indicator as described herein—for the indicator(s) sent by the UE for the UE-initiated beam operation such as UE-initiated TCI state(s)/beam(s) switching/update/change could be indicated/provided via one or more new/dedicated DCI fields—e.g., denoted by ‘ACK/NACK for UE-initiated beam switching’ field(s)—in the DCI. Alternatively, when/if provided/indicated in a DCI, the ACK (or NACK)—e.g., the one-bit indicator as described herein—for the indicator(s) sent by the UE for the UE-initiated beam operation including UE-initiated TCI state(s)/beam(s) switching/update/change could be indicated/provided via/by repurposing one or more bits of one or more existing DCI fields in the DCI. For instance, the ‘New Data Indicator’ (NDI) field in a DCI could be repurposed/used to indicate the ACK (or NACK) for the indicator(s) sent by the UE for the UE-initiated beam operation; when/if the NDI field is toggled or is set to ‘1’ (or ‘0’), the NDI could indicate an ACK for the indicator(s) sent by the UE for the UE-initiated beam operation including UE-initiated TCI state(s)/beam(s) switching/update/change; otherwise, the NDI could indicate a NACK for the indicator(s) sent by the UE for the UE-initiated beam operation including UE-initiated TCI state(s)/beam(s) switching/update/change.

Throughout the present disclosure, a UE-initiated (UEI) report could provide/contain/include/comprise one or more of the indicators/triggers as described herein in the present disclosure, which could correspond to the trigger/pre-notification message in a (report-)type (A) based report or a (report-)type (C) based report, or part of the (corresponding) content in a (report-)type (B) based report or a (report-)type (C) based report according to those specified herein in the present disclosure. For this case, uplink control information (UCI) types reported in a PUCCH could include the UEI report, and UCI bits could include UEI report bits.

A UE could be configured up to four sets of PUCCH resources in a PUCCH-Config. A PUCCH resource set is provided by PUCCH-ResourceSet and is associated with a PUCCH resource set index provided by pucch-ResourceSetId, with a set of PUCCH resource indexes provided by resourceList that provides a set of pucch-ResourceId used in the PUCCH resource set, and with a maximum number of UCI information bits the UE can transmit using a PUCCH resource in the PUCCH resource set provided by maxPayloadSize. For the first PUCCH resource set, the maximum number of UCI information bits is 2. A maximum number of PUCCH resource indexes for a set of PUCCH resources is provided by maxNrofPUCCH-ResourcesPerSet. The maximum number of PUCCH resources in the first PUCCH resource set is 32 and the maximum number of PUCCH resources in the other PUCCH resource sets is 8.

If the UE transmits O_{UCI} UCI information bits, that include hybrid automatic repeat request acknowledgement (HARQ-ACK) information bits and UEI report bits, the UE could determine a PUCCH resource set to be
a first set of PUCCH resources with pucch-ResourceSetId=0 if O_{UCI}≤2 including 1 or 2 HARQ-ACK information bits and a positive or negative SR on one SR transmission occasion and/or 1 or 2 UEI report bits if transmission of HARQ-ACK information and SR and/or UEI report occurs simultaneously, or
a second set of PUCCH resources with pucch-ResourceSetId=1, if provided by higher layers, if 2<O_{UCI}≤N₂ where N₂ is equal to maxPayloadSize if maxPayloadSize is provided for the PUCCH resource set with pucch-ResourceSetId=1; otherwise N₂ is equal to 1706, or
a third set of PUCCH resources with pucch-ResourceSetId=2, if provided by higher layers, if N₂<O_{UCI}≤N₃ where N₃ is equal to maxPayloadSize if maxPayloadSize is provided for the PUCCH resource set with pucch-ResourceSetId=2; otherwise N₃ is equal to 1706, or
a fourth set of PUCCH resources with pucch-ResourceSetId=3, if provided by higher layers, if N₃<O_{UCI}≤1706.

Furthermore, if a UE is not transmitting PUSCH, and the UE is transmitting UCI, the UE could transmit UCI in a PUCCH using
PUCCH format 0 if
   the transmission is over 1 symbol or 2 symbols,
   the number of HARQ-ACK information bits with positive or negative SR (HARQ-ACK/SR bits) is 1 or 2, and/or
   the number of UEI report bits is 1 or 2
PUCCH format 1 if
   the transmission is over 4 or more symbols,
   the number of HARQ-ACK/SR bits is 1 or 2, and/or
   the number of UEI report bits is 1 or 2
PUCCH format 2 if
   the transmission is over 1 symbol or 2 symbols,
   the number of UCI bits is more than 2, and/or
   the number of UEI report bits is 1 or 2
PUCCH format 3 if
   the transmission is over 4 or more symbols,
   the number of UCI bits, including e.g. UEI report bits, is more than 2,
   the PUCCH resource does not include an orthogonal cover code, or the UE is provided useInterlacePUCCH-PUSCH in BWP-UplinkDedicated
PUCCH format 4 if
   the transmission is over 4 or more symbols,
   the number of UCI bits, including e.g., UEI report bits, is more than 2,
   the PUCCH resource includes an orthogonal cover code and the UE is not provided useInterlacePUCCH-PUSCH in BWP-UplinkDedicated

A UE could first determine a number of UEI report bits O_{UEI} and a corresponding set of PUCCH resources according to those specified herein in the present disclosure. If O_{UEI}=0, the UE may not transmit a PUCCH that only includes UEI report bits.

In addition, for a PUCCH transmission with UEI report, a UE could determine a PUCCH resource on the cell of the PUCCH transmission, after determining a set of PUCCH resources for O_{UEI} UEI report bits. The PUCCH resource determination could be based on a PUCCH resource indicator field, if present, in a last DCI format, excluding the semi-persistent scheduling (SPS) activation DCI, among one or more DCI formats that provide necessary information related to the UEI report, indicating a same slot for the PUCCH transmission, that the UE detects and for which the UE transmits corresponding UEI report in the PUCCH.

For the first set of PUCCH resources and when the size R_{PUCCH} of resourceList is larger than eight, when a UE provides UEI report in a PUCCH transmission in response to detecting a last DCI format in a physical downlink control channel (PDCCH) reception, excluding the SPS activation DCI, among one or more DCI formats that provide necessary information related to the UEI report, indicating a same slot for the PUCCH transmission, the UE determines a PUCCH resource with index r_{PUCCH}, 0≤r_{PUCCH}≤R_{PUCCH}−1, as

$${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ ⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + {R}_{PUCCH} mod 8 & if {Δ}_{PRI} \geq {R}_{PUCCH} mod 8\end{matrix} \}$$

where N_{CCE,p} is a number of CCEs in CORESET p of the PDCCH reception for the DCI format, n_{CCE,p} is the index of a first CCE for the PDCCH reception, and Δ_{PRI} is a value of the PUCCH resource indicator field in the corresponding DCI format. When the PDCCH reception includes first and second PDCCH candidates from respective first and second search space sets, the CORESET is associated with the search space set having the smaller index. If
the first search space set has larger index than the second search space set and includes the first PDCCH candidate and a third PDCCH candidate that have same first CCE index and CCE aggregation levels 8 and 16, or 16 and 8, respectively,
the second search space set includes the second PDCCH candidate that has same index and same CCE aggregation level as the first PDCCH candidate, and a fourth PDCCH candidate that has same index and same CCE aggregation level as the third PDCCH candidate,
the CORESET associated with the first search space set has cce-REG-MappingType=‘nonInterleaved’ and has duration of one symbol, and
the second PDCCH candidate has different first CCE index than the fourth PDCCH candidate the UE determines n_{CCE,0} from the PDCCH candidate with CCE aggregation level 16 among the second PDCCH candidate and the fourth PDCCH candidate. If the DCI format does not include a PUCCH resource indicator field, Δ_{PRI}=0.

If a UE transmits a PUCCH with UEI report using PUCCH format 0, the UE could determine values m₀ and m_{CS} for computing a value of cyclic shift α where m₀ is provided by initialCyclicShift of PUCCH-format0 or, if initialCyclicShift is not provided, by the initial cyclic shift index and m_{CS} is determined from the value of one UEI report bit or from the values of two UEI report bits as specified herein in the present disclosure, respectively.

TABLE 8
mapping of values for one UEI report
bit to sequences for PUCCH format 0

| UEI report bit value | 0 | 1 |
|---|---|---|
| Sequence cyclic shift | m_{CS} = 0 | m_{CS} = 6 |

TABLE 9
mapping of values for two UEI report
bits to sequences for PUCCH format 0

| UEI report bit value | {0, 0} | {0, 1} | {1, 1} | {1, 0} |
|---|---|---|---|---|
| Sequence cyclic shift | m_{CS} = 0 | m_{CS} = 3 | m_{CS} = 6 | m_{CS} = 9 |

If a UE transmits a PUCCH with UEI report using PUCCH format 1, the UE could be provided a value for m₀ by initialCyclicShift of PUCCH-format or, if initialCyclicShift is not provided, by the initial cyclic shift index.

If a UE transmits a PUCCH with O_{UEI} UEI report bits and O_{CRC} bits using PUCCH format 2 or PUCCH format 3 in a PUCCH resource that includes M_{RB}^{PUCCH} physical resource blocks (PRBs), the UE could determine a number of PRBs M_{RB,min}^{PUCCH} for the PUCCH transmission to be the minimum number of PRBs, that is smaller than or equal to a number of PRBs M_{RB}^{PUCCH} provided respectively by nrofPRBs of PUCCH-format2 or nrofPRBs of PUCCH-format3 and start from the first PRB from the number of PRBs, that results to (O_{UEI}+O_{CRC})≤M_{RB,min}^{PUCCH}·N_{sc,ctrl}^{RB}·N_{symb-UCI}^{PUCCH}·Qₘ·r and, if M_{RB}^{PUCCH}>1, (O_{UEI}+O_{CRC})>(M_{RB,min}^{PUCCH}−1)·N_{sc,ctrl}^{RB}·N_{symb-UCI}^{PUCCH}·Qₘ·r, where N_{sc,ctrl}^{RB}, N_{symb-UCI}^{PUCCH}, Qₘ, and r are defined in clause 9.2.5.2 in the 3GPP TS 38.213 [REF3]. For PUCCH format 3, if M_{RB,min}^{PUCCH} is not equal 2^{α}^{₂}·3^{α}^{₃}·5^{α}^{₅}, M_{RB,min}^{PUCCH} is increased to the nearest allowed value of nrofPRBs. If (O_{UCI}+O_{CRC})>(M_{RB}^{PUCCH}−1)·N_{sc,ctrl}^{RB}·N_{symb-UCI}^{PUCCH}·Qₘ·r, the UE could transmit the PUCCH over M_{RB}^{PUCCH} PRBS.

If a UE is provided a first interlace of M_{Interlace,0}^{PUCCH} PRBs by interlace0 in InterlaceAllocation and transmits a PUCCH with O_{UCI} UEI report bits and O_{CRC} bits using PUCCH format 2 or PUCCH format 3, the UE could transmit the PUCCH over the first interlace if (O_{UEI}+O_{CRC})≤M_{Interlace,0}^{PUCCH}·N_{sc,ctrl}^{RB}·N_{symb-UCI}^{PUCCH}·Qₘ·r; otherwise, if the UE is provided a second interlace by interlace1 in PUCCH-format2 or PUCCH-format3, the UE could transmit the PUCCH over the first and second interlaces.

A UE could be be provided by higher layer parameter(s)/signaling(s) a set of configurations for UEI report in a PUCCH transmission using either PUCCH format 0 or PUCCH format 1. Furthermore, the UE can be provided, by phy-PriorityIndex in the higher layer parameter(s)/signaling(s) that provides the set of UEI report configurations, a priority index 0 or a priority index 1 for the UEI report. If the UE is not provided a priority index for UEI report, the corresponding priority index is 0. The UE could also be provided a periodicity UEIreport_{PERIODICITY} in symbols or slots and an offset UEI report_{OFFSET} in slots by periodicityAndOffset for a PUCCH transmission conveying the UEI report. If UEIreport_{PERIODICITY} is larger than one slot, the UE could determine a transmission occasion for the UEI report (e.g., a trigger/pre-notification message as specified herein in the present disclosure) in a PUCCH to be in a slot with number n_{s,f}^{μ} in a frame with number n_{f} if (n_{f}·Nₛₗₒₜ^{frame,μ}+n_{s,f}^{μ}-UEIreport_{OFFSET})mod(UEIreport_{PERIODICITY})=0. Furthermore, if UEIreport_{PERIODICITY} is one slot, the UE could expect or expect that UEIreport_{OFFSET}=0 and every slot is a transmission occasion for the UEI report in a PUCCH. If UEIreport_{PERIODICITY} is smaller than one slot, the UE could determine a transmission occasion for the UEI report in a PUCCH to start in a symbol with index l if (l−l₀modUEIreport_{PERIODICITY})modUEIreport_{PERIODICITY}=0 where l₀ is the value of startingSymbolIndex.

For example, if the UE determines that, for a transmission occasion for the UEI report in a PUCCH, the number of symbols available for the PUCCH transmission in a slot is smaller than the value provided by nrofSymbols, the UE may not transmit the PUCCH in the slot. The UEI reporting transmission occasions in a PUCCH could be subject to the limitations for UE transmissions. The UE could transmit a PUCCH in the PUCCH resource for the corresponding configuration for UEI reporting only when the UE transmits a positive UEI report value. For a positive UEI report value transmission using PUCCH format 0, the UE could transmit the PUCCH by obtaining m₀ as described herein in the present disclosure and by setting m_{CS}=0. For a positive UEI report value transmission using PUCCH format 1, the UE could transmit the PUCCH by setting b(0)=0 according to those specified herein in the present disclosure.

For another example, if a UE is configured with multiple PUCCH resources in a slot to transmit the UEI reports as specified herein in the present disclosure
if the UE is not provided by the network PUCCH resources for transmission of multiple UEI reports or if PUCCH resources for transmissions of the UEI reports do not overlap in the slot, the UE could determine a first resource corresponding to a UEI report with the highest priority
   if the first resource includes PUCCH format 2, and if there are remaining resources in the slot that do not overlap with the first resource, the UE determines a UEI report with the highest priority, among the UEI reports with corresponding resources from the remaining resources, and a corresponding second resource as an additional resource for the UEI reporting
   if the first resource includes PUCCH format 3 or PUCCH format 4, and if there are remaining resources in the slot that include PUCCH format 2 and do not overlap with the first resource, the UE determines a UEI report with the highest priority, among the UEI reports with corresponding resources from the remaining resources, and a corresponding second resource as an additional resource for the UEI reporting
if the UE is provided by the network PUCCH resources for transmission of multiple UEI reports and if any of the multiple PUCCH resources overlap, the UE could multiplex the UEI reports in a resource from the resources provided by the network as described herein.

Furthermore, a UE could be provided/indicated/configured by the network, e.g., via higher layer RRC signalling(s)/parameter(s)—e.g., a higher layer parameter simultaneousHARQ-ACK-CSI-UEIreport—and MAC CE command(s) and/or dynamic DCI based L1 signalling(s), to multiplex DL HARQ-ACK information, with or without SR, and/or CSI report(s), and/or UEI report(s) as specified herein in the present disclosure in a same PUCCH; otherwise, the UE drops the CSI report(s) and includes only DL HARQ-ACK information, with or without SR, in the PUCCH, or the UE drops the CSI report(s) and includes the UEI report(s) and/or DL HARQ-ACK information in the PUCCH, with or without SR, or the UE drops the UEI report(s) and includes the CSI report(s) and/or DL HARQ-ACK information, with or without SR, in the PUCCH. If the UE would transmit multiple PUCCHs in a slot that include DL HARQ-ACK information, and/or CSI report(s), and/or UEI report(s) according to those specified herein in the present disclosure, the UE could expect to be provided a same configuration (of) simultaneousHARQ-ACK-CSI-UEIreport for each of PUCCH formats 2, 3, and 4.

If a UE would transmit multiple PUCCHs in a slot that include HARQ-ACK information, and/or SR, and/or CSI reports and/or UEI report(s), and any PUCCH with HARQ-ACK information in the slot that satisfies the timing conditions as provided in system specification(s) and does not overlap with any other PUCCH or PUSCH in the slot that does not satisfy the timing conditions as those provided in system specifications, the UE could multiplex the HARQ-ACK information, and/or SR, and/or CSI reports, and/or UEI report(s) as specified herein in the present disclosure, and determine corresponding PUCCH(s) for transmission in the slot according to the following pseudo-code. If the multiple PUCCHs do not include HARQ-ACK information and do not overlap with any PUSCH transmission by the UE in response to a DCI format detection by the UE, the timing conditions provided in the corresponding system specification(s) do not apply.

If
a UE is not provided multi-CSI-PUCCH-ResourceList, and/or the UE is not provided by the network (e.g., the network 130) PUCCH resources for transmission of multiple UEI reports, and
a resource for a PUCCH transmission with HARQ-ACK information in response to SPS PDSCH reception and/or a resource for a PUCCH associated with a SR occasion and/or a resource for a PUCCH associated with a UEI report overlap in time with two resources for respective PUCCH transmissions with two CSI reports, and/or a resource for a PUCCH transmission with HARQ-ACK information in response to SPS PDSCH reception and/or a resource for a PUCCH associated with a SR occasion overlap in time with two resources for respective PUCCH transmissions with one or two CSI reports and/or one or two UEI reports, and
there is no resource for a PUCCH transmission with HARQ-ACK information in response to a DCI format detection that overlaps in time with any of the previous resources, and/or there is no resource for a PUCCH transmission with UEI report that overlaps in time with any of the previous resources, and
the following pseudo code results to the UE attempting to determine a single PUCCH resource from the HARQ-ACK and/or the SR and/or the UEI report resource and the two PUCCH resources with CSI reports, and/or to determine a single PUCCH resource from the HARQ-ACK and/or the SR resource and the two PUCCH resources with CSI report(s) and/or UEI report(s)

### the UE

multiplexes the HARQ-ACK information and/or the SR and/or the UEI report in the resource for the PUCCH transmission with the CSI report having the higher priority, and/or multiplexes the HARQ-ACK information and/or the SR in the resource for the PUCCH transmission with the CSI report and/or the UEI report having the higher priority, and
does not transmit the PUCCH with the CSI report having the lower priority, and/or does not transmit the PUCCH with the UEI report having the lower priority.

Set Q to the set of resources for transmission of corresponding PUCCHs in a single slot without repetitions where
a resource with earlier first symbol is placed before a resource with later first symbol
for two resources with same first symbol, the resource with longer duration is placed before the resource with shorter duration
for two resources with same first symbol and same duration, the placement is arbitrary
   the three steps herein for the set Q are according to a subsequent pseudo-code for a function order (Q)
a resource for negative SR transmission that does not overlap with a resource for HARQ-ACK or CSI transmission or transmission of UEI report(s) is excluded from set Q
if the UE (e.g., the UE 116) is not provided simultaneousHARQ-ACK-CSI-UEIreport according to those specified herein in the present disclosure and resources for transmission of HARQ-ACK information and/or UEI report(s)—e.g., including the trigger/pre-notification message as specified herein in the present disclosure—include PUCCH format 0 or PUCCH format 2, resources that include PUCCH format 2, or PUCCH format 3, or PUCCH format 4 for transmission of CSI reports and/or UEI report(s)—e.g., including the content(s) associated to the corresponding trigger/pre-notification message as specified herein in the present disclosure—are excluded from the set Q if they overlap with any resource from the resources for transmission of HARQ-ACK information and/or UEI report(s)—e.g., including the trigger/pre-notification message as specified herein in the present disclosure
if the UE is not provided simultaneousHARQ-ACK-CSI-UEIreport according to those specified herein in the present disclosure and at least one of the resources for transmission of HARQ-ACK information and/or UEI report(s)—e.g., including the trigger/pre-notification message as specified herein in the present disclosure—includes PUCCH format 1, PUCCH format 3, or PUCCH format 4
   resources that include PUCCH format 3 or PUCCH format 4 for transmission of CSI reports and/or UEI report(s)—e.g., including the content(s) associated to the corresponding trigger/pre-notification message as specified herein in the present disclosure—are excluded from the set Q
   resources that include PUCCH format 2 for transmission of CSI reports and/or UEI report(s)—e.g., including the content(s) associated to the corresponding trigger/pre-notification message as specified herein in the present disclosure—are excluded from the set Q if they overlap with any resource from the resources for transmission of HARQ-ACK information and/or UEI report(s)—e.g., including the trigger/pre-notification message as specified herein in the present disclosure

```
Set C(Q) to the cardinality of Q
Set Q(j, 0)to be the first symbol of resource Q(j) in the slot
Set L(Q(j)) to be the number of symbols of resource Q(j) in the slot
Set j = 0 - index of first resource in set Q
Set o = 0 - counter of overlapped resources
while j ≤ C(Q) − 1
  if
    j < C(Q) − 1 and resource Q(j − o) overlaps with resource Q(j + 1)
      and the resources in set Q are of same priority index, or
    j < C(Q) − 1 and resource Q(j − o) overlaps with resource Q(j + 1),
      o = 0, the resources in set Q are of different priority indexes, and
      the UE is provided uci-MuxWithDiffPrio
  then
    o = o + 1;
    j = j + 1;
  else
    if o > 0
      determine a single resource for multiplexing UCI associated with
        resources {Q(j − o), Q(j − o + 1), ... , Q(j)}
      set the index of the single resource to j
          Q = Q\{Q(j − o), Q(j − o + 1), ... , Q(j − 1)}
      j = 0 % start from the beginning after reordering unmerged
      resources at next step
      o = 0;
      order(Q) % function that re-orders resources in current set Q
      Set C(Q) to the cardinality of Q
    else
      j = j + 1;
    end if
  end if
end while
The function order(Q) performs the following pseudo-code
{
  k = 0;
  while k < C(Q) − 1 % the next two while loops are to re-order the
  unmerged resources
    l = 0;
    while k < C(Q) − 1 − k
      if Q(l, 0) > Q(l + 1,0) OR (Q(l, 0) = Q(l + 1,0)&L(Q(l)) <
      L(Q(l + 1)))
        temp = Q(l);
        Q(l) = Q(l + 1);
        Q(l + 1) = temp;
      end if
    l = l + 1;
    end while
  k = k + 1;
  end while
}
```

For each PUCCH resource in the set Q that satisfies the timing conditions provided in the corresponding system specification(s), when applicable,
the UE could transmit a PUCCH using the PUCCH resource if the PUCCH resource does not overlap in time with a PUSCH transmission after multiplexing UCI following the procedures specified herein in the present disclosure
the UE could multiplex HARQ-ACK information and/or CSI reports and/or UEI report(s) in a PUSCH if the PUCCH resource overlaps in time with a PUSCH transmission, and does not transmit SR and/or UEI report(s). In case the PUCCH resource overlaps in time with multiple PUSCH transmissions, the PUSCH for multiplexing HARQ-ACK information and/or CSI and/or UEI report(s)—e.g., including the trigger/pre-notification message as specified herein in the present disclosure—is selected. If the PUSCH transmission by the UE is not in response to a DCI format detection and the UE multiplexes only CSI reports and/or UEI report(s), the timing conditions are not applicable
the UE does not expect the resource to overlap with a second resource of a PUCCH transmission over multiple slots if the resource is obtained from a group of resources that do not overlap with the second resource.

In one embodiment, UE behaviours/procedures for multiplexing HARQ-ACK and/or CSI and/or SR and/or UEI report(s) in a PUCCH are provided expecting one or more of the followings:
resources for transmissions of UCI types, prior to multiplexing or dropping, overlap in a slot
multiplexing conditions of corresponding UCI types in a single PUCCH are satisfied, and
the UE does not transmit any PUSCH time-overlapping with PUCCH in the slot.

In one example, a UE could be configured to transmit K PUCCHs for respective K SRs in a slot, as determined by a set of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, with SR transmission occasions that could overlap with a transmission of a PUCCH with HARQ-ACK information from the UE in the slot or with a transmission of a PUCCH with CSI report(s) from the UE in the slot or with a transmission of a PUCCH with UEI report(s) from the UE in the slot. In another example, a UE could be configured to transmit K PUCCHs for respective K UEI reports as specified herein in the present disclosure in a slot, as determined by a set of configurations for the UEI reporting as specified herein in the present disclosure, with transmission occasions for UEI report(s) that could overlap with a transmission of a PUCCH with HARQ-ACK information from the UE in the slot or with a transmission of a PUCCH with CSI report(s) from the UE in the slot or with a SR transmission occasion from the UE in the slot.

In one example, if a UE would transmit a PUCCH with positive UEI report value and at most two HARQ-ACK information bits in a resource using PUCCH format 0, the UE could transmit the PUCCH in the resource using PUCCH format 0 in PRB(s) for HARQ-ACK information. The UE could determine a value of m₀ and m_{CS} for computing a value of cyclic shift α [4, TS 38.211] [REF1] where m₀ is provided by initialCyclicShift of PUCCH-format0, and m_{CS} is determined from the value of one HARQ-ACK information bit or from the values of two HARQ-ACK information bits as in Table 10 and Table 11, respectively. Furthermore, if the UE would transmit negative UEI report value and a PUCCH with at most two HARQ-ACK information bits in a resource using PUCCH format 0, the UE could transmit the PUCCH in the resource using PUCCH format 0 for HARQ-ACK information as specified herein in the present disclosure.

TABLE 10
mapping of values for one HARQ-ACK information bit and positive
UEI report value to sequences for PUCCH format 0

| HARQ-ACK Value | 0 | 1 |
|---|---|---|
| Sequence cyclic shift | m_{CS} = 3 | m_{CS} = 9 |

TABLE 11
mapping of values for two HARQ-ACK information bits and
positive UEI report value to sequences for PUCCH format 0

| HARQ-ACK Value | {0, 0} | {0, 1} | {1, 1} | {1, 0} |
|---|---|---|---|---|
| Sequence cyclic shift | m_{CS} = 1 | m_{CS} = 4 | m_{CS} = 7 | m_{CS} = 10 |

If a UE would transmit a PUCCH with positive SR and at most two UEI report bits in a resource using PUCCH format 0, the UE could transmit the PUCCH in the resource using PUCCH format 0 in PRB(s) for UEI reporting as described herein in the present disclosure. The UE could determine a value of m₀ and m_{CS} for computing a value of cyclic shift α where m₀ is provided by initialCyclicShift of PUCCH-format0, and m_{CS} is determined from the value of one UEI report bit or from the values of two UEI report bits as in Table 12 and Table 13, respectively, wherein the UEI report could include at least a trigger/pre-notification message as specified herein in the present disclosure. If the UE would transmit negative SR and a PUCCH with at most two UEI report bits in a resource using PUCCH format 0, the UE could transmit the PUCCH in the resource using PUCCH format 0 for the UEI report(s) according to those specified herein in the present disclosure.

TABLE 12
mapping of values for one UEI report bit and
positive SR to sequences for PUCCH format 0

| UEI report bit value | 0 | 1 |
|---|---|---|
| Sequence cyclic shift | m_{CS} = 3 | m_{CS} = 9 |

TABLE 13
mapping of values for two UEI report bits and
positive SR to sequences for PUCCH format 0

| UEI report bit value | {0, 0} | {0, 1} | {1, 1} | {1, 0} |
|---|---|---|---|---|
| Sequence cyclic shift | m_{CS} = 1 | m_{CS} = 4 | m_{CS} = 7 | m_{CS} = 10 |

In one example, if a UE would transmit SR in a resource using PUCCH format 0 and UEI report bits in a resource using PUCCH format 1 in a slot, the UE could transmit only a PUCCH with the UEI report bits in the resource using PUCCH format 1. In another example, if a UE would transmit UEI report bits in a resource using PUCCH format 0 and HARQ-ACK information bits in a resource using PUCCH format 1 in a slot, the UE could transmit (1) only a PUCCH with the UEI report bits in the resource using PUCCH format 1, or (2) only a PUCCH with the HARQ-ACK information bits in the resource using PUCCH format 1, according to e.g. network's configuration(s)/indication(s) via higher layer RRC signaling(s)/parameter(s) and/or MAC CE command(s) and/or dynamic DCI based L1 signaling(s), and/or UE's capability reporting.

In one example, if the UE would transmit positive SR in a first resource using PUCCH format 1 and at most two UEI report bits in a second resource using PUCCH format 1 in a slot, the UE could transmit a PUCCH with the UEI report bits in the first resource using PUCCH format 1. If a UE would not transmit a positive SR in a resource using PUCCH format 1 and would transmit at most two UEI report bits in a resource using PUCCH format 1 in a slot, the UE could transmit a PUCCH in the resource using PUCCH format 1 for UEI reporting as specified herein in the present disclosure. In another example, if the UE would transmit positive UEI report value in a first resource using PUCCH format 1 and at most two HARQ-ACK information bits in a second resource using PUCCH format 1 in a slot, the UE could transmit, (1) a PUCCH with HARQ-ACK information bits in the first resource using PUCCH format 1, or (2) a PUCCH with UEI report bits in the first resource using PUCCH format 1, according to e.g. network's configuration(s)/indication(s) via higher layer RRC signaling(s)/parameter(s) and/or MAC CE command(s) and/or dynamic DCI based L1 signaling(s), and/or UE's capability reporting. If a UE would not transmit a positive UEI report value in a resource using PUCCH format 1 and would transmit at most two HARQ-ACK information bits in a resource using PUCCH format 1 in a slot, the UE could transmit (1) a PUCCH in the resource using PUCCH format 1 for HARQ-ACK information, or (2) a PUCCH in the resource using PUCCH format 1 for UEI reporting, according to e.g. network's configuration(s)/indication(s) via higher layer RRC signaling(s)/parameter(s) and/or MAC CE command(s) and/or dynamic DCI based L1 signaling(s), and/or UE's capability reporting.

In one example, if a UE would transmit a PUCCH with O_{UEI} UEI report bits in a resource using PUCCH format 2 or PUCCH format 3 or PUCCH format 4 in a slot, as described herein in the present disclosure, ┌ log₂(K+1)┐ bits representing a negative or positive SR, in ascending order of the values of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, could be appended to the UEI report bits and the UE could transmit the combined O_{UCI}=O_{UEI}+┌ log₂(K+1)┐ UCI bits in a PUCCH using a resource with PUCCH format 2 or PUCCH format 3 or PUCCH format 4 that the UE determines as described herein in the present disclosure. If one of the SRs is a positive LRR, the value of the ┌ log₂(K+1)┐ bits indicates the positive LRR. An all-zero value for the ┌ log₂(K+1)┐ bits represents a negative SR value across K SRs.

In another example, if a UE would transmit a PUCCH with O_{ACK} HARQ-ACK information bits in a resource using PUCCH format 2 or PUCCH format 3 or PUCCH format 4 in a slot, ┌ log₂(L+1)┐ bits representing (positive/negative value of) a UEI report could be appended to the HARQ-ACK information bits and the UE could transmit the combined O_{UCI}=O_{ACK}+┌ log₂(L+1)┐ UCI bits in a PUCCH using a resource with PUCCH format 2 or PUCCH format 3 or PUCCH format 4 that the UE determines as described herein in the present disclosure. For this case/design example, an all-zero value for the ┌ log₂(L+1)┐ bits could represent a negative UEI report value across L UEI reports.

In another example, if a UE would transmit a PUCCH with O_{CSI} CSI report bits in a resource using PUCCH format 2 or PUCCH format 3 or PUCCH format 4 in a slot, ┌ log₂(L+1)┐ bits representing (positive/negative value of) a UEI report could be prepended to the CSI information bits and the UE could transmit a PUCCH with the combined O_{UCI}=┌ log₂(L+1)┐+O_{CSI} UCI bits in a resource using the PUCCH format 2 or PUCCH format 3 or PUCCH format 4 for CSI reporting. For this case/design example, an all-zero value for the ┌ log₂(L+1)┐ bits could represent a negative UEI report value across all L UEI reports.

In one example, a UE could determine PUCCH resource(s) for transmitting the corresponding UCI according to one or more of:
In one example, if a UE would transmit a PUCCH with O_{ACK} HARQ-ACK information bits, O_{UEI}=┌ log₂(L+1)┐ UEI report bits, and O_{CRC} CRC bits using PUCCH format 2 or PUCCH format 3 in a PUCCH resource that includes M_{RB}^{PUCCH} PRBs, the UE could determine a number of PRBs M_{RB,min}^{PUCCH} for the PUCCH transmission to be the minimum number of PRBs, that is smaller than or equal to a number of PRBs provided by nrofPRBs in PUCCH-format2 or nrofPRBs in PUCCH-format3 and start from the first PRB from the number of PRBs, that results to (O_{ACK}+O_{UEI}+O_{CRC})≤M_{RB,min}^{PUCCH}·N_{sc,ctrl}^{RB}·N_{symb-UCI}^{PUCCH}·Qₘ·r and, if M_{RB}^{PUCCH}>1, (O_{ACK}+O_{UEI}+O_{CRC})>(M_{RB,min}^{PUCCH}−1)·N_{sc,ctrl}^{RB}·N_{symb-UCI}^{PUCCH}·Qₘ·r, where N_{sc,ctrl}^{RB}, N_{symb-UCI}^{PUCCH}, Qₘ, and r are defined in clause 9.2.5.2 in the 3GPP TS 38.213 [REF3]. For PUCCH format 3, if M_{RB,min}^{PUCCH} is not equal 2^{α}^{₂}·3^{α}^{₃}·5^{α}^{₅}, M_{RB,min}^{PUCCH} is increased to the nearest allowed value of nrofPRBs. If (O_{ACK}+O_{UEI}+O_{CRC})>(M_{RB}^{PUCCH}−1)·N_{sc,ctrl}^{RB}·N_{symb-UCI}^{RB}·Qₘ·r, the UE could transmit the PUCCH over the M_{RB}^{PUCCH} PRBs.
In another example, if a UE would transmit a PUCCH with O_{UEI} UEI report bits, O_{SR}=┌ log₂(K+1)┐ SR bits, and O_{CRC} CRC bits using PUCCH format 2 or PUCCH format 3 in a PUCCH resource that includes M_{RB}^{PUCCH} PRBs, the UE could determine a number of PRBs M_{RB,min}^{PUCCH} for the PUCCH transmission to be the minimum number of PRBs, that is smaller than or equal to a number of PRBs provided by nrofPRBs in PUCCH-format2 or nrofPRBs in PUCCH-format3 and start from the first PRB from the number of PRBs, that results to (O_{UEI}+O_{SR}+O_{CRC})≤M_{RB,min}^{PUCCH}·N_{sc,ctrl}^{RB}·N_{symb-UCI}^{PUCCH}·Qₘ·r and, if M_{RB}^{PUCCH}>1, (O_{UEI}+O_{SR}+O_{CRC})>(M_{RB,min}^{PUCCH}−1)·N_{sc,ctrl}^{RB}·N_{symb-UCI}^{PUCCH}·Qₘ·r, where N_{sc,ctrl}^{RB}·N_{symb-UCI}^{PUCCH}, Qₘ, and r are defined in clause 9.2.5.2 in the TS 38.213 [REF3]. For PUCCH format 3, if M_{RB,min}^{PUCCH} is not equal 2^{α}^{₂}·3^{α}^{₃}·5^{α}^{₅}, M_{RB,min}^{PUCCH} is increased to the nearest allowed value of nrofPRBs. If (O_{UEI}+O_{SR}+O_{CRC})>(M_{RB}^{PUCCH}−1)·N_{sc,ctrl}^{RB}·N_{symb-UCI}^{PUCCH}·Qₘ·r, the UE could transmit the PUCCH over the M_{RB}^{PUCCH} PRBs.
In another example, if a UE would transmit a PUCCH with O_{ACK} HARQ-ACK information bits, O_{UEI} UEI report bits, O_{SR}=┌ log₂(K+1)┐ SR bits, and O_{CRC} CRC bits using PUCCH format 2 or PUCCH format 3 in a PUCCH resource that includes M_{RB}^{PUCCH} PRBs, the UE could determine a number of PRBs M_{RB,min}^{PUCCH} for the PUCCH transmission to be the minimum number of PRBs, that is smaller than or equal to a number of PRBs provided by nrofPRBs in PUCCH-format2 or nrofPRBs in PUCCH-format3 and start from the first PRB from the number of PRBs, that results to (O_{ACK}+O_{UEI}+O_{SR}+O_{CRC})≤M_{RB,min}^{PUCCH}·N_{sc,ctrl}^{RB}·N_{symb-UCI}^{PUCCH}·Qₘ·r, and, if M_{RB}^{PUCCH}>1, (O_{ACK}+O_{UEI}+O_{SR}+O_{CRC})>(M_{RB,min}^{PUCCH}−1)·N_{sc,ctrl}^{RB}·N_{symb-UCI}^{PUCCH}·Qₘ·r, where N_{sc,ctrl}^{RB}, N_{symb-UCI}^{PUCCH}, Qₘ, and r are defined in clause 9.2.5.2 in the 3GPP TS 38.213 [REF3]. For PUCCH format 3, if M_{RB,min}^{PUCCH} is not equal 2^{α}^{₂}·3^{α}^{₃}·5^{α}^{₅}, M_{RB,min}^{PUCCH} is increased to the nearest allowed value of nrofPRBs. If (O_{ACK}+O_{UEI}+O_{SR}+O_{CRC})>(M_{RB}^{PUCCH}−1)·N_{sc,ctrl}^{RB}·N_{symb-UCI}^{PUCCH}·Qₘ·r, the UE could transmit the PUCCH over the M_{RB}^{PUCCH} PRBS.
In another example, if a UE is provided a first interlace of M_{Interlace,0}^{PUCCH} PRBs by interlace0 in InterlaceAllocation and would transmit a PUCCH with O_{UEI} UEI report bits, O_{SR}=┌ log₂(K+1)┐ SR bits, and O_{CRC} CRC bits using PUCCH format 2 or PUCCH format 3, the UE could transmit the PUCCH over the first interlace if (O_{UEI}+O_{SR}+O_{CRC})≤M_{Interlace,0}^{PUCCH}·N_{sc,ctrl}^{RB}·N_{symb-UCI}^{PUCCH}·Qₘ·r; otherwise, if the UE is provided a second interlace by interlace1 in PUCCH-format2 or PUCCH-format3, the UE could transmit the PUCCH over the first and second interlaces.
In another example, if a UE is provided a first interlace of M_{Interlace,0}^{PUCCH} PRBs by interlace0 in InterlaceAllocation and would transmit a PUCCH with O_{ACK} HARQ-ACK information bits, O_{UEI}=┌ log₂(L+1)┐ UEI report bits, and O_{CRC} CRC bits using PUCCH format 2 or PUCCH format 3, the UE could transmit the PUCCH over the first interlace if (O_{ACK}+O_{UEI}+O_{CRC})≤M_{Interlace,0}^{PUCCH}·N_{sc,ctrl}^{RB}·N_{symb-UCI}^{PUCCH}·Qₘ·r; otherwise, if the UE is provided a second interlace by interlace1 in PUCCH-format2 or PUCCH-format3, the UE could transmit the PUCCH over the first and second interlaces.
In another example, if a UE is provided a first interlace of M_{Interlace,0}^{PUCCH} PRBs by interlace0 in InterlaceAllocation and would transmit a PUCCH with O_{ACK} HARQ-ACK information bits, O_{UEI} UEI report bits, O_{SR}=┌ log₂(K+1)┐ SR bits, and O_{CRC} CRC bits using PUCCH format 2 or PUCCH format 3, the UE could transmit the PUCCH over the first interlace if (O_{ACK}+O_{UEI}+O_{SR}+O_{CRC})≤M_{Interlace,0}^{PUCCH}·N_{sc,ctrl}^{RB}·N_{symb-UCI}^{PUCCH}·Qₘ·r; otherwise, if the UE is provided a second interlace by interlace1 in PUCCH-format2 or PUCCH-format3, the UE could transmit the PUCCH over the first and second interlaces.

For a transmission occasion of a single UEI report as specified herein in the present disclosure, a PUCCH resource could be provided by the network (e.g., the network 130) via a higher layer parameter/signalling pucch-UEI-ResourceList. For a transmission occasion of multiple UEI reports, corresponding PUCCH resources can be provided by the network via a higher layer parameter/signalling multi-UEI-PUCCH-ResourceList. If a UE is provided first and second PUCCH-Config, multi-UEI-PUCCH-ResourceList is provided by the first PUCCH-Config, and PUCCH-ResourceId in pucch-CSI-ResourceList or multi-UEI-PUCCH-ResourceList could indicate a corresponding PUCCH resource in PUCCH-Resource provided by the first PUCCH-Config.

A UE could be configured by maxCodeRate a code rate for multiplexing HARQ-ACK, SR, UEI report(s), and/or CSI report(s) in a PUCCH transmission using PUCCH format 2, PUCCH format 3, or PUCCH format 4. Denote as
O_{ACK} a total number of HARQ-ACK information bits, if any
O_{SR} a total number of SR bits. O_{SR}=0 if there is no scheduling request bit; otherwise, O_{SR}=┌ log₂(K+1)┐
Σₙ₌₁^{N}^{_{CSI}}^{^{total}} (O_{CSI-part1,n}+O_{CSI-part2,n}), where O_{CSI-part1,n} is a number of Part 1 CSI report bits for CSI report with priority value n, O_{CSI-part2,n} is a number of Part 2 CSI report bits, if any, for CSI report with priority value n, and N_{CSI}^{total} is a number of CSI reports that include overlapping CSI reports total
O_{UEI} a total number of UEI report bits as specified herein in the present disclosure, if any
O_{CRC}=O_{CRC,CSI-part1}+O_{CRC,CSI-part2}, where O_{CRC,CSI-part1} is a number of CRC bits, if any, for encoding HARQ-ACK, SR, UEI report(s) and Part 1 CSI report bits and O_{CRC,CSI-part2} is a number of CRC bits, if any, for encoding Part 2 CSI report bits

In the following
r is a code rate given by maxCodeRate.
M_{RB}^{PUCCH} is a number of PRBs provided by nrofPRBs; otherwise, if nrofPRBs is not provided, M_{RB}^{PUCCH}=1
M_{RB}^{PUCCH}=M_{RB}^{PUCCH}−4 for PUCCH format 2 or, if the PUCCH resource with PUCCH format 2 includes an orthogonal cover code with length N_{RB}^{PUCCH,2} provided by occ-Length, N_{sc,ctrl}^{RB}=(N_{sc}^{RB}−4)/N_{SF}^{PUCCH,2}, N_{sc,ctrl}^{RB}=N_{sc}^{RB} for PUCCH format 3 or, if the PUCCH resource with PUCCH format 3 includes an orthogonal cover code with length N_{SF}^{PUCCH,3} provided by occ-Length, N_{sc,ctrl}^{RB}=N_{sc}^{RB}/N_{SF}^{PUCCH,3}, and N_{sc,ctrl}^{RB}=N_{sc}^{RB}/N_{SF}^{PUCCH,4} for PUCCH format 4, where N_{sc}^{RB} is a number of subcarriers per resource block
N_{symb-UCI}^{PUCCH} is equal to a number of PUCCH symbols N_{SF}^{PUCCH,2} for PUCCH format 2 provided by nrofSymbols in PUCCH-format2. For PUCCH format 3 or for PUCCH format 4, N_{symb-UCI}^{PUCCH} is equal to a number of PUCCH symbols N_{SF}^{PUCCH,3} for PUCCH format 3 or equal to a number of PUCCH symbols N_{SF}^{PUCCH,4} for PUCCH format 4 provided by nrofSymbols in PUCCH-format3 or nrofSymbols in PUCCH-format4, respectively, after excluding a number of symbols used for demodulation reference signal (DM-RS) transmission for PUCCH format 3 or for PUCCH format 4, respectively
Qₘ=1 if pi/2-BPSK is the modulation scheme and Qₘ=2 if QPSK is the modulation scheme as indicated by pi2BPSK for PUCCH format 3 or PUCCH format 4. For PUCCH format 2, Qₘ=2

If a UE (e.g., the UE 116) has one or more CSI reports and zero or more HARQ-ACK/SR information bits and/or one or more UEI reports (e.g., each includes at least the trigger/pre-notification message and/or the corresponding content(s) as specified herein in the present disclosure) to transmit in a PUCCH where the HARQ-ACK, if any, is in response to a PDSCH reception without a corresponding PDCCH
if any of the CSI reports and/or UEI reports are overlapping and the UE is provided by multi-CSI-PUCCH-ResourceList and/or multi-UEI-PUCCH-ResourceList as described herein in the present disclosure with J≤2 PUCCH resources in a slot, for PUCCH format 2 and/or PUCCH format 3 and/or PUCCH format 4, where the resources are indexed according to an ascending order for the product of a number of corresponding REs, modulation order Qₘ, and configured code rate r;
if (O_{ACK}+O_{UEI}+O_{SR}+O_{CSI}+O_{CRC})≤(M_{RB}^{PUCCH}·N_{sc,ctrl}^{RB}·N_{symb-UCI}^{PUCCH}·Qₘ·r)₀, the UE could use PUCCH format 2 resource 0, or the PUCCH format 3 resource 0, or the PUCCH format 4 resource 0
else if (O_{ACK}+O_{UEI}+O_{SR}+O_{CSI}+O_{CRC})>(M_{RB}^{PUCCH}·N_{sc,ctrl}^{RB}·N_{symb-UCI}^{PUCCH}·Qₘ·r)ⱼ and (O_{ACK}+O_{UEI}+O_{SR}+O_{CSI}+O_{CRC})≤(M_{RB}^{PUCCH}·N_{sc,ctrl}^{RB}·N_{symb-UCI}^{PUCCH}·Qₘ·r)ⱼ₊₁, 0≤j<J−1, the UE could transmit a PUCCH conveying HARQ-ACK information, SR, UEI report(s) and CSI report(s) in a respective PUCCH where the UE uses the PUCCH format 2 resource j+1, or the PUCCH format 3 resource j+1, or the PUCCH format 4 resource j+1
else the UE uses the PUCCH format 2 resource J−1, or the PUCCH format 3 resource J−1, or the PUCCH format 4 resource J−1 and the UE selects N_{CSI}^{reported} CSI report(s) and/or N_{UEI}^{reported} UEI report(s) for transmission together with HARQ-ACK information and SR and UEI report(s), when any, in ascending priority value.
else, the UE transmits the O_{ACK}+O_{UEI}+O_{SR}+O_{CSI}+O_{CRC} bits in a PUCCH resource provided by pucch-CSI-ResourceList and determined as described herein in the present disclosure.

If a UE has HARQ-ACK, SR, UEI report(s) and wideband or sub-band CSI reports to transmit and the UE determines a PUCCH resource with PUCCH format 2, or the UE has HARQ-ACK, SR, UEI report(s) and wideband CSI reports to transmit and the UE determines a PUCCH resource with PUCCH format 3 or PUCCH format 4, where
the UE could determine the PUCCH resource using the PUCCH resource indicator field in a last of a number of DCI formats, excluding the SPS activation DCI, with a value of a PDSCH-to-HARQ_feedback timing indicator field, if present, or a value of dl-DataToUL-ACK, or dl-DataToUL-ACK-r16, or dl-DataToUL-ACK-DCI-1-2, or dl-DataToUL-ACK-r17, or dl-DataToUL-ACK-DCI-1-2-r17, indicating a same slot for the PUCCH transmission, from a PUCCH resource set provided to the UE for HARQ-ACK transmission, and
the UE could determine the PUCCH resource set as described herein in the present disclosure for O_{UCI} UCI bits
   and
if (O_{ACK}+O_{SR}+O_{UEI}+O_{CSI-part1}+O_{CRC,CSI-part1})≤M_{RB}^{PUCCH}·N_{sc,ctrl}^{RB}·N_{symb-UCI}^{PUCCH}·Qₘ·r, the UE transmits the HARQ-ACK, SR, UEI report(s) and CSI reports bits by selecting the minimum number M_{RB,min}^{PUCCH} of the M_{RB}^{PUCCH} PRBs satisfying (O_{ACK}+O_{SR}+O_{UEI}+O_{CSI-part1}+O_{CRC,CSI-part1})≤M_{RB}^{PUCCH}·N_{sc,ctrl}^{RB}·N_{symb-UCI}^{PUCCH}·Qₘ·r as described herein in the present disclosure;
else, the UE could selects N_{CSI}^{reported} CSI report(s), from the N_{CSI}^{total} CSI reports, and/or N_{UEI}^{reported} UEI report(s), from the N_{UEI}^{total} UEI reports, for transmission together with HARQ-ACK, UEI report(s) and SR in ascending priority value, where the value of N_{CSI}^{reported} (and/or N_{UEI}^{reported}) satisfies (O_{ACK}+O_{SR}+O_{UEI}+Σₙ₌₁^{N}^{_{CSI}}^{^{reported}} O_{CSI-part1,n} (and/or +Σₙ₌₁^{N}^{_{UEI}}^{^{reported}} O_{UEI,n})+O_{CRC, CSI-part1,N})≤M_{RB}^{PUCCH}·N_{sc,ctrl}^{RB}·N_{symb-UCI}^{PUCCH}·Qₘ·r and (O_{ACK}+O_{SR}+O_{UEI}+Σₙ₌₁^{N}^{_{CSI}}^{^{reported}}⁺¹ O_{CSI-part1,n} (and/or +Σₙ₌₁^{N}^{_{UEI}}^{^{reported}}⁺¹ O_{UEI,n})+O_{CRC,CSI-part1,N+1})>M_{RB}^{PUCCH}·N_{sc,ctrl}^{RB}·N_{symb-UCI}^{PUCCH}·Qₘ·r, where O_{CRC, CSI-part1,N} is a number of CRC bits corresponding to O_{ACK}+O_{SR}+O_{UEI}+Σₙ₌₁^{N}^{_{CSI}}^{^{reported}} O_{CSI-part1,n} (and/or +Σₙ₌₁^{N}^{_{UEI}}^{^{reported}} O_{UEI,n}) UCI bits, and O_{CRC,CSI-part1,N+1} a number of CRC bits corresponding to O_{ACK}+O_{SR}+O_{UEI}+Σₙ₌₁^{N}^{_{CSI}}^{^{reported}}⁺¹ O_{CSI-part1,n} (and/or +Σₙ₌₁^{N}^{_{UEI}}^{^{reported}}⁺¹ O_{UEI,n}) UCI bits.

If a UE is provided a first interlace of M_{Interlace,0}^{PUCCH} PRBs by interlace0 in InterlaceAllocation, the UE has HARQ-ACK, SR, UEI report(s) as specified herein in the present disclosure and wideband or sub-band CSI reports to transmit, and the UE determines a PUCCH resource with PUCCH format 2, or the UE has HARQ-ACK, SR, UEI report(s) and wideband CSI reports to transmit and the UE determines a PUCCH resource with PUCCH format 3, where
the UE determines the PUCCH resource using the PUCCH resource indicator field in a last of a number of DCI formats, excluding the SPS activation DCI, with a value of a PDSCH-to-HARQ_feedback timing indicator field, or a value provided by dl-DataToUL-ACK or dl-DataToUL-ACK-r16 or dl-DataToUL-ACK-DCI-1-2 or dl-DataToUL-ACK-r17 or dl-DataToUL-ACK-DCI-1-2-r17 if the PDSCH-to-HARQ_feedback timing indicator field is not present in a DCI format, indicating a same slot for the PUCCH transmission, from a PUCCH resource set provided to the UE for HARQ-ACK transmission, and
the UE determines the PUCCH resource set as described herein in the present disclosure for O_{UCI} UCI bits and
if (O_{ACK}+O_{UEI}+O_{SR}+O_{CSI-part1}+O_{CRC,CSI-part1})≤M_{Interlace,0}^{PUCCH}·N_{sc,ctrl}^{RB}·N_{symb-UCI}^{PUCCH}·Qₘ·r, the UE transmits the HARQ-ACK, SR, UEI report(s) as specified herein in the present disclosure and CSI reports bits in a PUCCH over the first interlace
else, if the UE is provided a second interlace of M_{Interlace,1}^{PUCCH} PRBs by interlace1 and if (O_{ACK}+O_{UEI}+O_{SR}+O_{CSI-part1}+O_{CRC,CSI-part1})≤(M_{Interlace,0}^{PUCCH}+M_{Interlace,1}^{PUCCH})·N_{sc,ctrl}^{RB}·N_{symb-UCI}^{PUCCH}·Qₘ·r, the UE transmits the HARQ-ACK, SR, UEI report(s) as specified herein in the present disclosure and CSI reports bits in a PUCCH over both the first and second interlaces
else, the procedure is same as the corresponding one when the UE is provided PUCCH-ResourceSet by replacing M_{RB}^{PUCCH} with M_{Interlace,0}^{PUCCH}, or, if the UE is provided interlace1, by M_{Interlace,0}^{PUCCH}+M_{Interlace,1}^{PUCCH}.

If a UE has HARQ-ACK, SR, UEI report(s) and sub-band CSI reports to transmit and the UE determines a PUCCH resource with PUCCH format 3 or PUCCH format 4, where
the UE determines the PUCCH resource using the PUCCH resource indicator field in a last of a number of DCI formats, excluding the SPS activation DCI, with a value of a PDSCH-to-HARQ_feedback timing indicator field indicating a same slot for the PUCCH transmission, or by a value provided by dl-DataToUL-ACK or dl-DataToUL-ACK-r16 or dl-DataToUL-ACK-DCI-1-2 or dl-DataToUL-ACK-r17 or dl-DataToUL-ACK-DCI-1-2-r17 if the PDSCH-to-HARQ_feedback timing indicator field is not present in the last DCI format, from a PUCCH resource set provided to the UE for HARQ-ACK transmission, and
the UE determines the PUCCH resource set as described herein in the present disclosure for O_{UCI} UCI bits and
   if (O_{ACK}+O_{UEI}+O_{SR}+O_{CSI}+O_{CRC})≤M_{RB}^{PUCCH}·N_{sc,ctrl}^{RB}·N_{symb-UCI}^{PUCCH}·Qₘ·r, the UE transmits the HARQ-ACK, SR, UEI report(s) and the N_{CSI}^{total} CSI report bits by selecting the minimum number M_{RB,min}^{PUCCH} of PRBs from the M_{RB}^{PUCCH} PRBs satisfying (O_{ACK}+O_{UEI}+O_{SR}+O_{CSI}+O_{CRC})≤M_{RB,min}^{PUCCH}·N_{sc,ctrl}^{RB}·N_{symb-UCI}^{PUCCH}·Qₘ·r as described herein in the present disclosure
   else,
      if for N_{CSI-part2}^{reported} Part 2 CSI report priority value(s), it is

$${\sum }_{n = 1}^{{N}_{CSI - part 2}^{reported}} {O}_{CSI - part 2 , n} + {O}_{CRC , CSI - part 2 , N} \leq ( {M}_{RB}^{PUCCH} \cdot {N}_{sc , ctrl}^{RB} \cdot {N}_{symb - UCI}^{PUCCH} - ⌈ ( {O}_{A C K} + {O}_{S R} + {O}_{UEI} + {\sum }_{n = 1}^{{N}_{CSI}^{total}} {O}_{C S I - part 1 , n} + {O}_{CRC , CSI - part 1} ) / ( {Q}_{m} \cdot r ) ⌉ ) \cdot {Q}_{m} \cdot r$$

$$and$$

$${\sum }_{n = 1}^{{N}_{CSI - part 2}^{reported} + 1} {O}_{CSI - part 2 , n} + {O}_{CRC , CSI - part 2 , N + 1} > ( {M}_{RB}^{PUCCH} \cdot {N}_{sc , ctrl}^{RB} \cdot {N}_{symb - UCI}^{PUCCH} - ⌈ ( {O}_{A C K} + {O}_{S R} + {O}_{UEI} + {\sum }_{n = 1}^{{N}_{CSI}^{total}} {O}_{C S I - part 1 , n} + {O}_{CRC , CSI - part 1} ) / ( {Q}_{m} \cdot r ) ⌉ ) \cdot {Q}_{m} \cdot r$$

the UE selects the first N_{CSI-part2}^{reported} Part 2 CSI reports, according to respective priority value(s), for transmission together with the HARQ-ACK, SR, UEI report(s) and N_{CSI}^{total} Part 1 CSI reports, where O_{CSI-part1,n} is the number of Part 1 CSI report bits for the nₜₕ CSI report and O_{CSI-part2,n} is the number of Part 2 CSI report bits for the nₜₕ CSI report priority value, O_{CRC,CSI-part2,N} is a number of CRC bits corresponding to Σₙ₌₁^{N}^{_{CSI-part2}}^{^{reported}} O_{CSI-part2,n}, and O_{CRC,CSI-part2,N+1} is a number of CRC bits corresponding to Σₙ₌₁^{N}^{_{CSI-part2}}^{^{reported}}⁺¹ O_{CSI-part2,n}.
else, the UE drops all Part 2 CSI reports and selects N_{CSI-part1}^{reported} Part 1 CSI report(s), from the N_{CSI}^{total} CSI reports in ascending priority value, for transmission together with the HARQ-ACK, UEI report(s) and SR information bits where the value of N reported CSI-part1 satisfies (O_{ACK}+O_{SR}+O_{UEI}+Σₙ₌₁^{N}^{_{CSI-part1}}^{^{reported}} O_{CSI-part1,n}+O_{CRC,CSI-part1,N})≤M_{RB}^{PUCCH}·N_{sc,ctrl}^{RB}·N_{symb-UCI}^{PUCCH}·Qₘ·r and (O_{ACK}+O_{SR}+O_{UEI}+Σₙ₌₁^{N}^{_{CSI-part1}}^{^{reported}} O_{CSI-part1,n}+O_{CRC,CSI-part1,N})>M_{RB}^{PUCCH}·N_{sc,ctrl}^{RB}·N_{symb-UCI}^{PUCCH}·Qₘ·r, where O_{CRC,CSI-part1,N} is a number of CRC bits corresponding to O_{ACK}+O_{SR}+O_{UEI}+Σₙ₌₁^{N}^{_{CSI-part1}}^{^{reported}}⁺¹ O_{CSI-part1,n} UCI bits, and O_{CRC,CSI-part1,N+1} is a number of CRC bits corresponding to O_{ACK}+O_{SR}+O_{UEI}+Σₙ₌₁^{N}^{_{CSI-part1}}^{^{reported}}⁺¹ O_{CSI-part1,n} UCI bits.

If a UE is provided a first interlace of M_{Interlace,0}^{PUCCH} PRBs by interlace0 in InterlaceAllocation, the UE has HARQ-ACK, UEI report(s) as specified herein in the present disclosure, SR and sub-band CSI reports to transmit, and the UE determines a PUCCH resource with PUCCH format 3, where
the UE determines the PUCCH resource using the PUCCH resource indicator field in a last of a number of DCI formats, excluding the SPS activation DCI, that have a value of a PDSCH-to-HARQ_feedback timing indicator field indicating a same slot for the PUCCH transmission, or a value provided by dl-DataToUL-ACK or dl-DataToUL-ACK-r16 or dl-DataToUL-ACK-DCI-1-2 or dl-DataToUL-ACK-r17 or dl-DataToUL-ACK-DCI-1-2-r17 if the PDSCH-to-HARQ_feedback timing indicator field is not present in the last DCI format, from a PUCCH resource set provided to the UE for HARQ-ACK transmission, and
the UE determines the PUCCH resource set as described herein in the present disclosure for O_{UCI} UCI bits
   and
if (O_{ACK}+O_{SR}+O_{UEI}+O_{CSI}+O_{CRC})≤M_{Interlace,0}^{PUCCH}·N_{sc,ctrl}^{RB}·N_{symb-UCI}^{PUCCH}·Qₘ·r, the UE transmits the HARQ-ACK, SR, UEI report(s) and the N_{CSI}^{total} CSI report bits in a PUCCH over the first interlace
else if the UE is provided a second interlace of M_{Interlace,1}^{PUCCH} PRBs by interlace1 and if (O_{ACK}+O_{SR}+O_{UEI}+O_{CSI}+O_{CRC})≤(M_{Interlace,0}^{PUCCH}+M_{Interlace,1}^{PUCCH})·N_{sc,ctrl}^{RB}·N_{symb-UCI}^{PUCCH}·Qₘ·r, the UE transmits the HARQ-ACK, SR, UE-initiated (UEI) report(s) and CSI reports bits in a PUCCH over both the first and second interlaces
else, the procedure is same as the corresponding one when the UE is provided PUCCH-ResourceSet by replacing M_{RB}^{PUCCH}with M_{Interlace,0}^{PUCCH}, or, if the UE is provided interlace1, with M_{Interlace,0}^{PUCCH}+M_{Interlace,1}^{PUCCH}.

Offset values are defined for a UE to determine a number of resources for multiplexing UE-initiated (UEI) report(s) in a PUSCH. The offset values are signalled to a UE either by a DCI format scheduling the PUSCH transmission or by higher layers.

TABLE 14
mapping of beta_offset values for UEI report(s), CG-UCI,
or UTO-UCI and the index signaled by higher layers

| I_{offset, 0}^{UEI} or I_{offset, 1}^{UEI} or | |
|---|---|
| I_{offset, 2}^{UEI} or I_{offset}^{CG-UCI} or | |
| I_{offset}^{UTO-UCI} or I_{offset, 0}^{UEI, 0} or | |
| I_{offset, 1}^{UEI, 0} or I_{offset, 2}^{UEI, 0} | β_{offset}^{UEI} or β_{offset}^{CG-UCI} or |
| or I_{offset, 0}^{UEI, 1} or | β_{offset}^{UTO-UCI} or β_{offset}^{UEI, 0} |
| I_{offset, 1}^{UEI, 1} or I_{offset, 2}^{UEI, 1} | or β_{offset}^{UEI, 1} |
| 0 | 1.000 |
| 1 | 2.000 |
| 2 | 2.500 |
| 3 | 3.125 |
| 4 | 4.000 |
| 5 | 5.000 |
| 6 | 6.250 |
| 7 | 8.000 |
| 8 | 10.000 |
| 9 | 12.625 |
| 10 | 15.875 |
| 11 | 20.000 |
| 12 | 31.000 |
| 13 | 50.000 |
| 14 | 80.000 |
| 15 | 126.000 |
| 16 | 0.6 |
| 17 | 0.4 |
| 18 | 0.2 |
| 19 | 0.1 |
| 20 | 0.05 |
| 21 | Reserved |
| 22 | Reserved |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

TABLE 15
mapping of four beta_offset indicator values to offset indexes

| | (I_{offset, 0}^{UEI} or I_{offset, 1}^{UEI} or I_{offset, 2}^{UEI}), |
|---|---|
| beta_offset | (I_{offset, 0}^{UEI, 0} or I_{offset, 1}^{UEI, 0} or I_{offset, 2}^{UEI, 0}), |
| indicator | (I_{offset, 0}^{UEI, 1} or I_{offset, 1}^{UEI, 1} or I_{offset, 2}^{UEI, 1}) |
| ‘00’ | 1^{st} offset index provided by higher layers |
| ‘01’ | 2^{nd} offset index provided by higher layers |
| ‘10’ | 3^{rd} offset index provided by higher layers |
| ‘11’ | 4^{th} offset index provided by higher layers |

TABLE 16
mapping of two beta_offset indicator values to offset indexes

| | (I_{offset, 0}^{UEI} or I_{offset, 1}^{UEI} or I_{offset, 2}^{UEI}), |
|---|---|
| beta_offset | (I_{offset, 0}^{UEI, 0} or I_{offset, 1}^{UEI, 0} or I_{offset, 2}^{UEI, 0}), |
| indicator | (I_{offset, 0}^{UEI, 1} or I_{offset, 1}^{UEI, 1} or I_{offset, 2}^{UEI, 1}) |
| ‘0’ | 1^{st} offset index provided by higher layers |
| ‘1’ | 2^{nd} offset index provided by higher layers |

If a DCI format that does not include a beta_offset indicator field schedules the PUSCH transmission from the UE and the UE is provided betaOffsets=‘semiStatic’ or betaOffsetsDCI-0-2=‘semiStaticDCI-0-2’, the UE applies the β_{offset}^{UEI} value that is provided by betaOffsets=‘semiStatic’ for DCI formats 0_0/0_1 or by betaOffsetsDCI-0-2=‘semiStaticDCI-0-2’ for DCI format 0_2 for the corresponding UEI reports. If the PUSCH transmission has priority 0 or priority 1 and the UE is configured by uci-MuxWithDiffPrio to multiplex the UEI report(s) of priority 1 or priority 0, respectively, and if the UE multiplexes the UEI report(s) of priority 1 or priority 0, the UE applies corresponding β_{offset}^{UEI,1} or β_{offset}^{UEI,2} provided by betaOffsetsCrossPri1=‘semiStatic’ for DCI formats 0_0/0_1, by betaOffsetsCrossPri1DCI-0-2=‘semiStatic’ for DCI format 0_2, and by betaOffsetsCrossPri1DCI-0-3=‘semiStatic’ for DCI format 0_3, or by betaOffsetsCrossPri0=‘semiStatic’ for DCI format 0_0/0_1, by betaOffsetsCrossPri0DCI-0-2=‘semiStatic’ for DCI format 0_2, and by betaOffsetsCrossPri0DCI-0-3=‘semiStatic’ for DCI format 0_3, respectively.

If the PUSCH transmission is with a configured grant and the UE is provided CG-UCI-OnPUSCH=‘semiStatic’, the UE applies the β_{offset}^{UEI} value that is provided by CG-UCI-OnPUSCH=‘semiStatic’ for the corresponding UEI report(s). If the PUSCH transmission has priority 0 or priority 1 and the UE is configured by uci-MuxWithDiffPrio to multiplex the UEI report(s) of priority 1 or priority 0, respectively, and if the UE multiplexes the UEI report(s) of priority 1 or priority 0, the UE applies corresponding β_{offset}^{UEI,1} or β_{offset}^{UEI,2} provided by cg-betaOffsetsCrossPri1=‘semiStatic’ or cg-betaOffsetsCrossPri0=‘semiStatic’, respectively.

If the PUSCH transmission is scheduled by DCI format 0_0 and the UE is provided betaOffsets=‘dynamic’, the UE applies the β_{offset}^{UEI} value that is determined from the first value of betaOffsets=‘dynamic’. If the UE is configured by uci-MuxWithDiffPrio to multiplex the UE-initiated (UEI) report(s) of priority 1, the UE applies corresponding β_{offset}^{UEI,1} provided by the first value of betaOffsetsCrossPri1=‘dynamic’.

If the PUSCH transmission is a configured grant Type 2 PUSCH and the UE is provided CG-UCI-OnPUSCH=‘dynamic’, the UE (e.g., the UE 116) applies the β_{offset}^{UEI} value that is determined from the first value of CG-UCI-OnPUSCH=‘dynamic’. If the PUSCH transmission has priority 0 or priority 1 and the UE is configured by uci-MuxWithDiffPrio to multiplex the UEI report(s) of priority 1 or priority 0, respectively, and if the UE multiplexes the UEI report(s) of priority 1 or priority 0, the UE applies corresponding β_{offset}^{UEI,1} or β_{offset}^{UEI,0} provided by the first value of cg-betaOffsetsCrossPri1=‘dynamic’ or cg-betaOffsetsCrossPri0=‘dynamic’, respectively.

UEI report(s) offsets β_{offset}^{UEI} are configured to values according to Table 14 provided in the present disclosure. The betaOffsetUEI-Index1, betaOffsetUEI-Index2, and betaOffsetUEI-Index3 respectively provide indexes I_{offset,0}^{UEI}, I_{offset,1}^{UEI}, and I_{offset,2}^{UEI} for the UE to use if the UE multiplexes up to 2 UEI report(s) bits, more than 2 and up to 11 UEI report(s) bits, and more than 11 bits in the PUSCH, respectively.

Offsets β_{offset}^{UEI,0} for multiplexing UEI report(s) with priority 0 in a PUSCH transmission with priority 1 are configured to values according to Table 14. The first, second and third values provided by any of betaOffsetsCrossPri0, betaOffsetsCrossPri0DCI-0-2, betaOffsetsCrossPri1DCI-0-3, or cg-betaOffsetsCrossPri0 respectively provide indexes I_{offset,0}^{UEI,0}, I_{offset,1}^{UEI,0}, and I_{offset,2}^{UEI,0} for the UE to use if the UE multiplexes up to 2 bits, more than 2 and up to 11 bits, and more than 11 bits of UEI report(s) with priority 0 in the PUSCH transmission with priority 1, respectively.

Offsets β_{offset}^{UEI,1} for multiplexing UEI report(s) with priority 1 in a PUSCH transmission with priority 0 are configured to values according to Table 14. The first, second and third values provided by any of betaOffsetsCrossPri1, betaOffsetsCrossPri1DCI-0-2, or cg-betaOffsetsCrossPri1 respectively provide indexes I_{offset,0}^{UEI,1}, I_{offset,1}^{UEI,1}, and I_{offset,2}^{UEI,1} for the UE to use if the UE multiplexes up to 2 bits, more than 2 and up to 11 bits, and more than 11 bits of UEI report(s) with priority 1 in the PUSCH transmission with priority 0, respectively.

If a DCI format that includes a beta_offset indicator field with one bit or two bits, as configured by UCI-OnPUSCH for DCI format 0_1 or UCI-OnPUSCH-DCI-0-2 for DCI format 0_2 or UCI-OnPUSCH-DCI-0-3, schedules the PUSCH transmission from the UE, the UE is provided by each of {betaOffsetUEI-Index1, betaOffsetUEI-Index2, betaOffsetUEI-Index3}, the {first, second, third} values provided by betaOffsetsCrossPri0, or betaOffsetsCrossPri0DCI-0-2, or betaOffsetsCrossPri0DCI-0-3, and the {first, second, third} values provided by betaOffsetsCrossPri1, or betaOffsetsCrossPri1DCI-0-2, or betaOffsetsCrossPri0DCI-0-3, a set of two or four I_{offset}^{UEI}, I_{offset}^{UEI,0}, and I_{offset}^{UEI,1} indexes from Table 14 for multiplexing UEI report(s) including e.g. the trigger/pre-notification message as specified herein in the present disclosure in the PUSCH transmission. The beta_offset indicator field indicates a I_{offset}^{UEI} value and/or a I_{offset}^{UEI,0} value, and/or a I_{offset}^{UEI,1} value from the respective sets of values, with the mapping defined in Table 15 and in Table 16 provided herein in the present disclosure. If the PUSCH transmission has priority 0 or priority 1, and the UE is provided uci-MuxWithDiffPrio, and the UE multiplexes the UEI report(s) of priority 1 or priority 0 in the PUSCH, the UE applies the {first, second, third} values provided by betaOffsetsCrossPri1=‘dynamic’ for DCI format 0_1, betaOffsetsCrossPri1DCI-0-2=‘dynamic’ for DCI format 0_2, or betaOffsetsCrossPri1DCI-0-3=‘dynamic’ for DCI format 0_3, or applies the {first, second, third} values provided by betaOffsetsCrossPri0=‘dynamic’ for DCI format 0_1, betaOffsetsCrossPri0DCI-0-2=‘dynamic’ for DCI format 0_2, or betaOffsetsCrossPri0DCI-0-3=‘dynamic’ for DCI format 0_3.

For a PUSCH transmission that is configured by a ConfiguredGrantConfig and includes CG-UCI, the UE multiplexes the CG-UCI in the PUSCH transmission using a I_{offset}^{CG-UCI} value provided by betaOffsetCG-UCI with the mapping defined in Table 14. The CG-UCI has same priority value as the PUSCH. If the UE is provided cg-UCI-Multiplexing and multiplexes UEI report(s) of same priority value as the CG-UCI in the PUSCH transmission, the UE jointly encodes the UEI report(s) and the CG-UCI and determines a number of resources for multiplexing the combined information in a PUSCH using β_{offset}^{UEI} which provides indexes I_{offset,1}^{UEI} and I_{offset,2}^{UEI} for the UE to use if the UE multiplexes up to 11, and more than 11 combined information bits, respectively.

For a PUSCH transmission that is configured by a ConfiguredGrantConfig and includes UTO-UCI, the UE multiplexes the UTO-UCI in the PUSCH transmission using a I_{offset}^{UTO-UCI} value provided by betaOffsetUTO-UCI with the mapping defined in Table 14. The UTO-UCI has same priority value as the PUSCH. If the UE multiplexes UEI report(s) of same priority value as the UTO-UCI in the PUSCH transmission, the UE jointly encodes the corresponding UEI report(s) and the UTO-UCI and determines a number of resources for multiplexing the combined information in the PUSCH using β_{offset}^{UEI} which provides indexes I_{offset,1}^{UEI} and I_{offset,2}^{UEI} for the UE to use if the UE multiplexes up to 11, and more than 11 combined information bits, respectively.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate).

The present disclosure provides various detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means of transmitting the UE-initiated report(s) along with its indicator(s) via various uplink channels.

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. MCS, or number of CWs.
For another example, when there is no pre-notification message/trigger associated with a content, i.e., the report-type is (B), the content can be transmitted using UL resource(s) configured (e.g. configured-grant PUSCH), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network (e.g., the network 130) according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one embodiment, a UE could send to the network one or more indicators/triggers or report quantities (e.g., in part of the content(s) in a (report-)type (B) based report or a (report-)type (C) based report) each comprising/including/containing or corresponding to one or more of:
An identity (ID) of the TCI state
An index/ID of a higher layer RRC configured list/set/pool of TCI states that comprises/indicates/provides the TCI state.
An index of the TCI state in a list/set/pool of TCI states higher layer RRC configured to the UE
An index of the TCI state in a set of TCI states activated by a (unified) TCI state(s) activation/deactivation MAC CE
An index/ID of a set of TCI states—e.g., among all sets of TCI states activated/provided by a (unified) TCI state(s) activation/deactivation MAC CE—that comprises/indicates/provides the TCI state
An index of the TCI state among TCI states mapped to a TCI codepoint activated/provided by a (unified) TCI state(s) activation/deactivation MAC CE
A TCI codepoint activated/provided by a (unified) TCI state(s) activation/deactivation MAC CE that comprises/indicates/provides the TCI state
An index/ID of a TCI codepoint—e.g., among all TCI codepoints activated/provided by a (unified) TCI state(s) activation/deactivation MAC CE—that comprises/indicates/provides the TCI state.
An index of the TCI state among TCI states indicated by a TCI codepoint of a TCI field in a beam indication DCI (e.g., DCI format 1_1/1_2 with or without DL assignment)
An index/ID of or information related to a (unified) TCI state(s) activation/deactivation MAC CE that activates the TCI state or a TCI codepoint that comprises/indicates/provides the TCI state; the information could include/comprise/contain/indicate when (e.g., reception time in form of slot/slot index/etc.) the (unified) TCI state(s) activation/deactivation MAC CE was received
An index/ID of or information related to a beam indication DCI that provides/indicates the TCI state or a TCI codepoint that comprises/indicates/provides the TCI state; the information could include/comprise/contain/indicate when (e.g., reception time in form of slot/slot index/etc.) the beam indication DCI was received
An index/ID of a CORESET or a coresetPoolIndex/coresetGroupIndex associated to a CORESET, in which a beam indication DCI that provides/indicates the TCI state or a TCI codepoint that comprises/indicates/provides the TCI state was received
RS index(es)/ID(s) such as SSB index(es)/ID(s) and/or CSI-RS resource index(es)/ID(s) provided/indicated in the TCI state along with the corresponding QCL-type(s)
Resource indicator(s) such as SSBRI(s) and/or CRI(s) reported in one or more CSI/beam reports
Beam metric(s) such as L1-RSRP(s) and/or L1-SINR(s) reported in one or more CSI/beam reports
Index(es)/ordering(s) of resource indicator(s) such as SSBRI(s) and/or CRI(s) among resource indicators such as SSBRIs and/or CRIs reported in one or more CSI/beam reports
Index(es)/ordering(s) of resource indicator(s) such as SSBRI(s) and/or CRI(s) among resource indicators such as SSBRIs and/or CRIs reported for TCI state(s)/beam(s) activation/deactivation/sub-selection as specified herein in the present disclosure in one or more CSI/beam reports
Index(es)/ordering(s) of resource indicator(s) such as SSBRI(s) and/or CRI(s) among candidate resource indicators such as SSBRIs and/or CRIs—as specified herein in the present disclosure—reported in one or more CSI/beam reports
Index(es)/ordering(s) of beam metric(s) such as L1-RSRP(s) and/or L1-SINR(s) among beam metrics such as L1-RSRPs and/or L1-SINRs reported in one or more beam/CSI reports
Index(es)/ordering(s) of beam metric(s) such as L1-RSRP(s) and/or L1-SINR(s) among beam metrics such as L1-RSRPs and/or L1-SINRs corresponding to resource indicators such as SSBRIs and/or CRIs reported for TCI state(s)/beam(s) activation/deactivation/sub-selection as specified herein in the present disclosure in one or more CSI/beam reports
Index(es)/ordering(s) of beam metric(s) such as L1-RSRP(s) and/or L1-SINR(s) among beam metrics such as L1-RSRPs and/or L1-SINRs corresponding to candidate resource indicators such as SSBRIs and/or CRIs—as specified herein in the present disclosure—reported in one or more CSI/beam reports
Group(s)/pair(s) of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported in one or more CSI/beam reports
Index(es)/ordering(s) of group(s)/pair(s) of resource indicators among groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of resource indicators among groups/pairs of candidate resource indicators such as SSBRIs and/or CRIs—as specified herein in the present disclosure—reported in one or more CSI/beam reports
Group(s)/pair(s) of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs reported in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of resource indicators such as SSBRIs and/or CRIs reported for TCI state(s)/beam(s) activation/deactivation/sub-selection as specified herein in the present disclosure in one or more CSI/beam reports
Index(es)/ordering(s) of group(s)/pair(s) of beam metrics such as L1-RSRPs and/or L1-SINRs among groups/pairs of beam metrics such as L1-RSRPs and/or L1-SINRs corresponding to groups/pairs of candidate resource indicators such as SSBRIs and/or CRIs—as specified herein in the present disclosure-reported in one or more CSI/beam reports
A bitmap with each bit position of the bitmap corresponding to a candidate TCI state/TCI state ID/TCI state index/RS index or ID/resource indicator/etc. according to those specified herein in the present disclosure; for this case, when/if a bit position of the bitmap is set to ‘1’ (or ‘0’), the TCI state/TCI state ID/TCI state index/RS index or ID/resource indicator/etc. corresponding to the bit position could be for the UE-initiated beam(s)/TCI state(s) switching/update/change as specified herein in the present disclosure.

Throughout the present disclosure, an index could correspond to the “first”, the “second”, and etc. Furthermore, throughout the present disclosure, “trigger” can also be referred to as “initiate” or “indicate”; i.e., they can be used/applied to various design examples throughout the present disclosure interchangeably. For instance, the UE could send to the network an indicator to trigger a TCI state change/update/switch for one or more channels or signals. The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report.

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) same via/in a report/reporting instance/transmission/transmission occasion (e.g., via/in a same set of uplink resources including PUCCH(s), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, UCI and etc.

In one operation mode (Mode A), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)
   Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
   Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
      Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
      Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
      Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-6f: one or more CSI reporting configuration/setting IDs/indexes—for the resource(s) not used/applicable/available for the second UL channel, wherein a CSI reporting setting/configuration is provided by CSI-ReportConfig.
      Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-6h: a starting symbol/slot/etc. for the resource(s) not used/applicable/available for the second UL channel
      Component-6i: an ending symbol/slot/etc. for resource(s) not used/applicable/available for the second UL channel
      Component-6j: a time duration/length (e.g., in form/terms/number of symbols/slot/etc.), within which the resources may not be used/applicable/available for the second UL channel
      Component-6k: a number of resources not used/available/applicable for the second UL channel
      Component-6l: an uplink (scheduling) grant, e.g., for PUSCH(s), such that the scheduled/granted resource(s) may not be used/available/applicable for the second UL channel
   Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
   Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.
One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.

The (downlink/uplink) DCI (in Step-2) in response to the transmission of the PN message/trigger in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one operation mode (Mode B), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
   In one example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)
   Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
   Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
      Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
      Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
      Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-6f: one or more CSI reporting configuration/setting IDs/indexes—for the resource(s) not used/applicable/available for the second UL channel, wherein a CSI reporting setting/configuration is provided by CSI-ReportConfig.
      Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-6h: a starting symbol/slot/etc. for the resource(s) not used/applicable/available for the second UL channel
      Component-6i: an ending symbol/slot/etc. for resource(s) not used/applicable/available for the second UL channel
      Component-6j: a time duration/length (e.g., in form/terms/number of symbols/slot/etc.), within which the resources may not be used/applicable/available for the second UL channel
      Component-6k: a number of resources not used/available/applicable for the second UL channel
      Component-6l: an uplink (scheduling) grant, e.g., for PUSCH(s), such that the scheduled/granted resource(s) may not be used/available/applicable for the second UL channel
   Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
   Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.
One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap—within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this design example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission does not indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the (downlink/uplink) DCI in response to the PN message/trigger is received p1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q1 (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, regardless of how/when the periodic/semi-persistent PUCCH resource(s) and/or the PUSCH resource(s) such as CG PUSCH of Type1 and/or Type2 is (pre-) configured by the network for transmitting or sending the UEI report content(s)/quantity(s) as defined or specified herein in the present disclosure, the UE could (always) determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based LI signaling(s), according to or based on a corresponding UE's capability or capability signaling, wherein the candidate values could correspond to slot/symbol/etc. indexes.
The (downlink/uplink) DCI (in Step-2) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
   The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
   A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

Supporting Mode A (and/or Mode B and/or Mode C) and therefore the corresponding operations could be a basic UE feature such that when/if a UE supports the UE-initiated/event-driven beam reporting/management (or for a UE supporting the UE-initiated/event-driven beam reporting/management), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam reporting/management; in this case, the UE could indicate to the network in their capability signaling(s) one or more of:
Support of Mode A and therefore the corresponding operations.
Support of Mode B and therefore the corresponding operations.
Support of Mode C and therefore the corresponding operations

That is, a UE's capability or capability signaling could comprise one or more components each indicating support of:
{Mode A}
{Mode B}
{Mode C}
{Mode A, Mode B}
{Mode A, Mode C}
{Mode B, Mode C}

According to those specified/defined herein in the present disclosure, a UEI report (or a first UEI report) could correspond to a PN message/trigger transmitted/sent via the first UL channel that comprises the one or more (periodic) PUCCH resources (in Mode A, Mode B and/or Mode C); or, a UEI report (or a first UEI report) could correspond to or could be referred to as the first UL channel, and therefore, the corresponding one or more (periodic) PUCCH resources (in Mode A, Mode B and/or Mode C) comprised therein.

According to those specified/defined herein in the present disclosure, a UEI report (or a second UEI report) could correspond to UEI report content(s)/quantity(s) as specified/defined herein in the present disclosure transmitted/sent via the second UL channel that comprises the one or more periodic/semi-persistent PUCCH resources (e.g., pre-configured by the network for sending the UEI report content(s)/quantity(s)) and/or the one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH) in Mode A, Mode B and/or Mode C; or, a UEI report (or a second UEI report) could correspond to or could be referred to as the second UL channel, and therefore, the corresponding one or more periodic/semi-persistent PUCCH resources (e.g., pre-configured by the network for sending the UEI report content(s)/quantity(s)) and/or the one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH) in Mode A, Mode B and/or Mode C comprised therein.

In PHY prioritization/multiplexing handling, in one example, a UEI report or a first UEI report or a second UEI report or a PN message/trigger transmitted/sent via the first PUCCH channel could be of a higher priority than a SR and/or a LRR. That is, the Phy-PriorityIndex associated to the UEI report or the first UEI report or the second UEI report or the PN message/trigger transmitted/sent via the first PUCCH channel could be higher (or lower) than the Phy-PriorityIndex associated to a SR and/or the Phy-PriorityIndex associated to a LRR.

In PHY prioritization/multiplexing handling, in another example, a UEI report or a first UEI report or a second UEI report or a PN message/trigger transmitted/sent via the first PUCCH channel could be of a lower priority than a SR and/or a LRR. That is, the Phy-PriorityIndex associated to the UEI report or the first UEI report or the second UEI report or the PN message/trigger transmitted/sent via the first PUCCH channel could be lower (or higher) than the Phy-PriorityIndex associated to a SR and/or the Phy-PriorityIndex associated to a LRR.

In PHY prioritization/multiplexing handling, in another example, a UEI report or a first UEI report or a second UEI report or a PN message/trigger transmitted/sent via the first PUCCH channel could be of a higher priority than a SR, and of a lower priority than a LRR. That is, the Phy-PriorityIndex associated to the UEI report or the first UEI report or the second UEI report or the PN message/trigger transmitted/sent via the first PUCCH channel could be higher (or lower) than the Phy-PriorityIndex associated to a SR, and lower (or higher) than the Phy-PriorityIndex associated to a LRR.

According to those specified/defined herein in the present disclosure, when a first PUCCH channel/resource that carries or conveys a PN message/trigger (or a first UEI report) as specified/defined herein in the present disclosure would overlap or collide with a second PUCCH channel/resource in time, wherein:
In one example, the second PUCCH channel/resource carries or conveys a SR; in this design example, the PN message/trigger (or equivalently the first UEI report) and the SR could be multiplexed in the first (or second) PUCCH channel/resource with the PN message/trigger (or equivalently, the first UEI report) having a higher priority.
In another example, the second PUCCH channel/resource carries or conveys a LRR; in this design example, the PN message/trigger (or equivalently the first UEI report) and the LRR could be multiplexed in the first (or second) PUCCH channel/resource with the PN message/trigger (or equivalently, the first UEI report) having a lower priority.
In another example, the second PUCCH channel/resource carries or conveys a SR and a LRR; in this design example, the PN message/trigger (or equivalently the first UEI report), the SR and the LRR could be multiplexed in the first (or second) PUCCH channel/resource with the PN message/trigger (or equivalently, the first UEI report) having a higher priority than the SR and a lower priority than the LRR.

Furthermore, in PHY prioritization/multiplexing handling, a UEI report or a second UEI report or a first UEI report or UEI report content(s)/quantity(s) as specified/defined herein in the present disclosure transmitted/sent via the second PUSCH resource/channel could be the same as (e.g., of a same priority as) a CSI report; or, a UEI report or a second UEI report or a first UEI report or UEI report content(s)/quantity(s) as specified/defined herein in the present disclosure transmitted/sent via the second PUSCH resource/channel could be handled in a similar or same manner to or as a CSI report. That is, the Phy-PriorityIndex associated to the UEI report or the second UEI report or the first UEI report or the UEI report content(s)/quantity(s) as specified/defined herein in the present disclosure transmitted/sent via the second PUSCH resource/channel could have the same value as or could be the same as/identical to the Phy-PriorityIndex associated to a CSI report.

Additionally, when a first PUCCH channel/resource that carries or conveys a PN message/trigger (or a first UEI report) as specified/defined herein in the present disclosure would overlap or collide with a PUSCH channel/resource in time,
In one example, the UE could piggyback the PN message/trigger (or equivalently the first UEI report), and therefore, the number of UCI bits used to represent the PN message/trigger (e.g., 1 bit or 2 bits), in/into/on the PUSCH channel/resource. In this design example, the PUSCH channel/resource may or may not carry or convey SR(s) and/or HARQ-ACK information bit(s); furthermore, the PUSCH channel/resource may or may not carry or convey UL-SCH (i.e., data).
In another example, the PUSCH channel/resource carries or conveys a SR; in this design example, the UE could piggyback the PN message/trigger (or equivalently the first UEI report), and therefore, the number of UCI bits used to represent the PN message/trigger (e.g., 1 bit or 2 bits), in/into/on the PUSCH channel/resource. For instance, if a UE would transmit the PUSCH channel/resource carrying or conveying O_{SR} (with O_{SR}=1, 2, . . . ) SR bit(s) in a slot, the UE could append O_{UEI} (with O_{UEI}=1, 2, . . . ) UCI bit(s) representing the PN message/trigger (or the first UEI report) to the SR bit(s); in this case, the UE could transmit the combined O_{UCI}=O_{SR}+O_{UEI} UCI bits in the PUSCH channel/resource.
In another example, the PUSCH channel/resource carries or conveys a HARQ-ACK; in this design example, the UE could piggyback the PN message/trigger (or equivalently the first UEI report), and therefore, the number of UCI bits used to represent the PN message/trigger (e.g., 1 bit or 2 bits), in/into/on the PUSCH channel/resource. For instance, if a UE would transmit the PUSCH channel/resource carrying or conveying O_{ACK} (with O_{ACK}=1, 2, . . . ) HARQ-ACK information bit(s) in a slot, the UE could append O_{UEI} (with O_{UEI}=1, 2, . . . ) UCI bit(s) representing the PN message/trigger (or the first UEI report) to the HARQ-ACK information bit(s); in this case, the UE could transmit the combined O_{UCI}=O_{ACK}+O_{UEI} UCI bits in the PUSCH channel/resource.
In another example, the PUSCH channel/resource carries or conveys a SR and a HARQ-ACK; in this design example, the UE could piggyback the PN message/trigger (or equivalently the first UEI report), and therefore, the number of UCI bits used to represent the PN message/trigger (e.g., 1 bit or 2 bits), in/into/on the PUSCH channel/resource. For instance, if a UE would transmit the PUSCH channel/resource carrying or conveying O_{SR} (with O_{SR}=1, 2, . . . ) SR bit(s) and O_{ACK} (with O_{ACK}=1, 2, . . . ) HARQ-ACK information bit(s) in a slot, the UE could append O_{UEI} (with O_{UEI}=1, 2, . . . ) UCI bit(s) representing the PN message/trigger (or the first UEI report) to the SR bit(s) and HARQ-ACK information bit(s); in this case, the UE could transmit the combined O_{UCI}=O_{SR}+O_{ACK}+O_{UEI} UCI bits in the PUSCH channel/resource.
In another example, the PUSCH channel/resource may not carry or convey any (valid) SR(s) and/or HARQ-ACK information bit(s). In this design example, the UE could prioritize the transmission of the PN message/trigger (or the first UEI report) over/via the first PUCCH channel/resource, and drop the transmission of the PUSCH channel/resource.
In another example, regardless whether or not the PUSCH channel/resource carries or conveys SR(s) and/or HARQ-ACK information bit(s), the UE could prioritize the transmission of the PN message/trigger (or the first UEI report) over/via the first PUCCH channel/resource, and drop the transmission of the PUSCH channel/resource.
In another example, the PUSCH channel/resource may not carry or convey any (valid) SR(s) and/or HARQ-ACK information bit(s).
   For example, when/if the PUSCH channel/resource carries or conveys or is transmitted with UL-SCH (i.e., data), the UE could prioritize the transmission of the PUSCH channel/resource, and drop the transmission of the PN message/trigger (or the first UEI report) over/via the first PUCCH channel/resource; otherwise, i.e., when/if the PUSCH channel/resource does not carry/convey or is not transmitted with UL-SCH (i.e., data), the UE could prioritize the transmission of the PN message/trigger (or the first UEI report) over/via the first PUCCH channel/resource, and drop the transmission of the PUSCH channel/resource.
   For another example, regardless of whether or not the PUSCH channel/resource carries or conveys or is transmitted with UL-SCH (i.e., data), the UE could prioritize the transmission of the PUSCH channel/resource, and drop the transmission of the PN message/trigger (or the first UEI report) over/via the first PUCCH channel/resource.
   For another example, regardless of whether or not the PUSCH channel/resource carries or conveys or is transmitted with UL-SCH (i.e., data), the UE could prioritize the transmission of the PN message/trigger (or the first UEI report) over/via the first PUCCH channel/resource, and drop the transmission of the PUSCH channel/resource.
In another example, regardless of whether or not the PUSCH channel/resource carries or conveys SR(s) and/or HARQ-ACK information bit(s),
   For example, when/if the PUSCH channel/resource carries or conveys or is transmitted with UL-SCH (i.e., data), the UE could prioritize the transmission of the PUSCH channel/resource, and drop the transmission of the PN message/trigger (or the first UEI report) over/via the first PUCCH channel/resource; otherwise, i.e., when/if the PUSCH channel/resource does not carry/convey or is not transmitted with UL-SCH (i.e., data), the UE could prioritize the transmission of the PN message/trigger (or the first UEI report) over/via the first PUCCH channel/resource, and drop the transmission of the PUSCH channel/resource.
   For another example, regardless of whether or not the PUSCH channel/resource carries or conveys or is transmitted with UL-SCH (i.e., data), the UE could prioritize the transmission of the PUSCH channel/resource, and drop the transmission of the PN message/trigger (or the first UEI report) over/via the first PUCCH channel/resource.
   For another example, regardless of whether or not the PUSCH channel/resource carries or conveys or is transmitted with UL-SCH (i.e., data), the UE could prioritize the transmission of the PN message/trigger (or the first UEI report) over/via the first PUCCH channel/resource, and drop the transmission of the PUSCH channel/resource.

The UE could be provided or indicated or configured by the network, e.g., via higher layer RRC signaling(s) and/or MAC CE command(s) and/or dynamic DCI based L1 signaling(s) based on or subject/according to a corresponding UE's capability or capability signaling, whether (or not) the UE could piggyback the PN message/trigger (or equivalently the first UEI report), and therefore, the number of UCI bits used to represent the PN message/trigger (e.g., 1 bit or 2 bits), in/into/on the PUSCH channel/resource (e.g., when/if the first PUCCH resource/channel that could carry or convey the PN message/trigger would overlap or collide with the PUSCH channel/resource in time) according to or following those specified herein in the present disclosure.
The UE could signal or send or transmit to the network a capability signaling indicating their support of piggybacking the PN message/trigger (or equivalently the first UEI report), and therefore, the number of UCI bits used to represent the PN message/trigger (e.g., 1 bit or 2 bits), in/into/on the PUSCH channel/resource (e.g., when/if the first PUCCH resource/channel that could carry or convey the PN message/trigger would overlap or collide with the PUSCH channel/resource in time) according to or following those specified herein in the present disclosure.
The UE could signal or send or transmit to the network a capability signaling indicating that they do not support piggybacking the PN message/trigger (or equivalently the first UEI report), and therefore, the number of UCI bits used to represent the PN message/trigger (e.g., 1 bit or 2 bits), in/into/on the PUSCH channel/resource (e.g., when/if the first PUCCH resource/channel that could carry or convey the PN message/trigger would overlap or collide with the PUSCH channel/resource in time) according to or following those specified herein in the present disclosure.
When/if the UE could be provided or configured by the network, e.g., via higher layer RRC signaling(s) e.g. CSI-ReportConfig that provides or configures necessary information/setting(s) for the UE-initiated/event-driven beam reporting, a higher layer parameter simultaneousFirstPUCCHandPUSCH and/or set to ‘enabled’, the UE could piggyback the PN message/trigger (or equivalently the first UEI report), and therefore, the number of UCI bits used to represent the PN message/trigger (e.g., 1 bit or 2 bits), in/into/on the PUSCH channel/resource according to or following those specified herein in the present disclosure (e.g., appended to the SR bit(s) and/or HARQ-ACK information bit(s)).

According to or following those specified herein in the present disclosure, when/if:
the UE does not signal or send or transmit to the network the aforementioned capability signaling indicating their support of piggybacking the PN message/trigger (or equivalently the first UEI report), and therefore, the number of UCI bits used to represent the PN message/trigger (e.g., 1 bit or 2 bits), in/into/on the PUSCH channel/resource (e.g., when/if the first PUCCH resource/channel that could carry or convey the PN message/trigger would overlap or collide with the PUSCH channel/resource in time) according to or following those specified herein in the present disclosure, and/or
the UE has signaled or sent or transmitted to the network the aforementioned capability signaling indicating that they do not support piggybacking the PN message/trigger (or equivalently the first UEI report), and therefore, the number of UCI bits used to represent the PN message/trigger (e.g., 1 bit or 2 bits), in/into/on the PUSCH channel/resource (e.g., when/if the first PUCCH resource/channel that could carry or convey the PN message/trigger would overlap or collide with the PUSCH channel/resource in time) according to or following those specified herein in the present disclosure, and/or
the UE could be provided or configured by the network, e.g., via higher layer RRC signaling(s) e.g. CSI-ReportConfig that provides or configures necessary information/setting(s) for the UE-initiated/event-driven beam reporting, the aforementioned higher layer parameter simultaneousFirstPUCCHandPUSCH and set to ‘disabled’, and/or
the UE is not provided or configured by the network, e.g., via higher layer RRC signaling(s) e.g. CSI-ReportConfig that provides or configures necessary information/setting(s) for the UE-initiated/event-driven beam reporting, the aforementioned higher layer parameter simultaneousFirstPUCCHandPUSCH, or the higher layer parameter simultaneousFirstPUCCHandPUSCH is absent or is not present, provided or configured in the higher layer RRC signaling(s) e.g. CSI-ReportConfig that provides or configures necessary information/setting(s) for the UE-initiated/event-driven beam reporting,
   when a first PUCCH channel/resource that carries or conveys a PN message/trigger (or a first UEI report) as specified/defined herein in the present disclosure would overlap or collide with a PUSCH channel/resource in time,
In one example, the UE could prioritize the transmission of the PN message/trigger (or the first UEI report) over/via the first PUCCH channel/resource, and drop the transmission of the PUSCH channel/resource.
In another example,
   For example, when/if the PUSCH channel/resource carries or conveys or is transmitted with UL-SCH (i.e., data), the UE could prioritize the transmission of the PUSCH channel/resource, and drop the transmission of the PN message/trigger (or the first UEI report) over/via the first PUCCH channel/resource; otherwise, i.e., when/if the PUSCH channel/resource does not carry/convey or is not transmitted with UL-SCH (i.e., data), the UE could prioritize the transmission of the PN message/trigger (or the first UEI report) over/via the first PUCCH channel/resource, and drop the transmission of the PUSCH channel/resource.
   For another example, regardless of whether or not the PUSCH channel/resource carries or conveys or is transmitted with UL-SCH (i.e., data), the UE could prioritize the transmission of the PUSCH channel/resource, and drop the transmission of the PN message/trigger (or the first UEI report) over/via the first PUCCH channel/resource.
   For another example, regardless of whether or not the PUSCH channel/resource carries or conveys or is transmitted with UL-SCH (i.e., data), the UE could prioritize the transmission of the PN message/trigger (or the first UEI report) over/via the first PUCCH channel/resource, and drop the transmission of the PUSCH channel/resource.

In one embodiment, (1) PUSCH transmission(s) can be dynamically scheduled by an UL grant in a DCI, and/or (2) PUSCH transmission(s) can be (dynamically) triggered, initiated or requested by the UE via transmitting/sending their UEI report(s)—e.g., via a pre-notification message/trigger—e.g., of (report-)type (A) or (report-)type (C) as specified herein in the present disclosure, and/or via the (corresponding) content—e.g., of (report-)type (B) or (report-)type (C) as specified herein in the present disclosure, and/or (3) PUSCH transmission(s) can be (dynamically) triggered, initiated or requested by the UE via transmitting/sending their UEI report(s)—e.g., via a pre-notification message/trigger—e.g., of (report-)type (A) or (report-)type (C) as specified herein in the present disclosure, and/or via the (corresponding) content—e.g., of (report-)type (B) or (report-)type (C) as specified herein in the present disclosure and dynamically scheduled by an UL grant in a DCI associated/addressed to the UEI report(s). In one example, the UE could first send/transmit to the network the UEI report(s), e.g., the trigger/pre-notification message of (report-)type (A) or (report-)type (C) as specified herein in the present disclosure, to trigger, initiate or request the network to schedule PUSCH transmission(s). The UE (e.g., the UE 116) could expect to receive, within a time window starting from the last symbol/slot of the transmission of the UEI report(s), an UL grant in a DCI to schedule the PUSCH transmission(s), wherein the UL grant or the corresponding DCI could be associated/addressed to the UEI report(s) and/or the trigger/pre-notification message conveyed therein. For this case, the time window could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc. When/if the UE does not receive, within the time window as specified/described herein, an UL grant in a DCI associated/addressed to the UEI report(s) that schedules the PUSCH transmission(s), the UE could re-send or re-transmit the UEI report(s) including at least the trigger/pre-notification message as described/specified herein in the present disclosure.

In one embodiment, the PUSCH transmission(s) can correspond to a configured grant (CG) Type-1 or Type-2. The CG Type-1 PUSCH transmission(s) could be semi-statically configured to operate upon the reception of higher layer parameter of configuredGrantConfig including rrc-ConfiguredUplinkGrant and/or ueInitiatedReporting, wherein the higher layer parameter ueInitiatedReporting (e.g., when/if set to ‘enabled’) could provide/indicate/configure to the UE that the corresponding CG Type-1 PUSCH transmission(s) is for transmitting the UEI report(s) according to those specified herein in the present disclosure, without the detection of an UL grant in a DCI. The configured grant Type-2 PUSCH transmission could be (1) semi-persistently scheduled by an UL grant in a valid activation DCI after the reception of higher layer parameter of configuredGrantConfig including ueInitiatedReporting, wherein the higher layer parameter ueInitiatedReporting (e.g., when/if set to ‘enabled’) could provide/indicate/configure to the UE that the corresponding CG Type-2 PUSCH transmission(s) is for transmitting the UEI report(s) according to those specified herein in the present disclosure, but not including rrc-ConfiguredUplinkGrant, (2) (semi-persistently) triggered, initiated or requested by the UE via transmitting/sending their UEI report(s)—e.g., via a pre-notification message/trigger—e.g., of (report-)type (A) or (report-)type (C) as specified herein in the present disclosure, and/or via the (corresponding) content—e.g., of (report-)type (B) or (report-)type (C) as specified herein in the present disclosure after the reception of higher layer parameter of configuredGrantConfig including ueInitiatedReporting, wherein the higher layer parameter ueInitiatedReporting (e.g., when/if set to ‘enabled’) could provide/indicate/configure to the UE that the corresponding CG Type-2 PUSCH transmission(s) is for transmitting the UEI report(s) according to those specified herein in the present disclosure, but not including rrc-ConfiguredUplinkGrant, and/or (3) (semi-persistently) triggered, initiated or requested by the UE via transmitting/sending their UEI report(s)—e.g., via a pre-notification message/trigger—e.g., of (report-)type (A) or (report-)type (C) as specified herein in the present disclosure, and/or via the (corresponding) content—e.g., of (report-)type (B) or (report-)type (C) as specified herein in the present disclosure and semi-persistently scheduled by an UL grant in a valid activation DCI after the reception of higher layer parameter of configuredGrantConfig including ueInitiatedReporting, wherein the higher layer parameter ueInitiatedReporting (e.g., when/if set to ‘enabled’) could provide/indicate/configure to the UE that the corresponding CG Type-2 PUSCH transmission(s) is for transmitting the UEI report(s) according to those specified herein in the present disclosure, but not including rrc-ConfiguredUplinkGrant. In one example, the UE could first send/transmit to the network the UEI report(s), e.g., the trigger/pre-notification message of (report-)type (A) or (report-)type (C) as specified herein in the present disclosure, to trigger, initiate or request the network to (semi-persistently) schedule CG Type-2 PUSCH transmission(s). The UE could expect to receive, within a time window starting from the last symbol/slot of the transmission of the UEI report(s), an UL grant in a valid activation DCI to semi-persistently schedule the PUSCH transmission(s) after the reception of higher layer parameter of configuredGrantConfig including ueInitiatedReporting, wherein the higher layer parameter ueInitiatedReporting (e.g., when/if set to ‘enabled’) could provide/indicate/configure to the UE that the corresponding CG Type-2 PUSCH transmission(s) is for transmitting the UEI report(s) according to those specified herein in the present disclosure, but not including rrc-ConfiguredUplinkGrant, and the UL grant or the corresponding valid activation DCI could be associated/addressed to the UEI report(s) and/or the trigger/pre-notification message conveyed therein. For this case, the time window could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc. When/if the UE does not receive, within the time window as specified/described herein, an UL grant in a valid activation DCI associated/addressed to the UEI report(s) that schedules the CG Type-2 PUSCH transmission(s) after the reception of higher layer parameter of configuredGrantConfig including ueInitiatedReporting, wherein the higher layer parameter ueInitiatedReporting (e.g., when/if set to ‘enabled’) could provide/indicate/configure to the UE that the corresponding CG Type-2 PUSCH transmission(s) is for transmitting the UEI report(s) according to those specified herein in the present disclosure, but not including rrc-ConfiguredUplinkGrant, the UE could re-send or re-transmit the UEI report(s) including at least the trigger/pre-notification message as described/specified herein in the present disclosure.

For PUSCH transmission(s) as described/specified herein in the present disclosure, (1) a UE could upon detection of a PDCCH with a configured DCI format 0_0, 0_1 or 0_2 transmit the corresponding PUSCH(s) as indicated by that DCI unless the UE does not generate a transport block, (2) a UE could upon transmission of a UEI report (e.g., within a time window), e.g., the trigger/pre-notification message of (report-)type (A) or (report-) type (C) as specified herein in the present disclosure transmit the corresponding PUSCH(s) unless the UE does not generate a transport block, wherein the time window could be determined from the last symbol/block of the transmission of the UEI report, and according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc., and/or (3) a UE could upon detection of a PDCCH with a configured DCI format 0_0, 0_1 or 0_2 that is associated/addressed to a previously sent UEI report according to those specified herein in the present disclosure transmit the corresponding PUSCH(s) as indicated by that DCI unless the UE does not generate a transport block. The UE could maintain or track a counter and a timer associated to a UEI report, e.g., a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, and/or a corresponding UEI report ID/index. For example,
When/if the UE has sent or transmitted to the network a first UEI report according to those specified herein in the present disclosure, the UE could start the UEI report timer specific to the first UEI report (or set the UEI report timer specific to the first UEI report to 0), and/or start the UEI report counter specific to the first UEI report (or set the UEI report counter specific to the first UEI report to 0).
When/if the UE has re-sent or re-transmitted the first UEI report (or a UEI report with the same UEI report ID/index as the first UEI report), the UE could increment the UEI report counter specific to the first UEI report by one.
When/if the UE report counter specific to the first UEI report reaches a maximum value/threshold, and/or the UEI report timer specific to the first UEI report has expired, the UE could terminate or stop sending/transmitting or re-sending/re-transmitting the first UEI report, wherein the maximum value/threshold could be determined according to (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc.

For this case/design example, the first UEI report could also be referred to/represented as/by the first UEI report ID/index.

A UE could receive from the network (e.g., the network 130), in higher layer parameter of configuredGrantConfig including rrc-ConfiguredUplinkGrant and/or ueInitiatedReporting that configures/provides CG Type-1/Type-2 PUSCH transmission(s), one or more sets of resource allocation parameters or configurations with each set comprising one or more candidate resource allocation parameters or configurations for the corresponding CG Type-1/Type-2 PUSCH transmission(s), wherein the higher layer parameter ueInitiatedReporting (e.g., when/if set to ‘enabled’) could provide/indicate/configure to the UE that the corresponding CG Type-1/Type-2 PUSCH transmission(s) is for transmitting the UEI report(s) according to those specified herein in the present disclosure, without or with the detection of an UL grant in a DCI. A set of one or more, e.g., K≥1, candidate resource allocation parameters or configurations could include or comprise or contain or provide or correspond to at least:
One or more, e.g., K≥1, candidate higher layer parameter timeDomainAllocation value(s) m's each providing a row index m+1 pointing to the determined time domain resource allocation table, where the start symbol and length could be determined following the procedure defined in the corresponding system specification(s);
One or more, e.g., K≥1, candidate higher layer parameters frequencyDomainAllocation's, wherein the N least significant bit (LSB) bits in each of the higher layer parameters frequencyDomainAllocation forming a bit sequence, e.g., f₁₇, . . . , f₁, f₀, could be used to determine the corresponding frequency domain resource allocation according to the procedure defined in the corresponding system specification(s), wherein f₀ is the LSB, Nis determined as the size of frequency domain resource assignment field in DCI format 0_1 for a given resource allocation type indicated by resourceAllocation, except if useInterlacePUCCH-PUSCH in BWP-UplinkDedicated is configured, in which case uplink type 2 resource allocation is used wherein the UE could interpret the LSB bits in the corresponding higher layer parameter(s) frequencyDomainAllocation's as for the frequency domain resource assignment field of DCI format 0_1 according to the procedure defined in the corresponding system specification(s);
One or more, e.g., K≥1, candidate I_{MCS} values each provided by a higher layer parameter mCSAndTBS;
One or more, e.g., K≥1, candidate frequency offsets each configured by a higher layer parameter frequencyHoppingOffset between two frequency hops, when/if frequency hopping is enabled

Each of the one or more, e.g., K≥1, candidate resource allocation parameters or configurations in a set could also correspond to or provide number of DM-RS code-division multiplexing (CDM) groups, DM-RS ports, SRS resource indication and DM-RS sequence initialization, wherein the bit value for DM-RS sequence initialization, precoding information and number of layers, SRS resource indicator could be provided by the corresponding higher layer parameters antennaPort, dmrs-SeqInitialization, precodingAndNumberOfLayers, and srs-ResourceIndicator, respectively—or equivalently, a set of one or more, e.g., K≥1, candidate resource allocation parameters or configurations could also include or comprise or contain or provide or correspond to one or more, e.g., K≥1, candidate higher layer parameters antennaPort's, and/or one or more, e.g., K≥1, candidate higher layer parameters dmrs-SeqInitialization's, and/or one or more, e.g., K≥1, candidate higher layer parameters precodingAndNumberOfLayers's, and/or one or more, e.g., K≥1, candidate higher layer parameters srs-ResourceIndicator's.

For a set of one or more, e.g., K≥1, candidate resource allocation parameters or configurations as specified/described herein in the present disclosure provided/configured in a higher layer parameter of configuredGrantConfig including rrc-ConfiguredUplinkGrant and/or ueInitiatedReporting that configures/provides CG Type-1/Type-2 PUSCH transmission(s)—a CG PUSCH resource as described herein in the present disclosure could also be referred to/represented as/by or correspond to a CG Type-1/Type-2 PUSCH resource or transmission:
In one example, the CG PUSCH resource(s) used to transmit the UEI report(s) could be fixed in system specification(s). For example, the UE could use or determine the PUSCH resource(s) provided/configured in/by or according to the first candidate resource allocation parameter or configuration in the set provided/configured in the corresponding configuredGrantConfig to transmit the UEI report(s).
In another example, the UE could be indicated/configured/provided by the network (e.g., based on/according to a corresponding UE's capability signaling), e.g., via higher layer RRC signaling(s)/parameter(s) and/or MAC control element (CE) command(s) and/or dynamic DCI based L1 signaling(s), which one or more of the provided/indicated/configured K candidate resource allocation parameter(s) or configuration(s) in the set could be used to determine the PUSCH resource(s) to transmit the UEI report(s). For instance, the UE could be indicated/configured/provided by the network (e.g., based on/according to a corresponding UE's capability signaling), e.g., via higher layer RRC signaling(s)/parameter(s) and/or MAC CE command(s) and/or dynamic DCI based L1 signaling(s), that at least the k-th candidate resource allocation parameter or configuration in the set according to those specified herein in the present disclosure (out of the provided/indicated/configured K candidate resource allocation parameters or configurations in the set, i.e., k∈{1, . . . ,K}) could be used to determine the PUSCH resource(s) for transmitting the UEI report(s).
   For example, the UE could receive from the network, e.g., via higher layer RRC signaling(s)/parameter(s) and/or MAC CE command(s) and/or dynamic DCI based L1 signaling(s), one or more indications/configurations to enable the UE-initiated reporting specified herein in the present disclosure, wherein the one or more indications/configurations could also indicate/configure/provide to the UE that at least the k-th candidate resource allocation parameter or configuration in the set according to those specified herein in the present disclosure (out of the provided/indicated/configured K candidate resource allocation parameters or configurations in the set, i.e., k∈{1, . . . ,K}) could be used to determine the PUSCH resource(s) for transmitting the UEI report(s).
   For another example, each of the K candidate resource allocation parameters or configurations in the set could be associated/specific to a one-bit indicator, which could also be provided/configured in the same higher layer parameter ConfiguredGrantConfig that configures or provides the set of K candidate resource allocation parameters or configurations. For this case/design example, the one-bit indicator associated/specific to the k-th candidate resource allocation parameter or configuration in the set according to those specified herein in the present disclosure (out of the provided/indicated/configured K candidate resource allocation parameters or configurations in the set, i.e., k∈{1, . . . ,K}) could be set to ‘1’ (or ‘0’).
   For another example, the UE could be provided/configured/indicated in the higher layer parameter (and/or the corresponding MAC CE command(s) and/or dynamic DCI based L1 signaling(s)) such as ConfiguredGrantConfig that provides/configures/indicates the set of K candidate resource allocation parameters or configurations for PUSCH transmission(s) a bitmap of length K with each entry/bit position of the bitmap associated/corresponding one of the K candidate resource allocation parameters or configurations as specified herein in the present disclosure. For this case/design example, at least the entry/bit position (e.g., the k-th entry/bit position) of the bitmap that is associated/corresponding to the k-th candidate resource allocation parameter or configuration in the set according to those specified herein in the present disclosure (out of the provided/indicated/configured K candidate resource allocation parameters or configurations in the set, i.e., k∈{1, . . . ,K}) could be set to ‘1’ (or ‘0’).
   For another example, the UE could receive from the network one or more indicators via one or more DCI fields in a DCI format (e.g., DCI format 1_0, 1_1, 1_2, 0_0, 0_1, 0_2, etc.), wherein the one or more DCI indicators could indicate/provide/configure to the UE that at least the k-th candidate resource allocation parameter or configuration in the set as specified herein in the present disclosure for CG Type-1/2 PUSCH transmission(s) (out of the provided/indicated/configured K candidate resource allocation parameters or configurations in the set, i.e., k∈{1, . . . ,K}) could be used to determine PUSCH resource(s) for transmitting the UEI report(s). In one example, for a total of K candidate resource allocation parameters or configurations in the set for the CG Type-1 or Type-2 PUSCH transmission(s) as specified herein in the present disclosure, a DCI field in a DCI format (e.g., DCI format 1_0, 1_1, 1_2, 0_0, 0_1, 0_2, etc.) used to indicate which of the candidate resource allocation parameters or configurations in the set could be used to determine PUSCH resource(s) for transmitting the UEI report(s) could be of └ log₂K┘ bits—the presence/absence of the DCI field in the DCI format could be RRC configured; for instance, when/if the UE is not provided/configured by the network via higher layer RRC signaling the set of K candidate resource allocation parameters or configurations for determining PUSCH resource(s) for the UEI reporting (or equivalently, K=0) or when/if the UE is provided/configured by the network via higher layer RRC signaling a single candidate resource allocation parameter or configuration in the set for determining PUSCH resource(s) for the UEI reporting (or equivalently, K=1), the DCI field as mentioned herein could be absent (i.e., a 0-bit field) in the corresponding DCI format—for this case, i.e., K=1, the UE could use/apply the provided/configured/indicated resource allocation parameter or configuration in the set—and therefore, the PUSCH resource(s) determined according to the single candidate resource allocation parameter or configuration in the set—to transmit the UEI report(s) described/specified herein in the present disclosure. According to those specified herein in the present disclosure, the DCI field(s) in the DCI format used to indicate which of the candidate resource allocation parameter(s) or configuration(s) in the set to use for determining PUSCH resource(s) for transmitting the UEI report(s) could be new/dedicated DCI field(s) introduced in the corresponding DCI format; alternatively, the DCI field(s) in the DCI format used to indicate which of the candidate resource allocation parameter(s) or configuration(s) in the set to use for determining PUSCH resource(s) for transmitting the UEI report(s) could be existing DCI field(s) or could be by repurposing the existing DCI field(s). In addition, the DCI format could be received the latest in time among DCI formats e.g. that indicate/provide PUCCH resource indicator(s) (PRI(s)) for transmitting uplink control information (UCI) including HARQ-ACK, and/or the DCI format could be the most recent applicable one among DCI formats e.g. that indicate/provide PRI(s) for transmitting uplink control information (UCI) including HARQ-ACK.
   For another example, the UE could receive from the network a MAC CE activation command, activating one or more candidate resource allocation parameters or configurations from the total K candidate resource allocation parameters or configurations in the set that is higher layer configured/provided to the UE for the UE-initiated reporting, which could be used to map up to P DCI codepoints/indicators of one or more DCI fields in a DCI format (e.g., DCI format 1_0, 1_1, 1_2, 0_0, 0_1, 0_2, etc.). The UE could then receive from the network one or more DCI codepoints/indicators via the one or more DCI fields in the DCI format (e.g., DCI format 1_0, 1_1, 1_2, 0_0, 0_1, 0_2, etc.), wherein the one or more DCI indicators/codepoints could indicate/provide/configure to the UE that at least the k-th candidate resource allocation parameter or configuration in the set (out of the provided/indicated/configured K candidate resource allocation parameters or configurations in the set, i.e., k∈{1, . . . ,K}) could be used to determine PUSCH resource(s) for transmitting the UEI report(s). In one example, for up to P candidate resource allocation parameters or configurations that can be activated by/in the MAC CE activation command as described/specified herein in the present disclosure (from the set), a DCI field in a DCI format (e.g., DCI format 1_0, 1_1, 1_2, 0_0, 0_1, 0_2, etc.) used to indicate which of the (activated) candidate resource allocation parameters or configurations in the set to use for determining PUSCH resource(s) for transmitting the UEI report(s) could be of [log 2P] bits—the presence/absence of the DCI field in the DCI format could be RRC configured: for instance, when/if the UE is not provided/configured by the network via higher layer RRC signaling the set of K candidate resource allocation parameters or configurations for determining PUSCH resource(s) for the UEI reporting (or equivalently, K=0) or when/if the UE is provided/configured by the network via higher layer RRC signaling a single candidate resource allocation parameter or configuration in the set for determining PUSCH resource(s) for the UEI reporting (or equivalently, K=1), the DCI field as mentioned herein could be absent (i.e., a 0-bit field) in the corresponding DCI format—for this case, i.e., K=1, the UE could use/apply the provided/configured/indicated resource allocation parameter or configuration in the set—and therefore, the PUSCH resource(s) determined according to the single candidate resource allocation parameter or configuration in the set—to transmit the UEI report(s) described/specified herein in the present disclosure; optionally, when/if a single candidate resource allocation parameter or configuration is activated by/in the MAC CE activation command from the set, the DCI field as mentioned herein could be absent (i.e., a 0-bit field) in the corresponding DCI format—for this case, i.e., P=1, the UE could use/apply the resource allocation parameter or configuration—and therefore, the PUSCH resource(s) determined according to the candidate resource allocation parameter or configuration—activated by/in the MAC CE activation command from the set to determine PUSCH resource(s) for transmitting the UEI report(s) described/specified herein in the present disclosure. According to those specified herein in the present disclosure, the DCI field(s) in the DCI format used to indicate which of the (activated) candidate resource allocation parameter(s) or configuration(s) in the set to use for determining PUSCH resource(s) for transmitting the UEI report(s) could be new/dedicated DCI field(s) introduced in the corresponding DCI format; alternatively, the DCI field(s) in the DCI format used to indicate which of the (activated) candidate resource allocation parameter(s) or configuration(s) in the set to use for determining PUSCH resource(s) for transmitting the UEI report(s) could be existing DCI field(s) or could be by repurposing the existing DCI field(s). In addition, the DCI format could be received the latest in time among DCI formats e.g. that indicate/provide PRI(s) for transmitting uplink control information (UCI) including HARQ-ACK, and/or the DCI format could be the most recent applicable one among DCI formats e.g. that indicate/provide PRI(s) for transmitting uplink control information (UCI) including HARQ-ACK.
In another example, a UE could transmit a first UEI report, wherein the first UEI report could comprise at least a pre-notification (PN) message/trigger—e.g., of (report-)type (A) or (report-)type (C) as specified herein in the present disclosure, and a second UEI report, wherein the second UEI report could comprise at least the content(s)—e.g., of (report-)type (B) or (report-)type (C) as specified herein in the present disclosure-comprising one or more of the indicators/triggers or the report quantities as specified herein in the present disclosure, corresponding/associated/linked to the first UEI report according to those specified herein in the present disclosure. For this case/design example, the PN message sent by the UE (in part of the first UEI report) could indicate to the network which one or more of the provided/indicated/configured K candidate resource allocation configurations or parameters in the set could be used to determine PUSCH resource(s) for transmitting the second UEI report. For instance, the PN sent in part of the first UEI report by the UE could indicate/provide/inform to the network that at least the k-th candidate resource allocation configuration or parameter in the set (out of the provided/indicated/configured K candidate resource allocation parameters or configurations in the set, i.e., k∈{1, . . . ,K}) could be used to determine PUSCH resource(s) for transmitting the second UEI report.
   For example, the PN message sent in part of the first UEI report could be a └ log₂K┘-bit indicator, with each state of the └ log₂K┘-bit indicator corresponding/associated to one of the provided/indicated/configured K candidate resource allocation parameters or configurations in the set as specified herein in the present disclosure for determining PUSCH resource(s) for transmitting the UEI report(s); when/if a state of the └ log₂K┘-bit indicator is sent by the UE in form of the PN message, the UE indicates/provides/informs to the network that at least the candidate resource allocation parameter or configuration in the set associated/corresponding to the state could be used for determining PUSCH resource(s) for transmitting the second UEI report. For instance, for K=2, the PN message could be a 1-bit indicator with ‘0’ (or ‘1’) indicating/providing/informing to the network that at least the first candidate resource allocation parameter or configuration in the set could be used for determining PUSCH resource(s) for transmitting the second UEI report, and ‘1’ (or ‘0’) indicating/providing/informing to the network that at least the second candidate resource allocation parameter or configuration in the set could be used for determining PUSCH resource(s) for transmitting the second UEI report. For this case/design example, the UE could send the PN message (i.e., the └ log₂K┘-bit indicator) in part of the first UEI report indicating the state associated/corresponding to the k-th candidate resource allocation parameter or configuration in the set.
   For another example, the PN message sent in part of the first UEI report could be a multi-bit indicator with └ log₂K┘ most significant bits (MSBs)/LSBs used to indicate/inform to the network which one or more of the provided/indicated/configured K candidate resource allocation parameters or configurations in the set for determining PUSCH resource(s) for transmitting the UEI report(s) as specified herein in the present disclosure could be used for determining PUSCH resource(s) to transmit the second UEI report. Each state of the └ log₂K┘ MSBs/LSBs could be associated to one of the provided/indicated/configured K candidate resource allocation parameters or configurations in the set; when/if a state of the └ log₂K┘ MSBs/LSBs is sent by the UE in part of the PN message, the UE indicates/provides/informs to the network that at least the candidate resource allocation parameter or configuration in the set associated/corresponding to the state could be used for determining PUSCH resource(s) for transmitting the second UEI report. For instance, for K=2, the MSB/LSB of the PN message could be ‘0’ (or ‘1’) indicating/providing/informing to the network that at least the first candidate resource allocation parameter or configuration in the set could be used for determining PUSCH resource(s) for transmitting the second UEI report, and ‘1’ (or ‘0’) indicating/providing/informing to the network that at least the second candidate resource allocation parameter or configuration in the set could be used for determining PUSCH resource(s) for transmitting the second UEI report. For this case/design example, the UE (e.g., the UE 116) could send the PN message in part of the first UEI report indicating a state of the └ log₂K┘ MSBs/LSBs as the one associated/corresponding to the k-th candidate resource allocation parameter or configuration in the set.
   For another example, the PN message sent in part of the first UEI report could be a length-K bitmap with each entry/bit position of the bitmap corresponding/associated to one of the K candidate resource allocation parameters or configurations in the set as specified herein in the present disclosure. When/if an entry/bit position of the bitmap is set to ‘1’ (or ‘0’), the UE indicates/provides/informs to the network that at least the candidate resource allocation parameter or configuration in the set associated/corresponding to the entry/bit position in the bitmap could be used for determining PUSCH resource(s) for transmitting the second UEI report. For this case/design example, at least the entry/bit position (e.g., the k-th entry/bit position) of the bitmap/PN message sent by the UE in part of the first UEI report that is associated/corresponding to the k-th candidate resource allocation parameter or configuration in the set could be set to ‘1’ (or ‘0’).
   For another example, payload size of the PN message (or report size of the first UEI report) could be used to indicate/inform to the network which one or more of the provided/indicated/configured K resource allocation parameters or configurations in the set according to those specified herein in the present disclosure for determining PUSCH resource(s) for transmitting the UEI report(s) could be used to determine PUSCH resource(s) for transmitting the second UEI report. For instance, when/if the payload size of the PN message (or the report size of the first UEI report) is greater than (or less than) a threshold/level (e.g., the k-th threshold/level for this case), the UE indicates/provides/informs to the network that at least the candidate resource allocation parameter or configuration in the set (e.g., the k-th candidate resource allocation parameter or configuration in the set for this case) associated/corresponding to the threshold/level (e.g., the k-th threshold/level for this case) could be used for determining PUSCH resource(s) for transmitting the second UEI report. The value of the threshold/level (e.g., the k-th threshold/level for this case) could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network via/in part of the UEI report(s), beam/CSI report(s) and/or etc.

For the design examples specified/described herein in the present disclosure,
In one example, when/if the provided/configured/indicated K candidate resource allocation parameters or configurations in a/the set are specific to Type-2 CG PUSCH transmission(s), after the UE has sent to the network at least the first UEI report (or the PN message in the first UEI report), the UE could start transmitting the second UEI report on the PUSCH resource(s) determined/selected according to those specified herein in the present disclosure. That is, for Type-2 CG PUSCH transmission(s) in this case/design example, the UE may not expect to receive a DCI with or addressed to CS-RNTI to trigger or indicate the transmission(s) on the CG PUSCH resource(s); the first UEI report or the PN message in the first UEI report could serve as the same role as the DCI with or addressed to CS-RNTI to trigger or indicate the transmission(s) on the CG PUSCH resource(s).
In another example, for both Type-1 and Type-2 CG PUSCH configurations, after the UE has sent to the network at least the first UEI report (or the PN message in the first UEI report), the UE could expect or it is expected that the UE could transmit the second UEI report on the earliest available/applicable PUSCH resource(s) determined/selected according to those specified herein in the present disclosure.

The described/specified design examples related to the determination of the CG PUSCH configuration(s)/resource(s) to use for transmitting the UEI report(s) throughput the present disclosure are applicable for both Type-1 and Type-2 CG PUSCH transmissions.

In one embodiment, a UE could transmit a first UEI report, wherein the first UEI report could comprise at least a pre-notification (PN) message/trigger—e.g., of (report-)type (A) or (report-)type (C) as specified herein in the present disclosure, and a second UEI report, wherein the second UEI report could comprise at least the content(s)—e.g., of (report-)type (B) or (report-)type (C) as specified herein in the present disclosure-comprising one or more of the indicators/triggers or the report quantities as specified herein in the present disclosure, corresponding/associated/linked to the first UEI report according to those specified herein in the present disclosure. After the UE has sent to the network the first UEI report (or the PN message in the first UEI report), the UE could expect to be provided/configured/indicated by the network within a time window, e.g., via higher layer RRC signaling(s)/parameter(s)—e.g., via/in higher layer parameter of configuredGrantConfig including rrc-ConfiguredUplinkGrant and/or ueInitiatedReporting that configures/provides CG Type-1/Type-2 PUSCH transmission(s) wherein the higher layer parameter ueInitiatedReporting (e.g., when/if set to ‘enabled’) could provide/indicate/configure to the UE that the corresponding CG Type-1/Type-2 PUSCH transmission(s) is for transmitting the UEI report(s) according to those specified herein in the present disclosure, without or with the detection of an UL grant in a DCI—and/or MAC CE command(s) and/or dynamic DCI based L1 signaling(s), one or more sets of resource allocation parameters or configurations with each set comprising one or more candidate resource allocation parameters or configurations for the corresponding CG Type-1/Type-2 PUSCH transmission(s) as specified herein in the present disclosure. The UE could then determine/identify the CG PUSCH resource(s) for transmitting at least the second UEI report. The time window could be determined according to: (i) fixed rule(s)/value(s) in system specification(s), (ii) network's configuration(s)/indication(s), e.g., via higher layer RRC signaling(s)/parameter(s) and/or MAC CE command(s) and/or dynamic DCI based L1 signaling(s), and/or (iii) UE's autonomous determination/selection, which could be further sent to the network (e.g., the network 130) via/in part of the UEI report(s), beam/CSI report(s) and/or etc.

To determine a modulation order, target code rate, redundancy version and transport block size for the physical uplink shared channel used for transmitting the UEI report(s) as specified herein in the present disclosure, the UE could first
read a 5-bit modulation and coding scheme (I_{MCS} value) as provided by mCSAndTBS identified/determined from a set of candidate I_{MCS} values according to those specified herein in the present disclosure for a CG Type-1 or Type-2 PUSCH to determine the modulation order (Oₘ) and target rate (R)
determine the redundancy version for CG Type-1 and Type-2 PUSCH according to those specified herein in the present disclosure
   and second
use the number of layers (ν), the total number of allocated PRBs (n_{PRB}) to determine the transport block size based on the procedure specified herein in the present disclosure.

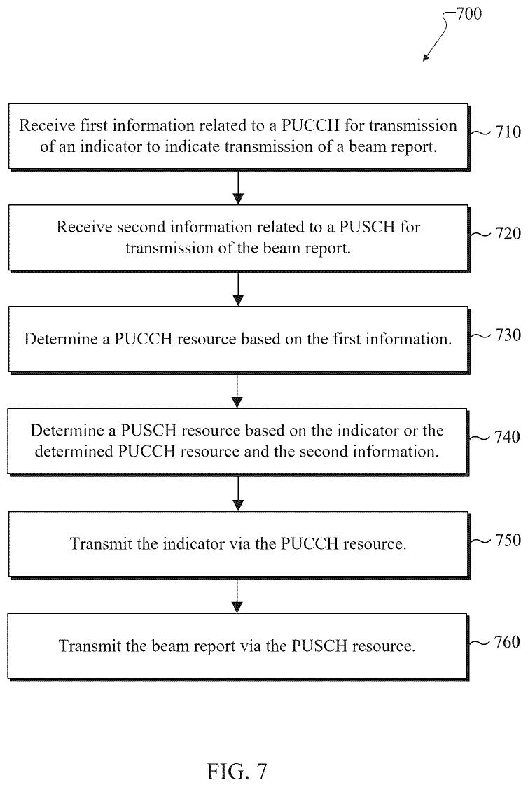

FIG. 7 illustrates an example method 700 performed by a UE in a wireless communication system according to embodiments of the present disclosure. The method 700 of FIG. 7 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method 700 begins with the UE receiving first information related to a PUCCH for transmission of an indicator to indicate transmission of a beam report (710) and receives second information related to a PUSCH for transmission of the beam report (720).

The UE then determines a PUCCH resource based on the first information (730) and determines a PUSCH resource based on the indicator or the determined PUCCH resource and the second information (740). In various embodiments, the second information includes a set of candidate resource configurations, and the indicator indicates a selection of a resource configuration from the set of candidate resource configurations. In various embodiments, the second information includes a resource configuration for one or more PUSCH resources each associated with the PUCCH resource, and the PUSCH resource corresponds to one of the one or more PUSCH resources associated with the PUCCH resource.

The UE then transmits the indicator via the PUCCH resource (750) and transmits the beam report via the PUSCH resource (760). In various embodiments, when the PUCCH resource overlaps with a resource for a PUCCH associated with a SR, the UE multiplexes the SR and the indicator in the PUCCH resource based on a priority of the SR and a priority of the beam report. In various embodiments, when the PUCCH resource overlaps with a resource for a PUSCH carrying HARQ-ACK information bits, the UE appends the indicator to the HARQ-ACK information bits.

In various embodiments, the first information indicates at least one of a priority index, a periodicity, an offset, a maximum number of transmissions, and a transmission timer. The UE, after transmission of the indicator a first time, starts the transmission timer. After transmission of the indicator a second time, the UE increments a counter by one. Then, when the counter reaches the maximum number of transmissions before the transmission timer expires or when the transmission timer expires, the UE terminates transmission of the indicator.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information related to a physical uplink control channel (PUCCH) for transmission of an indicator to indicate transmission of a beam report; and
receive second information related to a physical uplink shared channel (PUSCH) for transmission of the beam report; and
a processor operably coupled with the transceiver, the processor configured to:
determine, based on the first information, a PUCCH resource; and
determine, based on (i) the indicator or (ii) the determined PUCCH resource and the second information, a PUSCH resource,
wherein the transceiver is further configured to:
transmit, via the PUCCH resource, the indicator; and
transmit, via the PUSCH resource, the beam report.

2. The UE of claim 1, wherein, when the PUCCH resource overlaps with a resource for a PUCCH associated with a scheduling request (SR), the processor is further configured to multiplex the SR and the indicator in the PUCCH resource based on a priority of the SR and a priority of the beam report.

3. The UE of claim 1, wherein, when the PUCCH resource overlaps with a resource for a PUSCH carrying hybrid automatic repeat request acknowledge (HARQ-ACK) information bits, the processor is further configured to append the indicator to the HARQ-ACK information bits.

4. The UE of claim 1, wherein the first information indicates at least one of:
a priority index;
a periodicity;
an offset;
a maximum number of transmissions; and
a transmission timer.

5. The UE of claim 4, wherein:
after transmission of the indicator a first time, the processor is further configured to start the transmission timer;
after transmission of the indicator a second time, the processor is further configured to increment a counter by one; and
when the counter reaches the maximum number of transmissions before the transmission timer expires or when the transmission timer expires, the processor is further configured to terminate transmission of the indicator.

6. The UE of claim 1, wherein the second information comprises a set of candidate resource configurations.

7. The UE of claim 6, wherein the indicator indicates a selection of a resource configuration from the set of candidate resource configurations.

8. The UE of claim 1, wherein:
the second information includes a resource configuration for one or more PUSCH resources each associated with the PUCCH resource; and
the PUSCH resource corresponds to one of the one or more PUSCH resources associated with the PUCCH resource.

9. A base station (BS), comprising:
a processor; and
a transceiver operably coupled with the processor, the transceiver configured to:
transmit first information related to a physical uplink control channel (PUCCH) for an indicator to indicate transmission of a beam report;
transmit second information related to a physical uplink shared channel (PUSCH) for the beam report;
receive, via a PUCCH resource, the indicator; and
receive, via a PUSCH resource, the beam report,
wherein the PUCCH resource is based on the first information, and
wherein the PUSCH resource is based on (i) the indicator or (ii) the determined PUCCH resource and the second information.

10. The BS of claim 9, wherein, when the PUCCH resource overlaps with a resource for a PUCCH associated with a scheduling request (SR), the SR and the indicator are multiplexed in the PUCCH resource based on a priority of the SR and a priority of the beam report.

11. The BS of claim 9, wherein, when the PUCCH resource overlaps with a resource for a PUSCH carrying hybrid automatic repeat request acknowledge (HARQ-ACK) information bits, the indicator is appended to the HARQ-ACK information bits.

12. The BS of claim 9, wherein the first information indicates at least one of:
a priority index;
a periodicity;
an offset;
a maximum number of transmissions; and
a transmission timer.

13. The BS of claim 12, wherein:
transmission of the indicator a first time starts the transmission timer;
transmission of the indicator a second time increments a counter by one; and
when the counter reaches the maximum number of transmissions before the transmission timer expires or when the transmission timer expires, transmission of the indicator is terminated.

14. The BS of claim 9, wherein the second information comprises a set of candidate resource configurations.

15. The BS of claim 14, wherein the indicator indicates a selection of a resource configuration from the set of candidate resource configurations.

16. The BS of claim 9, wherein:
the second information includes a resource configuration for one or more PUSCH resources each associated with the PUCCH resource; and
the PUSCH resource corresponds to one of the one or more PUSCH resources associated with the PUCCH resource.

17. A method performed by a user equipment (UE), the method comprising:
receiving first information related to a physical uplink control channel (PUCCH) for transmission of an indicator to indicate transmission of a beam report;
receiving second information related to a physical uplink shared channel (PUSCH) for transmission of the beam report;
determining, based on the first information, a PUCCH resource;
determining, based on (i) the indicator or (ii) the determined PUCCH resource and the second information, a PUSCH resource;
transmitting, via the PUCCH resource, the indicator; and
transmitting, via the PUSCH resource, the beam report.

18. The method of claim 17, further comprising, when the PUCCH resource overlaps with a resource for a PUCCH associated with a scheduling request (SR), multiplexing the SR and the indicator in the PUCCH resource based on a priority of the SR and a priority of the beam report.

19. The method of claim 17, further comprising, when the PUCCH resource overlaps with a resource for a PUSCH carrying hybrid automatic repeat request acknowledge (HARQ-ACK) information bits, appending the indicator to the HARQ-ACK information bits.

20. The method of claim 17, further comprising:
after transmission of the indicator a first time, starting a transmission timer indicated in the first information;
after transmission of the indicator a second time, incrementing a counter by one; and
when the counter reaches a maximum number of transmissions indicated in the first information before the transmission timer expires or when the transmission timer expires, terminating transmission of the indicator.
